(19) United States
(12) Patent Application Publication
(10) Pub. No.: US 2026/0186245 A1
(43) Pub. Date: Jul. 2, 2026

(54) OPTICAL IMAGING SYSTEM

(71) Applicant: Samsung Electro-Mechanics Co., Ltd., Suwon-si (KR)

(72) Inventors: Jae Hyuk HUH, Suwon-si (KR); Seong Il CHO, Suwon-si (KR); You Jin JEONG, Suwon-si (KR); So Mi YANG, Suwon-si (KR); Joon JANG, Suwon-si (KR)

(73) Assignee: Samsung Electro-Mechanics Co., Ltd., Suwon-si (KR)

(21) Appl. No.: 19/385,733

(22) Filed: Nov. 11, 2025

(30) Foreign Application Priority Data
Dec. 31, 2024 (KR) 10-2024-0201614

(51) Int. Cl. G02B 9/62

(52) U.S. Cl. CPC G02B 9/62

(57) ABSTRACT

An optical imaging system includes a first lens having a positive refractive power; a second lens having a concave object-side surface in a paraxial region thereof; a third lens having a positive refractive power; a fourth lens having a negative refractive power; a fifth lens having a refractive power; and a sixth lens having a concave image-side surface in a paraxial region thereof, wherein the first to sixth lenses are sequentially disposed in ascending numerical order along an optical axis of the optical imaging system from an object side of the optical imaging system toward an imaging plane of the optical imaging system, and a conditional expression 0.6≤CT1/d2≤1.4 is satisfied, where CT1 is a thickness of the first lens along the optical axis, and d2 is an air gap along the optical axis between the second lens and the third lens.

### CROSS-REFERENCE TO RELATED APPLICATIONS

This application claims the benefit under 35 USC 119(a) of Korean Patent Application No. 10-2024-0201614 filed on Dec. 31, 2024, in the Korean Intellectual Property Office, the entire disclosure of which is incorporated herein by reference for all purposes.

### BACKGROUND

### 1. Field

The present disclosure relates to an optical imaging system.

### 2. Description of Background

Recently, in the mobile camera market, high-magnification telephoto cameras have adopted a folded system that bends a path of light on the front side of a lens.

To obtain high-quality images in a high-magnification mode, a large-sized image sensor and a large-diameter lens suitable for the size of the image sensor may be needed.

However, when a large-sized image sensor and a large-diameter lens are used in a folded system, a thickness of a module may increase, which may be problematic.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having a positive refractive power; a second lens having a concave object-side surface in a paraxial region thereof; a third lens having a positive refractive power; a fourth lens having a negative refractive power; a fifth lens having a refractive power; and a sixth lens having a concave image-side surface in a paraxial region thereof, wherein the first lens, the second lens, the third lens, the fourth lens, the fifth lens, and the sixth lens are sequentially disposed in ascending numerical order along an optical axis of the optical imaging system from an object side of the optical imaging system toward an imaging plane of the optical imaging system, and a conditional expression 0.6≤CT1/d2≤1.4 is satisfied, where CT1 is a thickness of the first lens along the optical axis, and d2 is an air gap along the optical axis between the second lens and the third lens.

An object-side surface of the first lens may be convex in a paraxial region thereof, and an image-side surface of the first lens may be convex in a paraxial region thereof.

The second lens may have a negative refractive power.

The fifth lens may have a positive refractive power, and the sixth lens may have a negative refractive power.

An object-side surface of the fifth lens may be convex in a paraxial region thereof, and an image-side surface of the fifth lens may be convex in a paraxial region thereof.

The first lens and the second lens may be D-cut lenses.

The second lens, the third lens, and the fourth lens may each have a refractive index of 1.6 or greater.

A conditional expression 0.1≤IMH/f≤0.4 may be satisfied, where IMH is one half of a diagonal length of the imaging plane, and f is a focal length of the optical imaging system.

A conditional expression 0.7≤SD1/IMH≤1.0 may be satisfied, where SD1 is a maximum effective radius of an object-side surface of the first lens, and IMH is one half of a diagonal length of the imaging plane.

A conditional expression 0.5≤EPD/Td≤0.9 may be satisfied, where EPD is an entrance pupil diameter of the optical imaging system, and Td is a total distance along the optical axis from an object-side surface of the first lens to the image-side surface of the sixth lens.

In another general aspect, an optical imaging system includes a first lens having a convex image-side surface in a paraxial region thereof; a second lens having a negative refractive power; a third lens having a positive refractive power; a fourth lens having a negative refractive power; a fifth lens having a positive refractive power and a convex object-side surface in a paraxial region thereof; and a sixth lens having a refractive power, wherein the first lens, the second lens, the third lens, the fourth lens, the fifth lens, and the sixth lens are sequentially disposed in ascending numerical order along an optical axis of the optical imaging system from an object side of the optical imaging system toward an imaging plane of the optical imaging system, the fifth lens has an Abbe number of 50 or more, and a conditional expression 0.1≤IMH/f≤0.4 is satisfied, where IMH is one half of a diagonal length of the imaging plane, and f is a focal length of the optical imaging system.

A conditional expression 0.4≤ΣAT/Td≤0.6 may be satisfied, where ΣAT is a sum of an air gap along the optical axis between the first lens and the second lens, an air gap along the optical axis between the second lens and the third lens, an air gap along the optical axis between the third lens and the fourth lens, an air gap along the optical axis between the fourth lens and the fifth lens, and an air gap along the optical axis between the fifth lens and the sixth lens, and Td is a total distance along the optical axis from an object-side surface of the first lens to an image-side surface of the sixth lens.

A conditional expression 0.7≤CT1/ET2≤1.5 may be satisfied, where CT1 is a thickness of the first lens along the optical axis, and ET2 is a peripheral thickness of the second lens at an edge of the second lens.

A conditional expression 0.5<AR1<1.0 may be satisfied, where AR1 is a ratio of a minor axis diameter of the first lens to a major axis diameter of the first lens.

A conditional expression 0.6≤f123/f≤1.2 may be satisfied, where f123 is a composite focal length of the first lens, the second lens, and the third lens, and f is the focal length of the optical imaging system.

An object-side surface of the sixth lens may be concave in a paraxial region thereof.

Other features and aspects will be apparent from the following detailed description, the drawings, and the claims.

### BRIEF DESCRIPTION OF DRAWINGS

FIG. 1A is a configuration diagram illustrating an optical imaging system according to a first embodiment of the present disclosure.

FIG. 1B is a graph showing aberration properties of the optical imaging system according to the first embodiment of the present disclosure.

FIG. 2A is a configuration diagram illustrating an optical imaging system according to a second embodiment of the present disclosure.

FIG. 2B is a graph showing aberration properties of the optical imaging system according to the second embodiment of the present disclosure.

FIG. 3A is a configuration diagram illustrating an optical imaging system according to a third embodiment of the present disclosure.

FIG. 3B is a graph showing aberration properties of the optical imaging system according to the third embodiment of the present disclosure.

FIG. 4A is a configuration diagram illustrating an optical imaging system according to a fourth embodiment of the present disclosure.

FIG. 4B is a graph showing aberration properties of the optical imaging system according to the fourth embodiment of the present disclosure.

FIG. 5A is a configuration diagram illustrating an optical imaging system according to a fifth embodiment of the present disclosure.

FIG. 5B is a graph showing aberration properties of the optical imaging system according to the fifth embodiment of the present disclosure.

FIG. 6A is a configuration diagram illustrating an optical imaging system according to a sixth embodiment of the present disclosure.

FIG. 6B is a graph showing aberration properties of the optical imaging system according to the sixth embodiment of the present disclosure.

FIG. 7A is a configuration diagram illustrating an optical imaging system according to a seventh embodiment of the present disclosure.

FIG. 7B is a graph showing aberration properties of the optical imaging system according to the seventh embodiment of the present disclosure.

FIG. 8A is a configuration diagram illustrating an optical imaging system according to an eighth embodiment of the present disclosure.

FIG. 8B is a graph showing aberration properties of the optical imaging system according to the eighth embodiment of the present disclosure.

FIG. 9A is a configuration diagram illustrating an optical imaging system according to a ninth embodiment of the present disclosure.

FIG. 9B is a graph showing aberration properties of the optical imaging system according to the ninth embodiment of the present disclosure.

FIG. 10A is a configuration diagram illustrating an optical imaging system according to a 10th embodiment of the present disclosure.

FIG. 10B is a graph showing aberration properties of the optical imaging system according to the 10th embodiment of the present disclosure.

FIG. 11A is a configuration diagram illustrating an optical imaging system according to an 11th embodiment of the present disclosure.

FIG. 11B is a graph showing aberration properties of the optical imaging system according to the 11th embodiment of the present disclosure.

FIG. 12A is a configuration diagram illustrating an optical imaging system according to a 12th embodiment of the present disclosure.

FIG. 12B is a graph showing aberration properties of the optical imaging system according to the 12th embodiment of the present disclosure.

FIG. 13A is a configuration diagram illustrating an optical imaging system according to a 13th embodiment of the present disclosure.

FIG. 13B is a graph showing aberration properties of the optical imaging system according to the 13th embodiment of the present disclosure.

FIG. 14A is a configuration diagram illustrating an optical imaging system according to a 14th embodiment of the present disclosure.

FIG. 14B is a graph showing aberration properties of the optical imaging system according to the 14th embodiment of the present disclosure.

FIG. 15A is a configuration diagram illustrating an optical imaging system according to a 15th embodiment of the present disclosure.

FIG. 15B is a graph showing aberration properties of the optical imaging system according to the 15th embodiment of the present disclosure.

FIG. 16A is a configuration diagram illustrating an optical imaging system according to a 16th embodiment of the present disclosure.

FIG. 16B is a graph showing aberration properties of the optical imaging system according to the 16th embodiment of the present disclosure.

FIG. 17A is a configuration diagram illustrating an optical imaging system according to a 17th embodiment of the present disclosure.

FIG. 17B is a graph showing aberration properties of the optical imaging system according to the 17th embodiment of the present disclosure.

FIG. 18A is a configuration diagram illustrating an optical imaging system according to an 18th embodiment of the present disclosure.

FIG. 18B is a graph showing aberration properties of the optical imaging system according to the 18th embodiment of the present disclosure.

FIG. 19A is a configuration diagram illustrating an optical imaging system according to a 19th embodiment of the present disclosure.

FIG. 19B is a graph showing aberration properties of the optical imaging system according to the 19th embodiment of the present disclosure.

FIG. 20A is a configuration diagram illustrating an optical imaging system according to a 20th embodiment of the present disclosure.

FIG. 20B is a graph showing aberration properties of the optical imaging system according to the 20th embodiment of the present disclosure.

FIG. 21A is a configuration diagram illustrating an optical imaging system according to a 21st embodiment of the present disclosure.

FIG. 21B is a graph showing aberration properties of the optical imaging system according to the 21st embodiment of the present disclosure.

FIG. 22A is a configuration diagram illustrating an optical imaging system according to a 22nd embodiment of the present disclosure.

FIG. 22B is a graph showing aberration properties of the optical imaging system according to the 22nd embodiment of the present disclosure.

FIG. 23 is an example of a D-cut lens according to embodiments of the present disclosure.

FIG. 24 is a configuration diagram illustrating a telephoto camera according to embodiments of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the drawings, a thickness, a size, and a shape of a lens may be exaggerated for clarity of illustration, and an aspherical shape of a lens is merely an example and is not limited thereto.

In the embodiments, a first lens may indicate a lens closest to an object side, and a sixth lens may indicate a lens closest to an image sensor.

Also, in the embodiments, a unit of a radius of curvature, a thickness, a distance, a focal length, an effective radius of a lens, and other measurements may be mm, and a unit of a field of view may be degrees (°).

In addition, in a description of a shape of a lens, a statement that a surface of a lens has a convex shape means that a paraxial region of the surface has a convex shape, and a statement that a surface of a lens has a concave shape means that a paraxial region of the surface has a concave shape. Accordingly, even when it is stated that a surface of a lens has a convex shape, an edge portion of the surface of the lens may have a concave shape. Similarly, even when it is stated that a surface of a lens has a concave shape, an edge portion of the surface of the lens may have a convex shape.

A paraxial region of a lens surface is a very narrow region around an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

The optical imaging system according to embodiments may include six lenses.

For example, an optical imaging system according to embodiments may include a first lens, a second lens, a third lens, a fourth lens, a fifth lens, and a sixth lens sequentially disposed in ascending numerical order along an optical axis of the optical imaging system from an object side of the optical imaging system toward an imaging plane of the optical imaging system.

However, the optical imaging system according to embodiments may include other components in addition to the six lenses.

For example, the optical imaging system according to embodiments may further include an image sensor configured to convert incident light into an electrical signal.

Also, for example, the optical imaging system may further include an infrared blocking filter (hereinafter referred to as a “filter”) configured to block infrared light incident on the image sensor. The filter may be disposed between the sixth lens and the image sensor.

Also, for example, the optical imaging system may further include a stop configured to adjust an amount of light reaching the image sensor. The stop may be disposed between the third and fourth lenses.

The optical imaging system according to embodiments may include a lens made of a plastic material.

For example, the first to sixth lenses according to embodiments may be made of a plastic material.

Also, the optical imaging system according to embodiments may include lenses made of plastic materials having different optical characteristics from each other.

For example, some lenses among the first to sixth lenses may be made of a plastic material having optical characteristics different from optical characteristics of a plastic material of which other lenses among the first to sixth lenses are made.

The optical imaging system according to embodiments may include at least one D-cut lens.

For example, according to embodiments, the first lens and the second lens may be D-cut lenses, and the other lenses (the third lens to the sixth lens) may be circular lenses.

A D-cut lens is a lens in which some edges of the lens are not circular. For example, some edges of the D-cut lens may be cut to form straight edges.

When viewed in an optical axis direction (the direction in which the first to sixth lenses are disposed), in the D-cut lens, each of two edges opposing each other in a major axis direction may have an arc shape, and each of two edges opposing each other in a minor axis direction may have a straight shape.

Also, according to embodiments, at least one of the first to sixth lenses may have an aspherical surface.

For example, object-side surfaces and image-side surfaces of the first to sixth lenses may be aspherical.

The aspherical surfaces of the first to sixth lenses may be represented by Equation 1 below.

$$Z = \frac{{cY}^{2}}{1 + \sqrt{1 - ( 1 + K )} {c}^{2} {Y}^{2}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system according to embodiments may satisfy any one or any combination or any two or more of Conditional Expressions 1 to 9 below.

$$0.5 < AR 1 < 1. \qquad ( Conditional Expression 1 )$$

$$0.6 \leq CT 1 / d 2 \leq 1.4 \qquad ( Conditional Expression 2 )$$

$$0.4 \leq \sum AΤ / Td \leq 0.6 \qquad ( Conditional Expression 3 )$$

$$0.7 \leq CT 1 / ET 2 \leq 1.5 \qquad ( Conditional Expression 4 )$$

$$0.1 \leq IMH / f \leq 0.4 \qquad ( Conditional Expression 5 )$$

$$0.5 \leq EPD / Td \leq 0.9 \qquad ( Conditional Expression 6 )$$

$$0.7 \leq SD 1 / IMH \leq 1. \qquad ( Conditional Expression 7 )$$

$$0.5 \leq ECT / Td \leq 0.8 \qquad ( Conditional Expression 8 )$$

$$0.6 \leq f 123 / f \leq 1.2 \qquad ( Conditional Expression 9 )$$

In Conditional Expression 1, AR1 may indicate a ratio of a minor axis diameter of the first lens to a major axis diameter of the first lens. When Conditional Expression 1 is satisfied, the first lens may be a D-cut lens, and the module thickness (height) may be reduced.

In Conditional Expression 2, CT1 may indicate a thickness of the first lens along the optical axis, and d2 may indicate an air gap (or a distance from an image-side surface of the second lens to an object-side surface of the third lens) along the optical axis between the second lens and the third lens. Conditional Expression 2 is related to a structure in which the third lens is disposed at a large distance from the first lens and the second lens, and when Conditional Expression 2 is satisfied, the sizes of the lenses subsequent to the third lens may be reduced.

In Conditional Expression 3, ΣAT may indicate a sum of air gaps along the optical axis between the lenses, and Td may indicate a total distance along the optical axis from an object-side surface of the first lens to an image-side surface of the sixth lens. Conditional Expression 3 is related to a structure in which an air gap between the lenses is set at a predetermined level or more, and when Conditional Expression 3 is satisfied, a curvature of an imaging plane may be effectively corrected.

In Conditional Expression 4, CT1 may indicate a thickness of the first lens along the optical axis, and ET2 may indicate a peripheral thickness of the second lens at an edge of the second lens. Conditional Expression 4 defines a ratio of the thickness of the first lens along the optical axis to the peripheral thickness of the second lens at an edge of the second lens to effectively correct aberration.

In Conditional Expression 5, IMH may indicate one half of the diagonal length of the imaging plane, and f may indicate a total focal length of the optical imaging system. A telephoto camera may have a relatively long focal length as compared to a size of an image sensor, and when Conditional Expression 5 is satisfied, the optical imaging system may correspond to a telephoto camera. In the drawings, IMG is shown as IMG HT.

In Conditional Expression 6, EPD may indicate an entrance pupil diameter of the optical imaging system, and Td may indicate a total distance along the optical axis from an object-side surface of the first lens to an image-side surface of the sixth lens. Conditional Expression 6 indicates a characteristic of a large-diameter telephoto camera, and when Conditional Expression 6 is satisfied, a relatively low F number may be obtained.

In Conditional Expression 7, SD1 may indicate a maximum effective radius of an object-side surface of the first lens, and IMH may indicate one half of a diagonal length of the imaging plane. Conditional Expression 7 reflects the characteristic in which the effective diameter of the lens is greater than the size of the image sensor, and when Conditional Expression 7 is satisfied, a relatively low F number may be obtained.

In Conditional Expression 8, ECT may indicate a sum of the thicknesses of the lenses along the optical axis, and Td may indicate a total distance from along the optical axis from an object-side surface of the first lens to an image-side surface of the sixth lens. In the case of an optical system having a large-sized image sensor and a low F number, the thicknesses of the lenses may be generally increased, and when Conditional Expression 8 is satisfied, aberration correction performance may be ensured.

In Conditional Expression 9, f123 may indicate a composite focal length of the first lens, the second lens, and the third lens, and f may indicate a total focal length of the optical imaging system. Conditional Expression 9 may be related to the characteristic in which the first lens to the third lens may greatly contribute to forming the total focal length of the optical imaging system.

In the description below, an optical imaging system according to embodiments will be described.

### First Embodiment

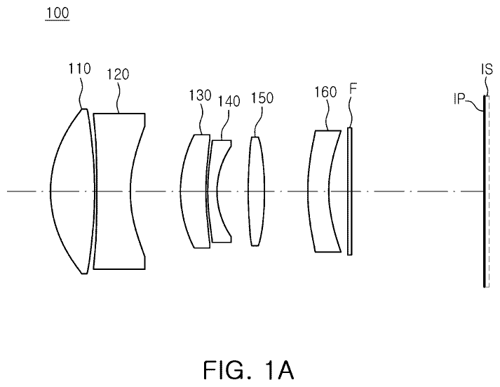

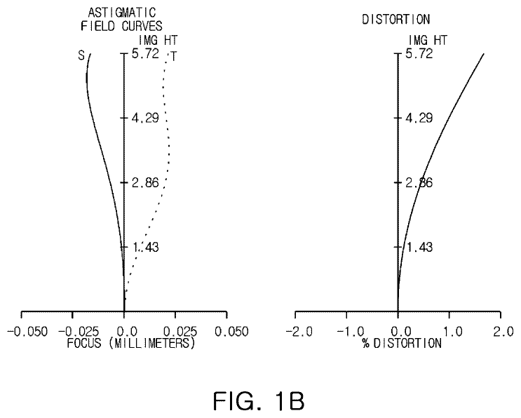

FIG. 1A is a configuration diagram illustrating an optical imaging system according to a first embodiment of the present disclosure. FIG. 1B is a graph showing aberration properties of the optical imaging system according to the first embodiment of the present disclosure.

An optical imaging system 100 according to the first embodiment may include a first lens 110, a second lens 120, a third lens 130, a fourth lens 140, a fifth lens 150, and a sixth lens 160 sequentially disposed in ascending numerical order along an optical axis of the optical imaging system 100 from an object side of the optical imaging system 100 toward an imaging plane IP of the optical imaging system 100, and may also include a filter F disposed on an image side of the sixth lens 160 and an image sensor IS including the imaging plane IP. Also, a stop (not shown) may be disposed between the third lens 130 and the fourth lens 140.

Table 1 below lists characteristics of each of the lenses and other elements included in the optical imaging system 100 according to the first embodiment.

TABLE 1

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.400 | 2.500 | 1.535 | 55.73 | 4.900 | 4.350 |
| 3 | Lens | −25.038 | 0.123 | | | 4.813 | 4.350 |
| 4 | Second | −101.955 | 1.896 | 1.614 | 25.95 | 4.637 | 4.350 |
| 5 | Lens | 8.119 | 2.846 | | | 3.882 | 4.350 |
| 6 | Third | 7.464 | 1.442 | 1.671 | 19.24 | 3.377 | |
| 7 | Lens | 14.983 | 0.100 | | | 3.098 | |
| 8 (Stop) | Fourth | 11.570 | 0.530 | 1.614 | 25.95 | 3.036 | |
| 9 | Lens | 4.885 | 1.767 | | | 2.720 | |
| 10 | Fifth | 23.785 | 0.923 | 1.535 | 55.73 | 3.163 | |
| 11 | Lens | −19.715 | 2.458 | | | 3.400 | |
| 12 | Sixth | 14.221 | 1.185 | 1.535 | 55.73 | 3.621 | |
| 13 | Lens | 8.155 | 1.082 | | | 3.700 | |
| 14 | Filter | Infinity | 0.210 | 1.518 | 64.17 | 3.795 | |
| 15 | | Infinity | 7.529 | | | 3.829 | |
| Image | | Infinity | | | | 5.804 | |

According to the first embodiment, the first lens 110 and the second lens 120 may be D-cut lenses.

According to the first embodiment, lenses having opposite refractive powers may be disposed in alternating order. For example, the first lens 110 may have a positive refractive power, the second lens 120 may have a negative refractive power, the third lens 130 may have a positive refractive power, the fourth lens 140 may have a negative refractive power, the fifth lens 150 may have a positive refractive power, and the sixth lens 160 may have a negative refractive power.

According to the first embodiment, an object-side surface and an image-side surface of the first lens 110 may be convex in respective paraxial regions thereof, and an object-side surface and an image-side surface of the second lens 120 may be concave in respective paraxial regions thereof. Object-side surfaces of the third lens 130 and the fourth lens 140 may be convex in respective paraxial regions thereof, and image-side surfaces of the third lens 130 and the fourth lens 140 may be concave in respective paraxial regions thereof. An object-side surface and an image-side surface of the fifth lens 150 may be convex in respective paraxial regions thereof. An object-side surface of the sixth lens 160 may be convex in a paraxial region thereof, and an image-side surface of the sixth lens 160 may be concave in a paraxial region thereof.

According to the first embodiment, the first lens 110, the second lens 120, and the third lens 130 may be made of plastic materials having different optical characteristics from each other. The fourth lens 140 may be made of the same plastic material as the second lens 120, and the fifth lens 150 and the sixth lens 160 may be made of the same plastic material as the first lens 110.

According to the first embodiment, the second lens 120, the third lens 130, and the fourth lens 140 may be high-index lenses each having a refractive index of 1.6 or greater.

Also, an Abbe number of each of the first lens 110, the fifth lens 150, and the sixth lens 160 may be 50 or more, an Abbe number of each of the second lens 120 and the fourth lens 140 may be 20 or more and less than 40, and an Abbe number of the third lens 130 may be less than 20.

Table 2 below lists aspheric coefficients of each of the lenses included in the optical imaging system 100 according to the first embodiment. According to the first embodiment, object-side surfaces and image-side surfaces of the first lens 110 to the sixth lens 160 may be

TABLE 2

| Surface No. | 2 | 3 | 4 | 5 | 6 | 7 |
|---|---|---|---|---|---|---|
| K | −0.611 | −4.386 | 0.000 | −0.056 | −0.191 | −53.823 |
| A | 7.574E−05 | 1.570E−04 | −2.764E−04 | −6.423E−04 | −6.235E−04 | −4.534E−04 |
| B | 1.112E−06 | −3.711E−07 | 6.243E−06 | −6.310E−06 | 2.557E−05 | 2.027E−05 |
| C | 4.234E−09 | −1.589E−08 | −1.072E−07 | −3.284E−07 | 2.862E−07 | 8.123E−07 |
| D | −5.390E−10 | −2.457E−09 | −3.055E−09 | 1.393E−08 | −1.784E−08 | 1.033E−07 |
| E | −1.997E−11 | −5.270E−11 | −4.247E−11 | −2.307E−10 | 1.451E−09 | 1.082E−09 |
| F | 2.146E−12 | −2.390E−12 | 2.407E−12 | −2.341E−11 | 3.113E−10 | −1.454E−10 |
| G | 4.107E−14 | 3.910E−15 | 6.663E−14 | 1.173E−12 | −1.718E−12 | −9.991E−12 |
| H | −3.753E−15 | −3.057E−16 | 3.353E−15 | 1.873E−13 | 6.218E−13 | 3.280E−14 |
| J | −3.746E−16 | 9.580E−17 | 2.619E−16 | −6.285E−15 | 4.310E−14 | 5.382E−16 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Surface No. | 9 | 9 | 10 | 11 | 12 | 13 |
| K | −24.879 | −0.022 | 3.859 | −44.078 | 0.000 | 0.000 |
| A | −4.787E−04 | −1.071E−03 | −8.541E−04 | −7.141E−04 | −4.347E−05 | −1.011E−03 |
| B | 2.857E−06 | 5.183E−05 | 1.849E−05 | −1.361E−05 | −6.765E−06 | 1.232E−05 |
| C | 2.919E−07 | 4.391E−06 | 2.612E−06 | −1.065E−06 | −2.108E−07 | −4.684E−07 |
| D | −3.916E−09 | 2.806E−07 | 8.829E−08 | −4.546E−08 | −2.859E−08 | −1.102E−08 |
| E | 4.775E−10 | −1.774E−08 | 3.801E−09 | −2.389E−09 | −7.785E−10 | −2.142E−10 |
| F | −6.425E−10 | −7.682E−10 | −7.029E−10 | −6.692E−10 | −6.867E−11 | −2.860E−11 |
| G | −9.255E−11 | 1.887E−11 | −4.849E−12 | 1.858E−11 | −2.517E−12 | −8.296E−13 |
| H | 1.109E−13 | 1.504E−12 | 2.077E−12 | 7.011E−13 | 3.246E−13 | −2.002E−13 |
| J | 2.195E−14 | 1.617E−20 | 5.513E−15 | 4.531E−14 | −1.460E−14 | 1.108E−14 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Second Embodiment

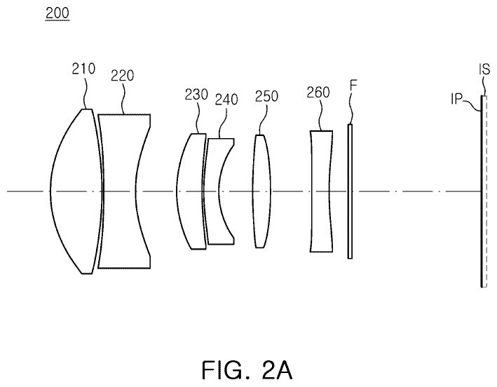

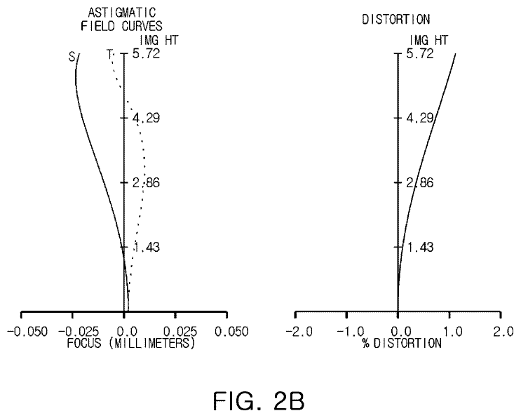

FIG. 2A is a configuration diagram illustrating an optical imaging system according to a second embodiment of the present disclosure. FIG. 2B is a graph showing aberration properties of the optical imaging system according to the second embodiment of the present disclosure.

An optical imaging system 200 according to the second embodiment may include a first lens 210, a second lens 220, a third lens 230, a fourth lens 240, a fifth lens 250, and a sixth lens 260 sequentially disposed in ascending numerical order along an optical axis of the optical imaging system 200 from an object side of the optical imaging system 200 toward an imaging plane IP of the optical imaging system 200, and may also include a filter F disposed on an image side of the sixth lens 260 and an image sensor IS including the imaging plane IP. Also, a stop (not shown) may be disposed between the third lens 230 and the fourth lens 240.

Table 3 below lists characteristics of each of the lenses and other elements included in the optical imaging system 200 according to the second embodiment.

TABLE 3

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.366 | 2.925 | 1.535 | 55.73 | 4.900 | 4.350 |
| 3 | Lens | −19.139 | 0.100 | | | 4.752 | 4.350 |
| 4 | Second | −44.783 | 1.797 | 1.614 | 25.95 | 4.576 | 4.350 |
| 5 | Lens | 8.016 | 2.336 | | | 3.852 | 4.350 |
| 6 | Third | 7.388 | 1.436 | 1.671 | 19.24 | 3.438 | |
| 7 | Lens | 16.796 | 0.102 | | | 3.198 | |
| 8 (Stop) | Fourth | 12.675 | 0.850 | 1.614 | 25.95 | 3.147 | |
| 9 | Lens | 4.937 | 1.923 | | | 2.800 | |
| 10 | Fifth | 26.147 | 1.011 | 1.535 | 55.73 | 3.271 | |
| 11 | Lens | −19.324 | 2.341 | | | 3.353 | |
| 12 | Sixth | 788.770 | 0.984 | 1.535 | 55.73 | 3.599 | |
| 13 | Lens | 19.064 | 1.082 | | | 3.800 | |
| 14 | Filter | Infinity | 0.210 | 1.518 | 64.17 | 4.005 | |
| 15 | | Infinity | 7.359 | | | 4.036 | |
| Image | | Infinity | | | | 5.785 | |

According to the second embodiment, the first lens 210 and the second lens 220 may be D-cut lenses.

According to the second embodiment, lenses having opposite refractive powers may be disposed in alternating order. For example, the first lens 210 may have a positive refractive power, the second lens 220 may have a negative refractive power, the third lens 230 may have a positive refractive power, the fourth lens 240 may have a negative refractive power, the fifth lens 250 may have a positive refractive power, and the sixth lens 260 may have a negative refractive power.

According to the second embodiment, an object-side surface and an image-side surface of the first lens 210 may be convex in respective paraxial regions thereof, and an object-side surface and an image-side surface of the second lens 220 may be concave in respective paraxial regions thereof. Object-side surfaces of the third lens 230 and the fourth lens 240 may be convex in respective paraxial regions thereof, and image-side surfaces of the third lens 230 and the fourth lens 240 may be concave in respective paraxial regions thereof. An object-side surface and an image-side surface of the fifth lens 250 may be convex in respective paraxial regions thereof. An object-side surface of the sixth lens 260 may be convex in a paraxial region thereof, and an image-side surface of the sixth lens 260 may be concave in a paraxial region thereof.

According to the second embodiment, the first lens 210, the second lens 220, and the third lens 230 may be made of plastic materials having different optical characteristics from each other. The fourth lens 240 may be made of the same plastic material as the second lens 220, and the fifth lens 250 and the sixth lens 260 may be made of the same plastic material as the first lens 210.

According to the first embodiment, the second lens 220, the third lens 230, and the fourth lens 240 may be high-index lenses each having a refractive index of 1.6 or greater.

Also, an Abbe number of each of the first lens 210, the fifth lens 250, and the sixth lens 260 may be 50 or more, an Abbe number of each of the second lens 220 and the fourth lens 240 may be 20 or more and less than 40, and an Abbe number of the third lens 230 may be less than 20.

Table 4 below lists aspheric coefficients of each of the lenses included in the optical imaging system 200 according to the second embodiment. According to the second embodiment, object-side surfaces and image-side surfaces of the first lens 210 to the sixth lens 260 may be aspherical.

TABLE 4

| Surface | | | | | | |
|---|---|---|---|---|---|---|
| No. | 2 | 3 | 4 | 5 | 6 | 7 |
| K | −0.605 | −3.964 | 0.000 | −0.074 | −0.199 | −54.843 |
| A | 7.767E−05 | 1.531E−04 | −2.752E−04 | −6.491E−04 | −6.275E−04 | −4.548E−04 |
| B | 1.279E−06 | −4.921E−07 | 6.221E−06 | −6.439E−06 | 2.566E−05 | 2.023E−05 |
| C | 7.603E−09 | −2.094E−08 | −1.094E−07 | −3.172E−07 | 3.690E−07 | 7.472E−07 |
| D | −5.201E−10 | −2.747E−09 | −3.098E−09 | 1.588E−08 | −1.020E−08 | 9.380E−08 |
| E | −1.954E−11 | −6.700E−11 | −4.129E−11 | −7.367E−11 | 1.472E−09 | 1.702E−09 |
| F | 2.169E−12 | −2.875E−12 | 2.462E−12 | −1.864E−11 | 3.113E−10 | −1.454E−10 |
| G | 4.326E−14 | −1.415E−14 | 6.746E−14 | 5.129E−13 | −1.718E−12 | −9.991E−12 |
| H | −3.756E−15 | −2.733E−16 | 3.325E−15 | 1.873E−13 | 6.218E−13 | 3.280E−14 |
| J | −3.806E−16 | 1.167E−16 | 2.429E−16 | −6.285E−15 | 4.310E−14 | 5.382E−16 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Surface | | | | | | |
|---|---|---|---|---|---|---|
| No. | 9 | 9 | 10 | 11 | 12 | 13 |
| K | −24.183 | −0.021 | 4.444 | −38.602 | 0.000 | 0.000 |
| A | −4.701E−04 | −1.082E−03 | −8.479E−04 | −7.181E−04 | −2.249E−04 | −9.190E−04 |
| B | 3.198E−06 | 5.698E−05 | 1.344E−05 | −1.124E−05 | −8.680E−06 | 9.155E−06 |
| C | 3.836E−07 | 5.032E−06 | 2.418E−06 | −1.121E−06 | −3.877E−07 | −5.914E−07 |
| D | 1.259E−08 | 2.689E−07 | 8.740E−08 | −4.013E−08 | −3.962E−08 | −1.443E−08 |
| E | 9.239E−10 | −1.774E−08 | 3.801E−09 | −2.389E−09 | −1.952E−09 | 6.971E−10 |
| F | −6.425E−10 | −7.682E−10 | −7.029E−10 | −6.692E−10 | −6.867E−11 | −2.860E−11 |
| G | −9.255E−11 | 1.887E−11 | −4.849E−12 | 1.858E−11 | −2.517E−12 | −8.296E−13 |
| H | 1.109E−13 | 1.504E−12 | 2.077E−12 | 7.011E−13 | 3.246E−13 | −2.002E−13 |
| J | 2.195E−14 | 1.617E−20 | 5.513E−15 | 4.531E−14 | −1.460E−14 | 1.108E−14 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Third Embodiment

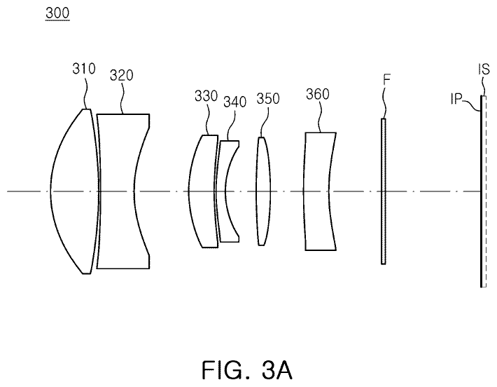

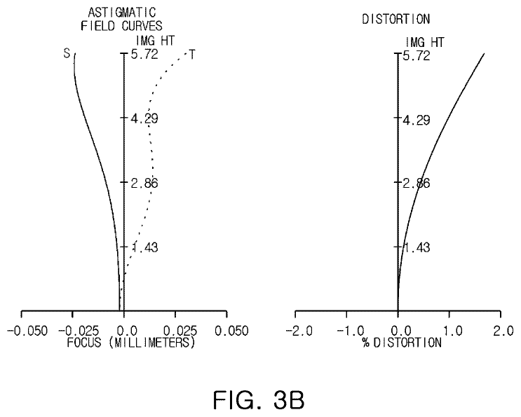

FIG. 3A is a configuration diagram illustrating an optical imaging system according to a third embodiment of the present disclosure. FIG. 3B is a graph showing aberration properties of the optical imaging system according to the third embodiment of the present disclosure.

An optical imaging system 300 according to the third embodiment may include a first lens 310, a second lens 320, a third lens 330, a fourth lens 340, a fifth lens 350, and a sixth lens 360 sequentially disposed in ascending numerical order along an optical axis of the optical imaging system 300 from an object side of the optical imaging system 300 toward an imaging plane IP of the optical imaging system 300, and may also include a filter F disposed on an image side of the sixth lens 360 and an image sensor IS including imaging plane IP. Also, a stop (not shown) may be disposed between the third lens 330 and the fourth lens 340.

Table 5 below lists characteristics of each of the lenses and other elements included in the optical imaging system 300 according to the third embodiment.

TABLE 5

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.232 | 2.733 | 1.535 | 55.73 | 4.900 | 4.350 |
| 3 | Lens | −22.871 | 0.100 | | | 4.780 | 4.350 |
| 4 | Second | −91.912 | 1.909 | 1.614 | 25.95 | 4.598 | 4.350 |
| 5 | Lens | 7.727 | 3.106 | | | 3.828 | 4.350 |
| 6 | Third | 7.449 | 1.440 | 1.671 | 19.24 | 3.342 | |
| 7 | Lens | 16.032 | 0.112 | | | 3.074 | |
| 8 (Stop) | Fourth | 12.193 | 0.525 | 1.614 | 25.95 | 3.011 | |
| 9 | Lens | 5.102 | 1.750 | | | 2.720 | |
| 10 | Fifth | 29.446 | 0.807 | 1.535 | 55.73 | 3.142 | |
| 11 | Lens | −19.502 | 1.880 | | | 3.204 | |
| 12 | Sixth | 32.739 | 1.438 | 1.535 | 55.73 | 3.504 | |
| 13 | Lens | 11.570 | 3.000 | | | 3.700 | |
| 14 | Filter | Infinity | 0.210 | 1.518 | 64.17 | 4.334 | |
| 15 | | Infinity | 5.446 | | | 4.368 | |
| Image | | Infinity | | | | 5.739 | |

According to the third embodiment, the first lens 310 and the second lens 320 may be D-cut lenses.

According to the third embodiment, lenses having opposite refractive powers may be disposed in alternating order. For example, the first lens 310 may have a positive refractive power, the second lens 320 may have a negative refractive power, the third lens 330 may have a positive refractive power, the fourth lens 340 may have a negative refractive power, the fifth lens 350 may have a positive refractive power, and the sixth lens 360 may have a negative refractive power.

According to the third embodiment, an object-side surface and an image-side surface of the first lens 310 may be convex in respective paraxial regions thereof, and an object-side surface and an image-side surface of the second lens 320 may be concave in respective paraxial regions thereof. Object-side surfaces of the third lens 330 and the fourth lens 340 may be convex in respective paraxial regions thereof, and image-side surfaces of the third lens 330 and the fourth lens 340 may be concave in respective paraxial regions thereof. An object-side surface and an image-side surface of the fifth lens 350 may be convex in respective paraxial regions thereof. An object-side surface of the sixth lens 360 may be convex in a respective paraxial region thereof, and an image-side surface of the sixth lens 360 may be concave in a respective paraxial region thereof.

According to the third embodiment, the first lens 310, the second lens 320, and the third lens 330 may be made of plastic materials having different optical characteristics from each other. The fourth lens 340 may be made of the same plastic material as the second lens 320, and the fifth lens 350 and the sixth lens 360 may be made of the same plastic material as the first lens 310.

According to the third embodiment, the second lens 320, the third lens 330, and the fourth lens 340 may be high-index lenses each having a refractive index of 1.6 or greater.

Also, an Abbe number of each of the first lens 310, the fifth lens 350, and the sixth lens 360 may be 50 or more, an Abbe number of each of the second lens 320 and the fourth lens 340 may be 20 or more and less than 40, and an Abbe number of the third lens 330 may be less than 20.

Table 6 below lists aspheric coefficients of each of the lenses included in the optical imaging system 300 according to the third embodiment. According to the third embodiment, object-side surfaces and image-side surfaces of the first lens 310 to the sixth lens 360 may be

TABLE 6

| Surface | | | | | | |
|---|---|---|---|---|---|---|
| No. | 2 | 3 | 4 | 5 | 6 | 7 |
| K | −0.608 | −4.05 | 0.000 | −0.055 | −0.233 | −55.130 |
| A | 7.660E−05 | 1.549E−04 | −2.748E−04 | −6.435E−04 | −6.399E−04 | −4.381E−04 |
| B | 1.182E−06 | −3.635E−07 | 6.260E−06 | −5.985E−06 | 2.475E−05 | 2.041E−05 |
| C | 1.152E−08 | −1.441E−08 | −1.062E−07 | −3.289E−07 | 3.483E−07 | 7.328E−07 |
| D | −3.469E−10 | −2.363E−09 | −3.047E−09 | 1.394E−08 | −1.199E−08 | 9.832E−08 |
| E | −1.627E−11 | −5.008E−11 | −4.132E−11 | −2.368E−10 | 1.830E−09 | 8.102E−10 |
| F | 2.226E−12 | −2.377E−12 | 2.531E−12 | −2.487E−11 | 3.391E−10 | −1.747E−10 |
| G | 4.382E−14 | 1.012E−15 | 7.302E−14 | 1.057E−12 | 5.873E−13 | −1.478E−11 |
| H | −3.643E−15 | −4.965E−16 | 3.471E−15 | 1.856E−13 | 8.098E−13 | −4.812E−13 |
| J | −3.711E−16 | 8.838E−17 | 2.492E−16 | −5.435E−15 | 5.352E−14 | −3.116E−14 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Surface | | | | | | |
|---|---|---|---|---|---|---|
| No | 9 | 9 | 10 | 11 | 12 | 13 |
| K | −24.440 | −0.005 | 1.798 | −42.620 | 0.000 | 0.000 |
| A | −4.925E−04 | −1.050E−03 | −8.702E−04 | −7.051E−04 | −1.044E−04 | −1.033E−03 |
| B | 1.754E−06 | 5.557E−05 | 1.804E−05 | −1.580E−05 | −1.025E−05 | 1.730E−05 |
| C | 2.349E−07 | 4.656E−06 | 2.979E−06 | −1.901E−06 | −2.928E−07 | −5.281E−07 |
| D | −1.678E−08 | 3.440E−07 | 9.623E−08 | −1.105E−07 | −5.430E−08 | −1.528E−08 |
| E | −1.355E−09 | −8.125E−09 | 1.755E−09 | −6.092E−09 | −3.038E−09 | −3.055E−10 |
| F | −8.395E−10 | 3.767E−11 | −9.643E−10 | −8.141E−10 | −1.715E−10 | −3.285E−11 |
| G | −1.101E−10 | 2.297E−11 | −1.462E−11 | 9.287E−12 | −3.092E−12 | −1.631E−12 |
| H | −1.609E−12 | −1.474E−11 | 2.687E−12 | 3.906E−13 | 5.859E−13 | −2.162E−13 |
| J | −1.777E−13 | 1.617E−20 | 5.513E−15 | 4.531E−14 | −1.206E−14 | 2.180E−14 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Fourth Embodiment

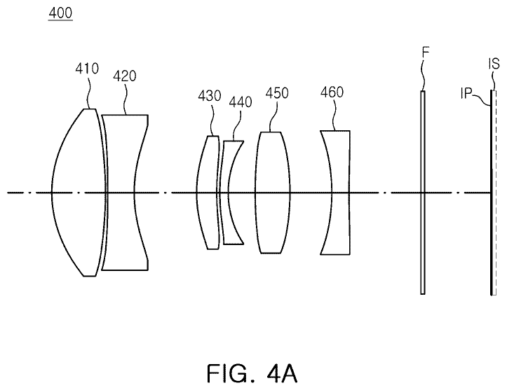

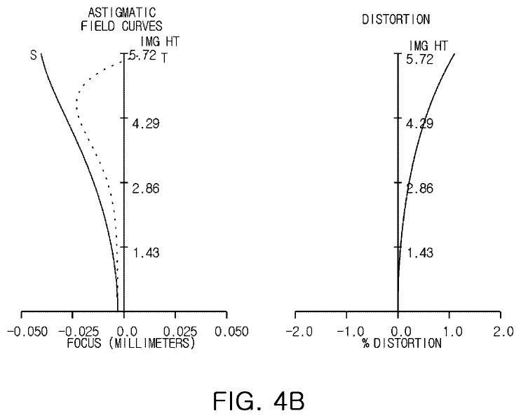

FIG. 4A is a configuration diagram illustrating an optical imaging system according to a fourth embodiment of the present disclosure. FIG. 4B is a graph showing aberration properties of the optical imaging system according to the fourth embodiment of the present disclosure.

An optical imaging system 400 according to the fourth embodiment may include a first lens 410, a second lens 420, a third lens 430, a fourth lens 440, a fifth lens 450, and a sixth lens 460 sequentially disposed in ascending numerical order along an optical axis of the optical imaging system 400 from an object side of the optical imaging system 400 toward an imaging plane IP of the optical imaging system 400, and may also include a filter F disposed on an image side of the sixth lens 460 and an image sensor IS including the imaging plane IP. Also, a stop (not shown) may be disposed between the third lens 430 and the fourth lens 440.

Table 7 below lists characteristics of each of the lenses and other elements included in the optical imaging system 400 according to the fourth embodiment.

TABLE 7

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.331 | 2.981 | 1.535 | 59.89 | 4.900 | 4.350 |
| 3 | Lens | −24.788 | 0.127 | | | 4.726 | 4.350 |
| 4 | Second | −79.349 | 1.475 | 1.614 | 27.51 | 4.540 | 4.350 |
| 5 | Lens | 8.515 | 3.473 | | | 3.985 | 4.350 |
| 6 | Third | 7.778 | 1.121 | 1.671 | 20.34 | 3.313 | |
| 7 | Lens | 14.788 | 0.172 | | | 3.168 | |
| 8 (Stop) | Fourth | 11.688 | 0.468 | 1.614 | 27.51 | 3.020 | |
| 9 | Lens | 5.742 | 1.501 | | | 2.984 | |
| 10 | Fifth | 24.087 | 1.934 | 1.535 | 59.89 | 3.370 | |
| 11 | Lens | −14.728 | 2.330 | | | 3.549 | |
| 12 | Sixth | −11.791 | 0.960 | 1.535 | 59.89 | 3.618 | |
| 13 | Lens | 49.957 | 4.000 | | | 3.864 | |
| 14 | Filter | Infinity | 0.210 | 1.518 | 64.17 | 6.000 | |
| 15 | | Infinity | 3.703 | | | 6.000 | |
| Image | | Infinity | | | | 5.870 | |

According to the fourth embodiment, the first lens 410 and the second lens 420 may be D-cut lenses.

According to the fourth embodiment, lenses having opposite refractive powers may be disposed in alternating order. For example, the first lens 410 may have a positive refractive power, the second lens 420 may have a negative refractive power, the third lens 430 may have a positive refractive power, the fourth lens 440 may have a negative refractive power, the fifth lens 450 may have a positive refractive power, and the sixth lens 460 may have a negative refractive power.

According to the fourth embodiment, an object-side surface and an image-side surface of the first lens 410 may be convex in respective paraxial regions thereof, and an object-side surface and an image-side surface of the second lens 420 may be concave in respective paraxial regions thereof. Object-side surfaces of the third lens 430 and the fourth lens 440 may be convex in respective paraxial regions thereof, and image-side surfaces of the third lens 430 and the fourth lens 440 may be concave in respective paraxial regions thereof. An object-side surface and an image-side surface of the fifth lens 450 may be convex in respective paraxial regions thereof. An object-side surface and an image-side surface of the sixth lens 460 may be concave in respective paraxial regions thereof.

According to the fourth embodiment, the first lens 410, the second lens 420, and the third lens 430 may be made of plastic materials having different optical characteristics from each other. The fourth lens 440 may be made of the same plastic material as the second lens 420, and the fifth lens 450 and the sixth lens 460 may be made of the same plastic material as the first lens 410.

According to the fourth embodiment, the second lens 420, the third lens 430, and the fourth lens 440 may be high-index lenses each having a refractive index of 1.6 or greater.

Also, an Abbe number of each of the first lens 410, the fifth lens 450, and the sixth lens 460 may be 50 or more, an Abbe number of each of the second lens 420 and the fourth lens 440 may be 20 or more and less than 40, and an Abbe number of the third lens 430 may be less than 30.

Table 8 below lists aspheric coefficients of each of the lenses included in the optical imaging system 400 according to the fourth embodiment. According to the fourth embodiment, object-side surfaces and image-side surfaces of the first lens 410 to the sixth lens 460 may be

TABLE 8

| Surface | | | | | | |
|---|---|---|---|---|---|---|
| No. | 2 | 3 | 4 | 5 | 6 | 7 |
| K | −0.687 | 0.689 | 0.000 | −0.220 | −1.263 | −38.748 |
| A | 5.209E−05 | 1.159E−04 | −2.820E−04 | −6.614E−04 | −8.806E−04 | −7.760E−04 |
| B | 4.443E−07 | −1.064E−06 | 3.124E−06 | 1.014E−06 | 3.227E−05 | −2.885E−05 |
| C | 5.804E−08 | −7.866E−08 | −2.586E−07 | −8.139E−07 | −4.153E−08 | −2.545E−06 |
| D | −1.084E−09 | −4.760E−09 | −1.307E−08 | −1.726E−08 | −1.336E−07 | −1.135E−07 |
| E | −6.985E−11 | −1.800E−10 | −3.708E−10 | −5.401E−10 | −1.328E−09 | 4.272E−09 |
| F | 4.326E−12 | −8.937E−12 | −7.034E−12 | −2.390E−11 | −4.091E−11 | −4.907E−10 |
| G | 2.352E−13 | −2.176E−13 | −9.131E−14 | 2.270E−12 | −2.301E−11 | 8.054E−13 |
| H | 7.703E−16 | 1.422E−16 | 1.696E−14 | 1.402E−13 | 9.115E−14 | 2.473E−13 |
| J | −7.505E−16 | 1.014E−15 | 2.179E−15 | 2.026E−15 | 7.964E−14 | 1.076E−13 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Surface | | | | | | |
| No. | 9 | 9 | 10 | 11 | 12 | 13 |
| K | −20.230 | 0.100 | 11.332 | −14.249 | 1.313 | 0.000 |
| A | −4.338E−04 | −1.226E−03 | −5.610E−04 | −3.925E−04 | −1.347E−04 | −8.234E−04 |
| B | −4.803E−06 | 1.123E−04 | 2.206E−06 | −2.853E−05 | −3.707E−06 | 2.198E−05 |
| C | −3.119E−06 | 6.509E−06 | 4.066E−06 | −3.270E−06 | 0.000E+00 | 0.000E+00 |
| D | −5.090E−07 | −2.090E−07 | 1.942E−07 | 2.240E−07 | 0.000E+00 | 0.000E+00 |
| E | −6.229E−09 | −2.332E−08 | 1.001E−08 | 2.634E−09 | 0.000E+00 | 0.000E+00 |
| F | 1.185E−09 | −3.331E−09 | −2.359E−09 | −8.014E−10 | 0.000E+00 | 0.000E+00 |
| G | −6.499E−11 | 8.324E−11 | 8.736E−12 | 9.637E−12 | 0.000E+00 | 0.000E+00 |
| H | 3.210E−12 | 5.908E−12 | 1.179E−12 | −4.180E−13 | 0.000E+00 | 0.000E+00 |
| J | 1.257E−14 | −1.958E−18 | 1.441E−13 | 8.804E−14 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Fifth Embodiment

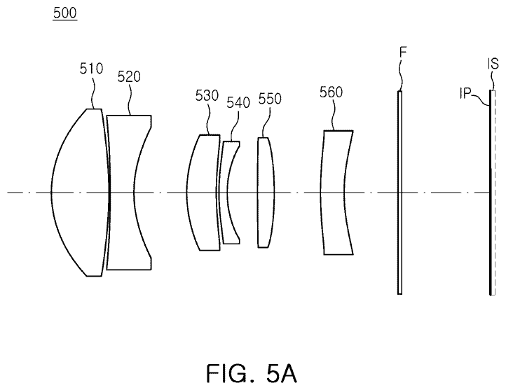

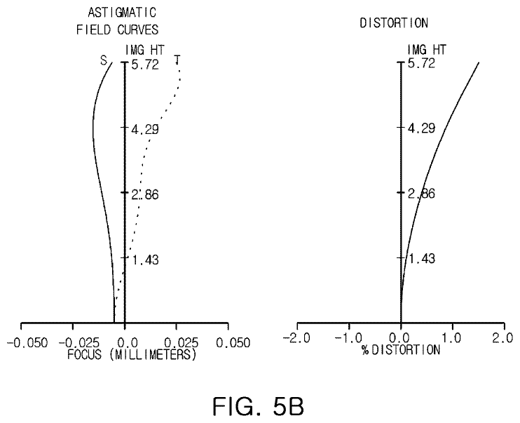

FIG. 5A is a configuration diagram illustrating an optical imaging system according to a fifth embodiment of the present disclosure. FIG. 5B is a graph showing aberration properties of the optical imaging system according to the fifth embodiment of the present disclosure.

An optical imaging system 500 according to the fifth embodiment may include a first lens 510, a second lens 520, a third lens 530, a fourth lens 540, a fifth lens 550, and a sixth lens 560 sequentially disposed in ascending numerical order along an optical axis of the optical imaging system 500 from an object side of the optical imaging system 500 toward an imaging plane IP of the optical imaging system 500, and may also include a filter F disposed on an image side of the sixth lens 560 and an image sensor IS including the imaging plane IP. Also, a stop (not shown) may be disposed between the third lens 530 and the fourth lens 540.

Table 9 below lists characteristics of each of the lenses and other elements included in the optical imaging system 500 according to the fifth embodiment.

TABLE 9

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 6.872 | 3.200 | 1.534 | 55.66 | 4.900 | 4.350 |
| 3 | Lens | −23.602 | 0.070 | | | 4.657 | 4.350 |
| 4 | Second | −73.898 | 1.323 | 1.614 | 25.94 | 4.515 | 4.350 |
| 5 | Lens | 7.326 | 2.942 | | | 3.825 | 4.350 |
| 6 | Third | 7.913 | 1.644 | 1.671 | 19.24 | 3.379 | |
| 7 | Lens | 15.890 | 0.149 | | | 3.081 | |
| 8 (Stop) | Fourth | 12.022 | 0.460 | 1.615 | 25.96 | 2.998 | |
| 9 | Lens | 5.871 | 1.690 | | | 2.750 | |
| 10 | Fifth | 71.079 | 0.932 | 1.534 | 55.66 | 3.101 | |
| 11 | Lens | −18.609 | 2.576 | | | 3.209 | |
| 12 | Sixth | 22.746 | 1.315 | 1.534 | 55.66 | 3.623 | |
| 13 | Lens | 10.288 | 3.000 | | | 3.800 | |
| 14 | Filter | Infinity | 0.210 | 1.518 | 64.17 | 6.000 | |
| 15 | | Infinity | 4.936 | | | 6.000 | |
| Image | | Infinity | | | | 5.764 | |

According to the fifth embodiment, the first lens 510 and the second lens 520 may be D-cut lenses.

According to the fifth embodiment, lenses having opposite refractive powers may be disposed in alternating order. For example, the first lens 510 may have a positive refractive power, the second lens 520 may have a negative refractive power, the third lens 530 may have a positive refractive power, the fourth lens 540 may have a negative refractive power, the fifth lens 550 may have a positive refractive power, and the sixth lens 560 may have a negative refractive power.

According to the fifth embodiment, an object-side surface and an image-side surface of the first lens 510 may be convex in respective paraxial regions thereof, and an object-side surface and an image-side surface of the second lens 520 may be concave in respective paraxial regions thereof. Object-side surfaces of the third lens 530 and the fourth lens 540 may be convex in respective paraxial regions thereof, and image-side surfaces of the third lens 530 and the fourth lens 540 may be concave in respective paraxial regions thereof. An object-side surface and an image-side surface of the fifth lens 550 may be convex in respective paraxial regions thereof. An object-side surface of the sixth lens 560 may be convex in a respective paraxial region thereof, and an image-side surface of the sixth lens 560 may be concave in a respective paraxial region thereof.

According to the fifth embodiment, the first lens 510, the second lens 520, and the third lens 530 may be made of plastic materials having different optical characteristics from each other. The fourth lens 540 may be made of the same plastic material as the second lens 520, and the fifth lens 550 and the sixth lens 560 may be made of the same plastic material as the first lens 510.

According to the fifth embodiment, the second lens 520, the third lens 530, and the fourth lens 540 may be high-index lenses each having a refractive index of 1.6 or greater.

Also, an Abbe number of each of the first lens 510, the fifth lens 550, and the sixth lens 560 may be 50 or more, an Abbe number of each of the second lens 520 and the fourth lens 540 may be 20 or more and less than 40, and an Abbe number of the third lens 530 may be less than 20.

Table 10 below lists aspheric coefficients of each of the lenses included in the optical imaging system 500 according to the fifth embodiment. According to the fifth embodiment, object-side surfaces and image-side surfaces of the first lens 510 to the sixth lens 560 may be

TABLE 10

| Surface | | | | | | |
|---|---|---|---|---|---|---|
| No. | 2 | 3 | 4 | 5 | 6 | 7 |
| K | −0.582 | −7.077 | 0.000 | −0.023 | −0.261 | −53.649 |
| A | 8.646E−05 | 1.647E−04 | −2.658E−04 | −6.335E−04 | −6.461E−04 | −4.810E−04 |
| B | 1.949E−06 | 1.903E−07 | 7.034E−06 | −5.209E−06 | 2.652E−05 | 1.844E−05 |
| C | 2.788E−08 | 9.231E−09 | −6.033E−08 | −2.161E−07 | 4.548E−07 | 5.543E−07 |
| D | −4.194E−11 | −1.694E−09 | −7.065E−10 | 2.147E−08 | −1.305E−08 | −2.722E−08 |
| E | −1.875E−11 | −4.539E−11 | 4.685E−11 | 3.841E−10 | 1.359E−09 | −2.889E−09 |
| F | 1.850E−12 | −2.357E−12 | 4.100E−12 | 1.125E−11 | 3.056E−10 | −2.643E−10 |
| G | 4.585E−14 | −1.674E−15 | 4.088E−14 | 1.751E−12 | −3.971E−12 | −3.213E−12 |
| H | −2.615E−15 | −2.292E−15 | −1.917E−15 | 1.188E−13 | −4.765E−15 | 2.319E−12 |
| J | −2.744E−16 | 2.911E−17 | −1.343E−16 | −1.498E−14 | −4.940E−14 | −9.414E−14 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Surface | | | | | | |
| No. | 9 | 9 | 10 | 11 | 12 | 13 |
| K | −0.582 | −7.077 | 0.000 | −0.023 | −0.261 | −53.649 |
| A | 8.646E−05 | 1.647E−04 | −2.658E−04 | −6.335E−04 | −6.461E−04 | −4.810E−04 |
| B | 1.949E−06 | 1.903E−07 | 7.034E−06 | −5.209E−06 | 2.652E−05 | 1.844E−05 |
| C | 2.788E−08 | 9.231E−09 | −6.033E−08 | −2.161E−07 | 4.548E−07 | 5.543E−07 |
| D | −4.194E−11 | −1.694E−09 | −7.065E−10 | 2.147E−08 | −1.305E−08 | −2.722E−08 |
| E | −1.875E−11 | −4.539E−11 | 4.685E−11 | 3.841E−10 | 1.359E−09 | −2.889E−09 |
| F | 1.850E−12 | −2.357E−12 | 4.100E−12 | 1.125E−11 | 3.056E−10 | −2.643E−10 |
| G | 4.585E−14 | −1.674E−15 | 4.088E−14 | 1.751E−12 | −3.971E−12 | −3.213E−12 |
| H | −2.615E−15 | −2.292E−15 | −1.917E−15 | 1.188E−13 | −4.765E−15 | 2.319E−12 |
| J | −2.744E−16 | 2.911E−17 | −1.343E−16 | −1.498E−14 | −4.940E−14 | −9.414E−14 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Sixth Embodiment

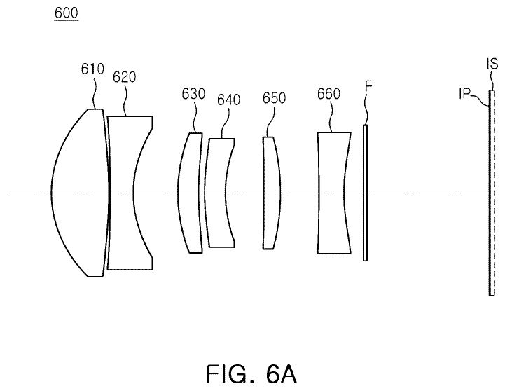

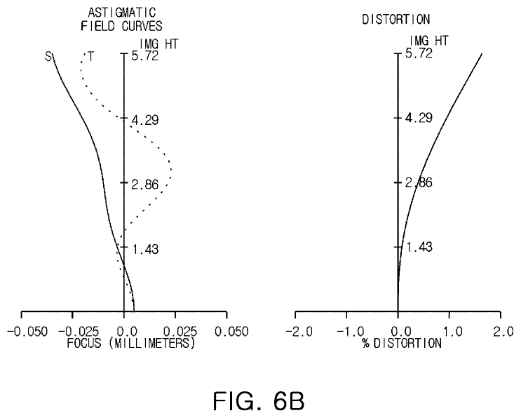

FIG. 6A is a configuration diagram illustrating an optical imaging system according to a sixth embodiment of the present disclosure. FIG. 6B is a graph showing aberration properties of the optical imaging system according to the sixth embodiment of the present disclosure.

An optical imaging system 600 according to the sixth embodiment may include a first lens 610, a second lens 620, a third lens 630, a fourth lens 640, a fifth lens 650, and a sixth lens 660 sequentially disposed in ascending numerical order along an optical axis of the optical imaging system 600 from an object side of the optical imaging system 600 toward an imaging plane IP of the optical imaging system 600, and may also include a filter F disposed on an image side of the sixth lens 660 and an image sensor IS including the imaging plane IP. Also, a stop (not shown) may be disposed between the third lens 630 and the fourth lens 640.

Table 11 below lists characteristics of each of the lenses and other elements included in the optical imaging system 600 according to the sixth embodiment.

TABLE 11

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 6.776 | 3.200 | 1.535 | 55.74 | 4.900 | 4.350 |
| 3 | Lens | −26.160 | 0.070 | | | 4.631 | 4.350 |
| 4 | Second | −113.676 | 1.288 | 1.614 | 25.94 | 4.494 | 4.350 |
| 5 | Lens | 6.715 | 2.486 | | | 3.778 | 4.350 |
| 6 | Third | 9.341 | 1.157 | 1.671 | 19.24 | 3.502 | |
| 7 | Lens | 18.877 | 0.333 | | | 3.324 | |
| 8 (Stop) | Fourth | 13.712 | 1.162 | 1.614 | 25.94 | 3.180 | |
| 9 | Lens | 7.972 | 2.146 | | | 2.824 | |
| 10 | Fifth | 672.637 | 0.918 | 1.535 | 55.74 | 3.189 | |
| 11 | Lens | −13.956 | 2.143 | | | 3.275 | |
| 12 | Sixth | 69.423 | 1.396 | 1.535 | 55.74 | 3.547 | |
| 13 | Lens | 11.158 | 1.082 | | | 3.800 | |
| 14 | Filter | Infinity | 0.210 | 1.518 | 64.17 | 4.002 | |
| 15 | | Infinity | 6.861 | | | 4.041 | |
| Image | | Infinity | | | | 6.061 | |

According to the sixth embodiment, the first lens 610 and the second lens 620 may be D-cut lenses.

According to the sixth embodiment, lenses having opposite refractive powers may be disposed in alternating order. For example, the first lens 610 may have a positive refractive power, the second lens 620 may have a negative refractive power, the third lens 630 may have a positive refractive power, the fourth lens 640 may have a negative refractive power, the fifth lens 650 may have a positive refractive power, and the sixth lens 660 may have a negative refractive power.

According to the sixth embodiment, an object-side surface and an image-side surface of the first lens 610 may be convex in respective paraxial regions thereof, and an object-side surface and an image-side surface of the second lens 620 may be concave in respective paraxial regions thereof. Object-side surfaces of the third lens 630 and the fourth lens 640 may be convex in respective paraxial regions thereof, and image-side surfaces of the third lens 630 and the fourth lens 640 may be concave in respective paraxial regions thereof. An object-side surface and an image-side surface of the fifth lens 650 may be convex in respective paraxial regions thereof. An object-side surface of the sixth lens 660 may be convex in a paraxial region thereof, and an image-side surface of the sixth lens 660 may be concave in a paraxial region thereof.

According to the sixth embodiment, the first lens 610, the second lens 620, and the third lens 630 may be made of plastic materials having different optical characteristics from each other. The fourth lens 640 may be made of the same plastic material as the second lens 620, and the fifth lens 650 and the sixth lens 660 may be made of the same plastic material as the first lens 610.

According to the sixth embodiment, the second lens 620, the third lens 630, and the fourth lens 640 may be high-index lenses each having a refractive index of 1.6 or greater.

Also, an Abbe number of each of the first lens 610, the fifth lens 650, and the sixth lens 660 may be 50 or more, an Abbe number of each of the second lens 620 and the fourth lens 640 may be 20 or more and less than 40, and an Abbe number of the third lens 630 may be less than 20.

Table 12 below lists aspheric coefficients of each of the lenses included in the optical imaging system 600 according to the sixth embodiment. According to the sixth embodiment, object-side surfaces and image-side surfaces of the first lens 610 to the sixth lens 660 may be

TABLE 12

| Surface | | | | | | |
|---|---|---|---|---|---|---|
| No. | 2 | 3 | 4 | 5 | 6 | 7 |
| K | −0.569 | −11.947 | 0.000 | −0.029 | −0.531 | −60.567 |
| A | 9.246E−05 | 1.829E−04 | −2.463E−04 | −6.414E−04 | −7.142E−04 | −4.789E−04 |
| B | 2.728E−06 | 1.167E−06 | 7.587E−06 | −3.174E−06 | 2.268E−05 | 1.602E−05 |
| C | 5.421E−08 | 2.968E−08 | −4.685E−08 | −6.780E−08 | 5.035E−07 | 2.955E−07 |
| D | 4.350E−10 | −2.148E−09 | −1.127E−09 | 2.668E−08 | 3.951E−09 | −8.365E−09 |
| E | −1.353E−11 | −7.645E−11 | 8.087E−13 | 6.521E−10 | 1.567E−09 | 5.227E−09 |
| F | 2.222E−12 | −3.360E−12 | −5.581E−13 | 3.251E−11 | 3.073E−10 | −2.593E−10 |
| G | 7.491E−14 | −1.343E−14 | −2.273E−13 | 2.819E−12 | 6.765E−12 | −1.406E−11 |
| H | −1.675E−15 | −2.283E−15 | −4.674E−15 | −1.540E−13 | −1.133E−13 | 2.020E−12 |
| J | −1.881E−16 | 7.243E−17 | 2.408E−16 | −1.465E−14 | −4.411E−14 | 5.382E−16 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Surface | | | | | | |
| No. | 9 | 9 | 10 | 11 | 12 | 13 |
| K | −23.362 | −0.248 | 99.000 | −23.980 | −23.933 | −0.069 |
| A | −4.466E−04 | −1.087E−03 | −1.276E−03 | −9.180E−04 | −1.045E−04 | −1.370E−03 |
| B | 1.057E−05 | 4.716E−05 | 5.279E−04 | 9.725E−05 | −4.789E−04 | −3.997E−05 |
| C | 1.164E−06 | 2.759E−06 | −3.806E−04 | 2.945E−05 | 2.885E−04 | 2.687E−05 |
| D | −3.028E−08 | 5.265E−07 | 1.823E−04 | −3.792E−05 | −1.106E−04 | −7.451E−06 |
| E | 3.974E−11 | −2.237E−08 | −5.782E−05 | 1.539E−05 | 2.787E−05 | 1.334E−06 |
| F | −5.891E−10 | 3.461E−11 | 1.236E−05 | −3.627E−06 | −4.795E−06 | −1.801E−07 |
| G | −6.788E−11 | 2.287E−11 | −1.782E−06 | 5.476E−07 | 5.673E−07 | 1.896E−08 |
| H | 5.375E−12 | 1.504E−12 | 1.708E−07 | −5.382E−08 | −4.539E−08 | −1.471E−09 |
| J | 2.195E−14 | 1.618E−20 | −1.041E−08 | 3.350E−09 | 2.346E−09 | 7.618E−11 |
| L | 0.000E+00 | 0.000E+00 | 3.642E−10 | −1.206E−10 | −7.066E−11 | −2.304E−12 |
| M | 0.000E+00 | 0.000E+00 | −5.551E−12 | 1.921E−12 | 9.422E−13 | 3.048E−14 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Seventh Embodiment

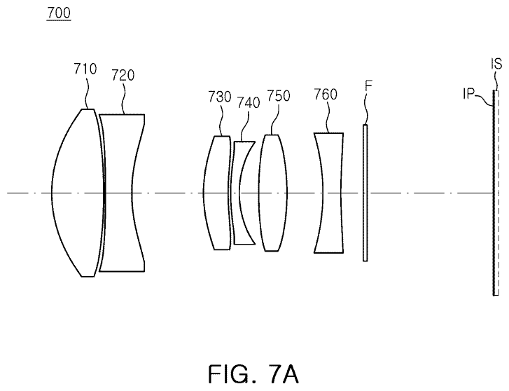

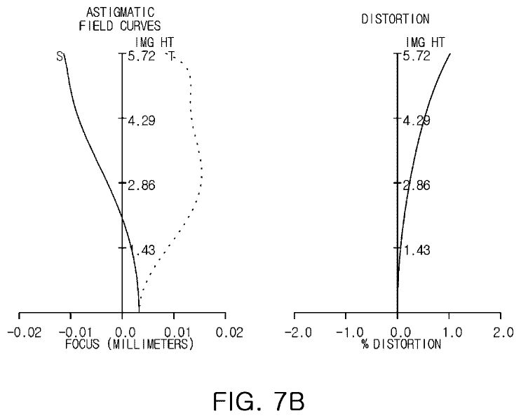

FIG. 7A is a configuration diagram illustrating an optical imaging system according to a seventh embodiment of the present disclosure. FIG. 7B is a graph showing aberration properties of the optical imaging system according to the seventh embodiment of the present disclosure.

An optical imaging system 700 according to the seventh embodiment may include a first lens 710, a second lens 720, a third lens 730, a fourth lens 740, a fifth lens 750, and a sixth lens 760 sequentially disposed in ascending numerical order along an optical axis of the optical imaging system 700 from an object side of the optical imaging system 700 toward an imaging plane IP of the optical imaging system 700, and may also include a filter F disposed on an image side of the sixth lens 760 and an image sensor IS including the imaging plane IP. Also, a stop (not shown) may be disposed between the third lens 730 and the fourth lens 740.

Table 13 below lists characteristics of each of the lenses and other elements included in the optical imaging system 700 according to the seventh embodiment.

TABLE 13

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.610 | 2.900 | 1.535 | 59.89 | 4.900 | 4.350 |
| 3 | Lens | −26.576 | 0.087 | | | 4.736 | 4.350 |
| 4 | Second | −90.350 | 1.472 | 1.614 | 27.51 | 4.588 | 4.350 |
| 5 | Lens | 9.237 | 4.000 | | | 4.100 | 4.350 |
| 6 | Third | 8.215 | 1.377 | 1.671 | 20.34 | 3.450 | |
| 7 | Lens | 15.054 | 0.138 | | | 3.116 | |
| 8 (Stop) | Fourth | 11.902 | 0.480 | 1.614 | 27.51 | 3.000 | |
| 9 | Lens | 5.664 | 1.082 | | | 2.980 | |
| 10 | Fifth | 19.318 | 1.579 | 1.535 | 59.89 | 3.300 | |
| 11 | Lens | −13.113 | 2.000 | | | 3.394 | |
| 12 | Sixth | −12.922 | 1.000 | 1.535 | 59.89 | 3.503 | |
| 13 | Lens | 27.592 | 1.253 | | | 3.718 | |
| 14 | Filter | Infinity | 0.210 | 1.518 | 64.17 | 3.986 | |
| 15 | | Infinity | 7.071 | | | 4.019 | |
| Image | | Infinity | | | | 5.848 | |

According to the seventh embodiment, the first lens 710 and the second lens 720 may be D-cut lenses.

According to the seventh embodiment, lenses having opposite refractive powers may be disposed in alternating order. For example, the first lens 710 may have a positive refractive power, the second lens 720 may have a negative refractive power, the third lens 730 may have a positive refractive power, the fourth lens 740 may have a negative refractive power, the fifth lens 750 may have a positive refractive power, and the sixth lens 760 may have a negative refractive power.

According to the seventh embodiment, an object-side surface and an image-side surface of the first lens 710 may be convex in respective paraxial regions thereof, and an object-side surface and an image-side surface of the second lens 720 may be concave in respective paraxial regions thereof. Object-side surfaces of the third lens 730 and the fourth lens 740 may be convex in respective paraxial regions thereof, and image-side surfaces of the third lens 730 and the fourth lens 740 may be concave in respective paraxial regions thereof. An object-side surface and an image-side surface of the fifth lens 750 may be convex in respective paraxial regions thereof. An object-side surface and an image-side surface of the sixth lens 760 may be concave in respective paraxial regions thereof.

According to the seventh embodiment, the first lens 710, the second lens 720, and the third lens 730 may be made of plastic materials having different optical characteristics from each other. The fourth lens 740 may be made of the same plastic material as the second lens 720, and the fifth lens 750 and the sixth lens 760 may be made of the same plastic material as the first lens 710.

According to the seventh embodiment, the second lens 720, the third lens 730, and the fourth lens 740 may be high-index lenses each having a refractive index of 1.6 or greater.

Also, an Abbe number of each of the first lens 710, the fifth lens 750, and the sixth lens 760 may be 50 or more, an Abbe number of each of the second lens 720 and the fourth lens 740 may be 20 or more and less than 40, and an Abbe number of the third lens 730 may be less than 30.

Table 14 below lists aspheric coefficients of each of the lenses included in the optical imaging system 700 according to the seventh embodiment. According to the seventh embodiment, object-side surfaces and image-side surfaces of the first lens 710 to the sixth lens 760 may be aspherical.

TABLE 14

| Surface | | | | | | |
|---|---|---|---|---|---|---|
| No. | 2 | 3 | 4 | 5 | 6 | 7 |
| K | −0.745 | 1.324 | 0.000 | −0.280 | −1.105 | −39.725 |
| A | 3.057E−05 | 1.096E−04 | −2.803E−04 | −6.778E−04 | −8.441E−04 | −7.857E−04 |
| B | 4.950E−07 | −1.381E−06 | 2.947E−06 | 1.100E−06 | 3.324E−05 | −2.777E−05 |
| C | 3.792E−08 | −1.012E−07 | −2.746E−07 | −6.951E−07 | −3.757E−08 | −2.476E−06 |
| D | −1.374E−09 | −5.961E−09 | −1.376E−08 | −9.150E−09 | −1.084E−07 | −1.211E−07 |
| E | −5.851E−11 | −2.257E−10 | −4.000E−10 | −2.851E−10 | 1.233E−09 | 4.222E−09 |
| F | 4.923E−12 | −1.028E−11 | −7.987E−12 | −2.454E−11 | 1.730E−10 | −4.860E−10 |
| G | 2.417E−13 | −2.360E−13 | −1.066E−13 | 2.045E−12 | −1.168E−11 | 1.096E−11 |
| H | 4.843E−16 | 1.143E−15 | 1.696E−14 | 1.194E−13 | 5.707E−13 | 2.394E−14 |
| J | −7.801E−16 | 1.209E−15 | 2.283E−15 | 6.060E−16 | 4.328E−14 | 5.363E−16 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Surface | | | | | | |
|---|---|---|---|---|---|---|
| No. | 9 | 9 | 10 | 11 | 12 | 13 |
| K | −19.179 | 0.109 | 10.462 | −17.640 | 0.000 | 0.000 |
| A | −4.220E−04 | −1.239E−03 | −5.933E−04 | −2.289E−04 | 0.000E+00 | −1.016E−03 |
| B | −8.298E−06 | 1.161E−04 | 5.206E−06 | −2.318E−05 | 0.000E+00 | 3.088E−05 |
| C | −3.635E−06 | 7.577E−06 | 4.813E−06 | −4.411E−06 | 0.000E+00 | 0.000E+00 |
| D | −5.449E−07 | −8.882E−08 | 2.389E−07 | 1.053E−07 | 0.000E+00 | 0.000E+00 |
| E | −9.663E−09 | −2.015E−08 | 9.193E−09 | −9.027E−11 | 0.000E+00 | 0.000E+00 |
| F | 8.803E−10 | −3.627E−09 | −2.489E−09 | −7.826E−10 | 0.000E+00 | 0.000E+00 |
| G | −1.051E−10 | 1.868E−11 | 7.530E−12 | 2.418E−11 | 0.000E+00 | 0.000E+00 |
| H | 1.010E−13 | 1.504E−12 | 2.094E−12 | 7.058E−13 | 0.000E+00 | 0.000E+00 |
| J | 2.195E−14 | −1.956E−18 | 5.511E−15 | 4.531E−14 | 0.000E+00 | 0.000E+00 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Eighth Embodiment

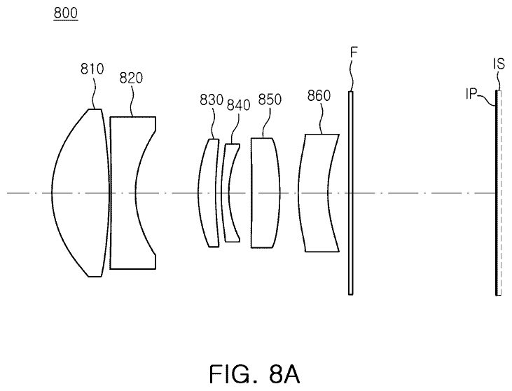

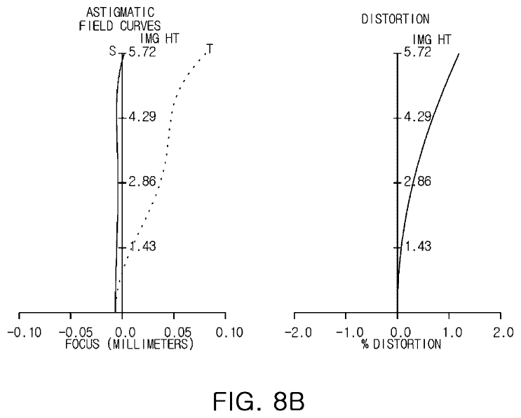

FIG. 8A is a configuration diagram illustrating an optical imaging system according to an eighth embodiment of the present disclosure. FIG. 8B is a graph showing aberration properties of the optical imaging system according to the eighth embodiment of the present disclosure.

An optical imaging system 800 according to the eighth embodiment may include a first lens 810, a second lens 820, a third lens 830, a fourth lens 840, a fifth lens 850, and a sixth lens 860 sequentially disposed in ascending numerical order along an optical axis of the optical imaging system 800 from an object side of the optical imaging system 800 toward an imaging plane IP of the optical imaging system 800, and may also include a filter F disposed on an image side of the sixth lens 860 and an image sensor IS including the imaging plane IP. Also, a stop (not shown) may be disposed between the third lens 830 and the fourth lens 840.

Table 15 below lists characteristics of each of the lenses and other elements included in the optical imaging system 800 according to the eighth embodiment.

TABLE 15

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 6.512 | 3.200 | 1.534 | 55.66 | 4.900 | 4.350 |
| 3 | Lens | −23.983 | 0.100 | | | 4.702 | 4.350 |
| 4 | Second | −859.733 | 1.357 | 1.614 | 27.51 | 4.448 | 4.350 |
| 5 | Lens | 6.221 | 3.500 | | | 3.640 | 4.350 |
| 6 | Third | 8.426 | 0.963 | 1.671 | 20.34 | 3.154 | |
| 7 | Lens | 17.434 | 0.322 | | | 3.006 | |
| 8 (Stop) | Fourth | 13.028 | 0.416 | 1.614 | 27.51 | 2.862 | |
| 9 | Lens | 6.223 | 1.279 | | | 2.656 | |
| 10 | Fifth | 7917.638 | 1.569 | 1.534 | 55.66 | 2.908 | |
| 11 | Lens | −13.513 | 1.027 | | | 3.200 | |
| 12 | Sixth | 12.289 | 1.644 | 1.534 | 55.66 | 3.500 | |
| 13 | Lens | 7.470 | 1.169 | | | 3.594 | |
| 14 | Filter | Infinity | 0.210 | 1.518 | 64.17 | 6.000 | |
| 15 | | Infinity | 8.015 | | | 6.000 | |
| Image | | Infinity | 0.007 | | | 5.778 | |

According to the eighth embodiment, the first lens 810 and the second lens 820 may be D-cut lenses.

According to the eighth embodiment, lenses having opposite refractive powers may be disposed in alternating order. For example, the first lens 810 may have a positive refractive power, the second lens 820 may have a negative refractive power, the third lens 830 may have a positive refractive power, the fourth lens 840 may have a negative refractive power, the fifth lens 850 may have a positive refractive power, and the sixth lens 860 may have a negative refractive power.

According to the eighth embodiment, an object-side surface and an image-side surface of the first lens 810 may be convex in respective paraxial regions thereof, and an object-side surface and an image-side surface of the second lens 820 may be concave in respective paraxial regions thereof. Object-side surfaces of the third lens 830 and the fourth lens 840 may be convex in respective paraxial regions thereof, and image-side surfaces of the third lens 830 and the fourth lens 840 may be concave in respective paraxial regions thereof. An object-side surface and an image-side surface of the fifth lens 850 may be convex in respective paraxial regions thereof. An object-side surface of the sixth lens 860 may be convex in a paraxial region thereof, and an image-side surface of the sixth lens 860 may be concave in a paraxial region thereof.

According to the eighth embodiment, the first lens 810, the second lens 820, and the third lens 830 may be made of plastic materials having different optical characteristics from each other. The fourth lens 840 may be made of the same plastic material as the second lens 820, and the fifth lens 850 and the sixth lens 860 may be made of the same plastic material as the first lens 810.

According to the eighth embodiment, the second lens 820, the third lens 830, and the fourth lens 840 may be high-index lenses each having a refractive index of 1.6 or greater.

Also, an Abbe number of each of the first lens 810, the fifth lens 850, and the sixth lens 860 may be 50 or more, an Abbe number of each of the second lens 820 and the fourth lens 840 may be 20 or more and less than 40, and an Abbe number of the third lens 830 may be less than 30.

Table 16 below lists aspheric coefficients of each of the lenses included in the optical imaging system 800 according to the eighth embodiment. According to the eighth embodiment, object-side surfaces and image-side surfaces of the first lens 810 to the sixth lens 860 may be

TABLE 16

| Surface | | | | | | |
|---|---|---|---|---|---|---|
| No. | 2 | 3 | 4 | 5 | 6 | 7 |
| K | −0.550 | −9.650 | 0.000 | 0.157 | −0.177 | −51.813 |
| A | 1.157E−04 | 1.757E−04 | −2.804E−04 | −4.469E−04 | −6.189E−04 | −5.154E−04 |
| B | 1.227E−06 | −1.241E−06 | 8.608E−06 | −1.081E−05 | 2.752E−05 | 1.443E−05 |
| C | 7.071E−09 | −4.192E−08 | −2.666E−08 | −3.685E−07 | 4.880E−07 | 7.211E−07 |
| D | −1.864E−09 | −3.528E−09 | −1.932E−10 | 2.094E−08 | 3.190E−08 | 4.938E−08 |
| E | −7.816E−11 | −7.112E−11 | 5.934E−11 | 6.579E−11 | 4.353E−09 | −1.134E−09 |
| F | −5.670E−14 | −3.039E−12 | −5.778E−12 | −8.167E−11 | 5.839E−10 | 4.604E−10 |
| G | 8.200E−15 | −8.206E−16 | 5.317E−14 | 1.637E−12 | −1.218E−11 | −1.575E−12 |
| H | −3.710E−15 | 8.844E−16 | 3.165E−15 | 2.024E−13 | 1.006E−12 | 2.234E−13 |
| J | −3.750E−16 | 3.382E−17 | 5.671E−16 | −1.014E−14 | 3.440E−14 | 3.846E−15 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Surface | | | | | | |
| No. | 9 | 9 | 10 | 11 | 12 | 13 |
| K | −20.854 | −0.116 | 99.000 | −39.726 | 0.000 | 0.000 |
| A | −3.936E−04 | −1.152E−03 | −8.875E−04 | −5.881E−04 | 2.112E−04 | −1.822E−03 |
| B | 2.372E−06 | 5.630E−05 | −3.730E−07 | 2.218E−06 | −3.487E−05 | 4.916E−05 |
| C | −1.154E−07 | 5.902E−06 | 3.344E−06 | −8.761E−07 | −1.762E−06 | 1.326E−07 |
| D | −7.167E−08 | 5.449E−07 | 5.095E−07 | −4.756E−07 | 6.286E−08 | −3.153E−07 |
| E | 5.731E−10 | 2.110E−08 | 2.664E−08 | −2.023E−08 | −1.301E−08 | −2.095E−09 |
| F | −5.611E−10 | −2.551E−10 | −5.737E−09 | −2.374E−13 | −1.497E−09 | 1.048E−09 |
| G | −1.481E−10 | −9.546E−14 | 2.962E−12 | −1.418E−11 | 6.581E−11 | −3.587E−11 |
| H | 9.479E−14 | −6.308E−12 | 1.810E−12 | 1.070E−12 | 7.796E−13 | 3.654E−13 |
| J | 4.446E−14 | 1.851E−20 | 3.718E−14 | 5.897E−14 | 1.301E−14 | 1.982E−14 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

### Ninth Embodiment

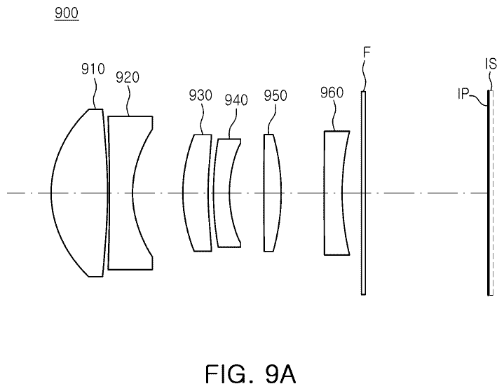

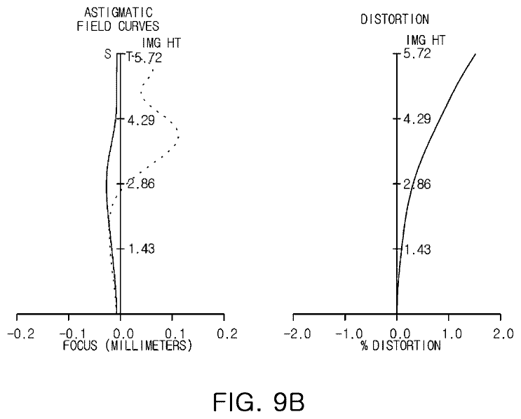

FIG. 9A is a configuration diagram illustrating an optical imaging system according to a ninth embodiment of the present disclosure. FIG. 9B is a graph showing aberration properties of the optical imaging system according to the ninth embodiment of the present disclosure.

An optical imaging system 900 according to the ninth embodiment may include a first lens 910, a second lens 920, a third lens 930, a fourth lens 940, a fifth lens 950, and a sixth lens 960 sequentially disposed in ascending numerical order along an optical axis of the optical imaging system 900 from an object side of the optical imaging system 900 toward an imaging plane IP of the optical imaging system 900, and may also include a filter F disposed on an image side of the sixth lens 960 and an image sensor IS including the imaging plane IP. Also, a stop (not shown) may be disposed between the third lens 930 and the fourth lens 940.

Table 17 below lists characteristics of each of the lenses and other elements included in the optical imaging system 900 according to the ninth embodiment.

TABLE 17

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 6.607 | 3.145 | 1.535 | 55.74 | 4.900 | 4.350 |
| 3 | Lens | −29.940 | 0.100 | | | 4.646 | 4.350 |
| 4 | Second | −353.061 | 1.287 | 1.614 | 25.94 | 4.485 | 4.350 |
| 5 | Lens | 6.429 | 2.799 | | | 3.733 | 4.350 |
| 6 | Third | 8.930 | 1.409 | 1.671 | 19.24 | 3.414 | |
| 7 | Lens | 17.723 | 0.292 | | | 3.252 | |
| 8 (Stop) | Fourth | 12.990 | 0.894 | 1.614 | 25.94 | 3.165 | |
| 9 | Lens | 7.220 | 1.914 | | | 2.950 | |
| 10 | Fifth | 97.317 | 0.964 | 1.535 | 55.74 | 3.340 | |
| 11 | Lens | −15.007 | 2.396 | | | 3.419 | |
| 12 | Sixth | 43.177 | 1.000 | 1.535 | 55.74 | 3.618 | |
| 13 | Lens | 10.774 | 1.082 | | | 3.800 | |
| 14 | Filter | Infinity | 0.210 | 1.518 | 64.17 | 6.000 | |
| 15 | | Infinity | 6.871 | | | 6.000 | |
| Image | | Infinity | 0.007 | | | 5.739 | |

According to the ninth embodiment, the first lens 910 and the second lens 920 may be D-cut lenses.

According to the ninth embodiment, lenses having opposite refractive powers may be disposed in alternating order. For example, the first lens 910 may have a positive refractive power, the second lens 920 may have a negative refractive power, the third lens 930 may have a positive refractive power, the fourth lens 940 may have a negative refractive power, the fifth lens 950 may have a positive refractive power, and the sixth lens 960 may have a negative refractive power.

According to the ninth embodiment, an object-side surface and an image-side surface of the first lens 910 may be convex in respective paraxial regions thereof, and an object-side surface and an image-side surface of the second lens 920 may be concave in respective paraxial regions thereof. Object-side surfaces of the third lens 930 and the fourth lens 940 may be convex in respective paraxial regions thereof, and image-side surfaces of the third lens 930 and the fourth lens 940 may be concave in respective paraxial regions thereof. An object-side surface and an image-side surface of the fifth lens 950 may be convex in respective paraxial regions thereof. An object-side surface of the sixth lens 960 may be convex in a paraxial region thereof, and an image-side surface of the sixth lens 960 may be concave in a paraxial region thereof.

According to the ninth embodiment, the first lens 910, the second lens 920, and the third lens 930 may be made of plastic materials having different optical characteristics from each other. The fourth lens 940 may be made of the same plastic material as the second lens 920, and the fifth lens 950 and the sixth lens 960 may be made of the same plastic material as the first lens 910.

According to the ninth embodiment, the second lens 920, the third lens 930, and the fourth lens 940 may be high-index lenses each having a refractive index of 1.6 or greater.

Also, an Abbe number of each of the first lens 910, the fifth lens 950, and the sixth lens 960 may be 50 or more, an Abbe number of each of the second lens 920 and the fourth lens 940 may be 20 or more and less than 40, and an Abbe number of the third lens 930 may be less than 20.

Table 18 below lists aspheric coefficients of each of the lenses included in the optical imaging system 900 according to the ninth embodiment. According to the ninth embodiment, object-side surfaces and image-side surfaces of the first lens 910 to the sixth lens 960 may be

TABLE 18

| Surface | | | | | | |
|---|---|---|---|---|---|---|
| No. | 2 | 3 | 4 | 5 | 6 | 7 |
| K | −0.565 | −12.289 | 0.000 | −0.014 | −0.491 | −60.788 |
| A | 9.505E−05 | 1.842E−04 | −2.485E−04 | −6.294E−04 | −7.083E−04 | −4.856E−04 |
| B | 2.723E−06 | 1.209E−06 | 7.681E−06 | −3.210E−06 | 2.433E−05 | 1.464E−05 |
| C | 5.434E−08 | 3.653E−08 | −3.630E−08 | −6.627E−08 | 5.642E−07 | 2.073E−07 |
| D | 5.378E−10 | −1.640E−09 | −4.269E−10 | 2.818E−08 | −2.924E−09 | −1.211E−08 |
| E | −7.313E−12 | −5.665E−11 | 4.495E−11 | 6.633E−10 | 9.992E−10 | 4.433E−09 |
| F | 2.275E−12 | −2.541E−12 | 1.855E−12 | 3.448E−11 | 2.528E−10 | −3.844E−10 |
| G | 6.452E−14 | −1.941E−14 | −1.189E−13 | 2.694E−12 | 3.211E−12 | −1.406E−11 |
| H | −2.483E−15 | −2.252E−15 | −4.095E−15 | −8.846E−14 | −1.133E−13 | 2.020E−12 |
| J | −2.263E−16 | 4.345E−17 | 4.734E−17 | −1.465E−14 | −4.411E−14 | 5.382E−16 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |

| Surface | | | | | | |
|---|---|---|---|---|---|---|
| No. | 9 | 9 | 10 | 11 | 12 | 13 |
| K | −23.609 | −0.103 | −60.322 | −26.166 | 4.611 | −0.219 |
| A | −7.340E−05 | −3.047E−04 | −5.460E−04 | −4.605E−04 | 2.018E−03 | 9.185E−04 |
| B | −5.333E−04 | −5.978E−04 | −9.813E−04 | −1.272E−03 | −5.200E−03 | −4.227E−03 |
| C | 1.308E−05 | −8.946E−04 | 1.323E−03 | 1.916E−03 | 5.505E−03 | 3.941E−03 |
| D | 5.452E−04 | 2.193E−03 | −1.078E−03 | −1.577E−03 | −3.626E−03 | −2.281E−03 |
| E | −5.542E−04 | −1.991E−03 | 6.011E−04 | 8.403E−04 | 1.599E−03 | 8.909E−04 |
| F | 2.892E−04 | 1.064E−03 | −2.381E−04 | −3.099E−04 | −4.908E−04 | −2.444E−04 |
| G | −9.544E−05 | −3.773E−04 | 6.792E−05 | 8.154E−05 | 1.073E−04 | 4.811E−05 |
| H | 2.140E−05 | 9.323E−05 | −1.401E−05 | −1.549E−05 | −1.693E−05 | −6.870E−06 |
| J | −3.352E−06 | −1.638E−05 | 2.080E−06 | 2.127E−06 | 1.929E−06 | 7.117E−07 |
| L | 3.682E−07 | 2.044E−06 | −2. 199E−07 | −2.087E−07 | −1.571E−07 | −5.290E−08 |
| M | −2.785E−08 | −1.775E−07 | 1.611E−08 | 1.425E−08 | 8.917E−09 | 2.746E−09 |
| N | 1.384E−09 | 1.021E−08 | −7.762E−10 | −6.427E−10 | −3.348E−10 | −9.448E−11 |
| O | −4.069E−11 | −3.503E−10 | 2.212E−11 | 1.720E−11 | 7.474E−12 | 1.935E−12 |
| P | 5.369E−13 | 5.422E−12 | −2.825E−13 | −2.066E−13 | −7.506E−14 | −1.784E−14 |

### 10th Embodiment

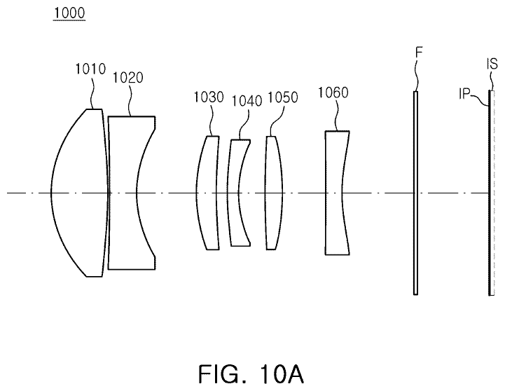

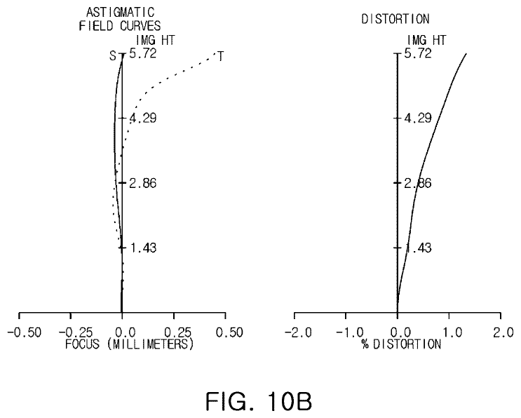

FIG. 10A is a configuration diagram illustrating an optical imaging system according to a 10th embodiment of the present disclosure. FIG. 10B is a graph showing aberration properties of the optical imaging system according to the 10th embodiment of the present disclosure.

an optical imaging system 1000 according to the 10th embodiment may include a first lens 1010, a second lens 1020, a third lens 1030, a fourth lens 1040, a fifth lens 1050, and a sixth lens 1060 sequentially disposed in ascending numerical order along an optical axis of the optical imaging system 1000 from an object side of the optical imaging system 1000 toward an imaging plane IP of the optical imaging system 1000, and may also include a filter F disposed on an image side of the sixth lens 1060 and an image sensor IS including the imaging plane IP. Also, a stop (not shown) may be disposed between the third lens 1030 and the fourth lens 1040.

Table 19 below lists characteristics of each of the lenses and other elements included in the optical imaging system 1000 according to the 10th embodiment.

TABLE 19

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 6.976 | 3.150 | 1.535 | 55.74 | 4.900 | 4.350 |
| 3 | Lens | −26.255 | 0.100 | | | 4.640 | 4.350 |
| 4 | Second | −236.374 | 1.507 | 1.614 | 25.94 | 4.476 | 4.350 |
| 5 | Lens | 6.894 | 3.329 | | | 3.723 | 4.350 |
| 6 | Third | 9.163 | 1.106 | 1.671 | 19.24 | 3.315 | |
| 7 | Lens | 24.510 | 0.617 | | | 3.221 | |
| 8 (Stop) | Fourth | 17.140 | 0.629 | 1.614 | 25.94 | 3.103 | |
| 9 | Lens | 6.860 | 1.474 | | | 2.950 | |
| 10 | Fifth | 41.767 | 0.966 | 1.535 | 55.74 | 3.231 | |
| 11 | Lens | −14.300 | 2.416 | | | 3.308 | |
| 12 | Sixth | 47.354 | 0.905 | 1.535 | 55.74 | 3.614 | |
| 13 | Lens | 10.073 | 4.000 | | | 3.800 | |
| 14 | Filter | Infinity | 0.210 | 1.518 | 64.17 | 6.000 | |
| 15 | | Infinity | 4.006 | | | 6.000 | |
| Image | | Infinity | 0.005 | | | 5.734 | |

According to the 10th embodiment, the first lens 1010 and the second lens 1020 may be D-cut lenses.

According to the 10th embodiment, lenses having opposite refractive powers may be disposed in alternating order. For example, the first lens 1010 may have a positive refractive power, the second lens 1020 may have a negative refractive power, the third lens 1030 may have a positive refractive power, the fourth lens 1040 may have a negative refractive power, the fifth lens 1050 may have a positive refractive power, and the sixth lens 1060 may have a negative refractive power.

According to the 10th embodiment, an object-side surface and an image-side surface of the first lens 1010 may be convex in respective paraxial region thereof, an object-side surface and an image-side surface of the second lens 1020 may be concave in respective paraxial region thereof. Object-side surfaces of the third lens 1030 and the fourth lens 1040 may be convex in respective paraxial region thereof, and image-side surfaces of the third lens 1030 and the fourth lens 1040 may be concave in respective paraxial region thereof. An object-side surface and an image-side surface of the fifth lens 1050 may be convex in respective paraxial region thereof. An object-side surface of the sixth lens 1060 may be convex in a paraxial region thereof, and an image-side surface of the sixth lens 1060 may be concave in a paraxial region thereof.

According to the 10th embodiment, the first lens 1010, the second lens 1020, and the third lens 1030 may be made of plastic materials having different optical characteristics from each other. The fourth lens 1040 may be made of the same plastic material as the second lens 1020, and the fifth lens 1050 and sixth lens 1060 may be made of the same plastic material as the first lens 1010.

According to the 10th embodiment, the second lens 1020, the third lens 1030, and the fourth lens 1040 may be high-index lenses each having a refractive index of 1.6 or greater.

Also, an Abbe number of each of the first lens 1010, the fifth lens 1050, and the sixth lens 1060 may be 50 or more, an Abbe number of each of the second lens 1020 and the fourth lens 1040 may be 20 or more and less than 40, and an Abbe number of the third lens 1030 may be less than 20.

Table 20 below lists aspheric coefficients of each of the lenses included in the optical imaging system 1000 according to the 10th embodiment. According to the 10th embodiment, object-side surfaces and image-side surfaces of the first lens 1010 to the sixth lens 1060 may be aspherical.

TABLE 20

| Surface | | | | | | |
|---|---|---|---|---|---|---|
| No. | 2 | 3 | 4 | 5 | 6 | 7 |
| K | −0.573 | −14.978 | 0.000 | 0.022 | −0.468 | −66.353 |
| A | 9.237E−05 | 1.935E−04 | −2.518E−04 | −6.038E−04 | −7.046E−04 | −5.021E−04 |
| B | 2.414E−06 | 1.291E−06 | 7.864E−06 | −2.479E−06 | 2.368E−05 | 1.493E−05 |
| C | 5.097E−08 | 3.252E−08 | −2.425E−08 | −7.280E−08 | 4.904E−07 | 3.665E−07 |
| D | 4.223E−10 | −1.855E−09 | −1.496E−10 | 2.750E−08 | −9.445E−09 | 1.419E−08 |
| E | −1.708E−11 | −7.132E−11 | 4.694E−11 | 6.963E−10 | 9.721E−10 | 4.313E−09 |
| F | 1.760E−12 | −3.154E−12 | 2.197E−12 | 4.552E−11 | 3.088E−10 | −3.842E−10 |
| G | 4.602E−14 | −5.085E−14 | −1.050E−13 | 2.496E−12 | 3.211E−12 | −1.406E−11 |
| H | −3.070E−15 | −3.020E−15 | −3.736E−15 | −8.846E−14 | −1.133E−13 | 2.020E−12 |
| J | −2.454E−16 | 8.886E−17 | 4.583E−17 | −1.465E−14 | −4.411E−14 | 5.382E−16 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Surface | | | | | | |
| No. | 9 | 9 | 10 | 11 | 12 | 13 |
| K | −22.136 | −0.422 | 5.776 | −29.618 | −56.000 | −1.355 |
| A | −2.132E−03 | −3.408E−03 | −1.795E−03 | −1.561E−03 | 2.043E−03 | 1.820E−03 |
| B | 7.372E−03 | 1.110E−02 | 3.632E−03 | 2.700E−03 | −4.964E−03 | −5.703E−03 |
| C | −1.070E−02 | −1.758E−02 | −4.545E−03 | −3.258E−03 | 5.418E−03 | 5.294E−03 |
| D | 8.910E−03 | 1.602E−02 | 3.388E−03 | 2.428E−03 | −3.789E−03 | −3.139E−03 |
| E | −4.826E−03 | −9.512E−03 | −1.667E−03 | −1.199E−03 | 1.767E−03 | 1.261E−03 |
| F | 1.804E−03 | 3.903E−03 | 5.659E−04 | 4.073E−04 | −5.678E−04 | −3.546E−04 |
| G | −4.805E−04 | −1.144E−03 | −1.363E−04 | −9.788E−05 | 1.289E−04 | 7.133E−05 |
| H | 9.282E−05 | 2.437E−04 | 2.365E−05 | 1.690E−05 | −2.095E−05 | −1.037E−05 |
| J | −1.305E−05 | −3.784E−05 | −2.969E−06 | −2.106E−06 | 2.447E−06 | 1.091E−06 |
| L | 1.323E−06 | 4.247E−06 | 2.671E−07 | 1.881E−07 | −2.036E−07 | −8.212E−08 |
| M | −9.424E−08 | −3.357E−07 | −1.681E−08 | −1.176E−08 | 1.177E−08 | 4.311E−09 |
| N | 4.479E−09 | 1.773E−08 | 7.032E−10 | 4.889E−10 | −4.495E−10 | −1.498E−10 |
| O | −1.275E−10 | −5.617E−10 | −1.756E−11 | −1.217E−11 | 1.019E−11 | 3.094E−12 |
| P | 1.645E−12 | 8.073E−12 | 1.981E−13 | 1.373E−13 | −1.038E−13 | −2.876E−14 |

### 11th Embodiment

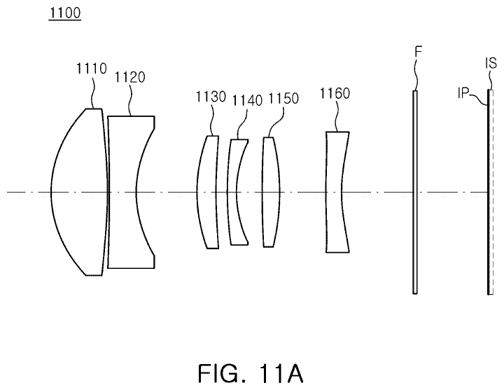

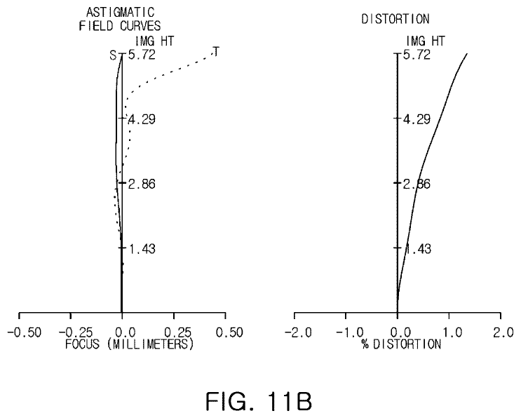

FIG. 11A is a configuration diagram illustrating an optical imaging system according to an 11th embodiment of the present disclosure. FIG. 11B is a graph showing aberration properties of the optical imaging system according to the 11th embodiment of the present disclosure.

An optical imaging system 1100 according to the 11th embodiment may include a first lens 1110, a second lens 1120, a third lens 1130, a fourth lens 1140, a fifth lens 1150, and a sixth lens 1160 sequentially disposed in ascending numerical order along an optical axis of the optical imaging system 1100 from an object side of the optical imaging system 1100 toward an imaging plane IP of the optical imaging system 1100, and may also include a filter F disposed on an image side of the sixth lens 1160 and an image sensor IS including the imaging plane IP. Also, a stop (not shown) may be disposed between the third lens 1130 and the fourth lens 1140.

Table 21 below lists characteristics of each of the lenses and other elements included in the optical imaging system 1100 according to the 11th embodiment.

TABLE 21

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 6.977 | 3.146 | 1.535 | 55.74 | 4.875 | 4.350 |
| 3 | Lens | −26.332 | 0.100 | | | 4.611 | 4.350 |
| 4 | Second | −243.988 | 1.501 | 1.614 | 25.94 | 4.449 | 4.350 |
| 5 | Lens | 6.917 | 3.386 | | | 3.709 | 4.350 |
| 6 | Third | 9.158 | 1.062 | 1.671 | 19.24 | 3.293 | |
| 7 | Lens | 25.776 | 0.633 | | | 3.208 | |
| 8 (Stop) | Fourth | 17.820 | 0.511 | 1.614 | 25.94 | 3.086 | |
| 9 | Lens | 6.831 | 1.431 | | | 2.950 | |
| 10 | Fifth | 39.728 | 0.976 | 1.535 | 55.74 | 3.133 | |
| 11 | Lens | −14.406 | 2.578 | | | 3.200 | |
| 12 | Sixth | 42.861 | 0.877 | 1.535 | 55.74 | 3.528 | |
| 13 | Lens | 9.817 | 4.000 | | | 3.700 | |
| 14 | Filter | Infinity | 0.210 | 1.518 | 64.17 | 6.000 | |
| 15 | | Infinity | 3.976 | | | 6.000 | |
| Image | | Infinity | 0.005 | | | 5.730 | |

According to the 11th embodiment, the first lens 1110 and the second lens 1120 may be D-cut lenses.

According to the 11th embodiment, lenses having opposite refractive powers may be disposed in alternating order. For example, the first lens 1110 may have a positive refractive power, the second lens 1120 may have a negative refractive power, the third lens 1130 may have a positive refractive power, the fourth lens 1140 may have a negative refractive power, the fifth lens 1150 may have a positive refractive power, and the sixth lens 1160 may have a negative refractive power.

According to the 11th embodiment, an object-side surface and an image-side surface of the first lens 1110 may be convex in respective paraxial regions thereof, an object-side surface and an image-side surface of the second lens 1120 may be concave in respective paraxial regions thereof. Object-side surfaces of the third lens 1130 and the fourth lens 1140 may be convex in respective paraxial regions thereof, and image-side surfaces of the third lens 1130 and the fourth lens 1140 may be concave in respective paraxial regions thereof. An object-side surface and an image-side surface of the fifth lens 1150 may be convex in respective paraxial regions thereof. An object-side surface of the sixth lens 1160 may be convex in a paraxial region thereof, and an image-side surface of the sixth lens 1160 may be concave in a paraxial region thereof.

According to the 11th embodiment, the first lens 1110, the second lens 1120, and the third lens 1130 may be made of plastic materials having different optical characteristics from each other. The fourth lens 1140 may be made of the same plastic material as the second lens 1120, and the fifth lens 1150 and sixth lens 1160 may be made of the same plastic material as the first lens 1110.

According to the 11th embodiment, the second lens 1120, the third lens 1130, and the fourth lens 1140 may be high-index lenses each having a refractive index of 1.6 or greater.

Also, an Abbe number of each of the first lens 1110, the fifth lens 1150, and the sixth lens 1160 may be 50 or more, an Abbe number of each of the second lens 1120 and the fourth lens 1140 may be 20 or more and less than 40, and an Abbe number of the third lens 1130 may be less than 20.

Table 22 below lists aspheric coefficients of each of the lenses included in the optical imaging system 1100 according to the 11th embodiment. According to the 11th embodiment, object-side surfaces and image-side surfaces of the first lens 1110 to the sixth lens 1160 may be aspherical.

TABLE 22

| Surface | | | | | | |
|---|---|---|---|---|---|---|
| No. | 2 | 3 | 4 | 5 | 6 | 7 |
| K | −0.573 | −14.978 | 0.000 | 0.022 | −0.468 | −66.353 |
| A | 9.237E−05 | 1.935E−04 | −2.518E−04 | −6.038E−04 | −7.046E−04 | −5.021E−04 |
| B | 2.414E−06 | 1.291E−06 | 7.864E−06 | −2.479E−06 | 2.368E−05 | 1.493E−05 |
| C | 5.097E−08 | 3.252E−08 | −2.425E−08 | −7.280E−08 | 4.904E−07 | 3.665E−07 |
| D | 4.223E−10 | −1.855E−09 | −1.496E−10 | 2.750E−08 | −9.445E−09 | 1.419E−08 |
| E | −1.708E−11 | −7.132E−11 | 4.694E−11 | 6.963E−10 | 9.721E−10 | 4.313E−09 |
| F | 1.760E−12 | −3.154E−12 | 2.197E−12 | 4.552E−11 | 3.088E−10 | −3.842E−10 |
| G | 4.602E−14 | −5.085E−14 | −1.050E−13 | 2.496E−12 | 3.211E−12 | −1.406E−11 |
| H | −3.070E−15 | −3.020E−15 | −3.736E−15 | −8.846E−14 | −1.133E−13 | 2.020E−12 |
| J | −2.454E−16 | 8.886E−17 | 4.583E−17 | −1.465E−14 | −4.411E−14 | 5.382E−16 |
| L | 0.000E+00 | 0.000E+00 | 0.000E+00 | 0.000E+00 | 0.000E+00 | 0.000E+00 |
| M | 0.000E+00 | 0.000E+00 | 0.000E+00 | 0.000E+00 | 0.000E+00 | 0.000E+00 |
| N | 0.000E+00 | 0.000E+00 | 0.000E+00 | 0.000E+00 | 0.000E+00 | 0.000E+00 |
| O | 0.000E+00 | 0.000E+00 | 0.000E+00 | 0.000E+00 | 0.000E+00 | 0.000E+00 |
| P | 0.000E+00 | 0.000E+00 | 0.000E+00 | 0.000E+00 | 0.000E+00 | 0.000E+00 |
| Surface | | | | | | |
| No. | 9 | 9 | 10 | 11 | 12 | 13 |
| K | −22.136 | −0.422 | 5.776 | −29.618 | −56.000 | −1.355 |
| A | −2.132E−03 | −3.408E−03 | −1.795E−03 | −1.561E−03 | 2.043E−03 | 1.820E−03 |
| B | 7.372E−03 | 1.110E−02 | 3.632E−03 | 2.700E−03 | −4.964E−03 | −5.703E−03 |
| C | −1.070E−02 | −1.758E−02 | −4.545E−03 | −3.258E−03 | 5.418E−03 | 5.294E−03 |
| D | 8.910E−03 | 1.602E−02 | 3.388E−03 | 2.428E−03 | −3.789E−03 | −3.139E−03 |
| E | −4.826E−03 | −9.512E−03 | −1.667E−03 | −1.199E−03 | 1.767E−03 | 1.261E−03 |
| F | 1.804E−03 | 3.903E−03 | 5.659E−04 | 4.073E−04 | −5.678E−04 | −3.546E−04 |
| G | −4.805E−04 | −1.144E−03 | −1.363E−04 | −9.788E−05 | 1.289E−04 | 7.133E−05 |
| H | 9.282E−05 | 2.437E−04 | 2.365E−05 | 1.690E−05 | −2.095E−05 | −1.037E−05 |
| J | −1.305E−05 | −3.784E−05 | −2.969E−06 | −2.106E−06 | 2.447E−06 | 1.091E−06 |
| L | 1.323E−06 | 4.247E−06 | 2.671E−07 | 1.881E−07 | −2.036E−07 | −8.212E−08 |
| M | −9.424E−08 | −3.357E−07 | −1.681E−08 | −1.176E−08 | 1.177E−08 | 4.311E−09 |
| N | 4.479E−09 | 1.773E−08 | 7.032E−10 | 4.889E−10 | −4.495E−10 | −1.498E−10 |
| O | −1.275E−10 | −5.617E−10 | −1.756E−11 | −1.217E−11 | 1.019E−11 | 3.094E−12 |
| P | 1.645E−12 | 8.073E−12 | 1.981E−13 | 1.373E−13 | −1.038E−13 | −2.876E−14 |

### 12th Embodiment

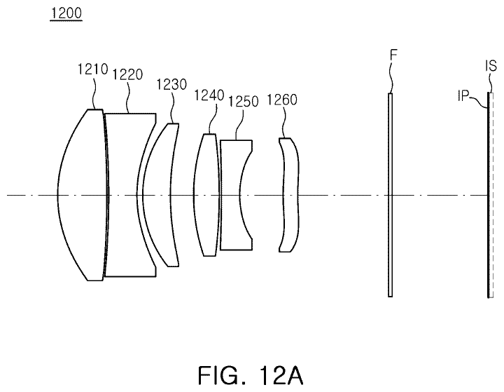

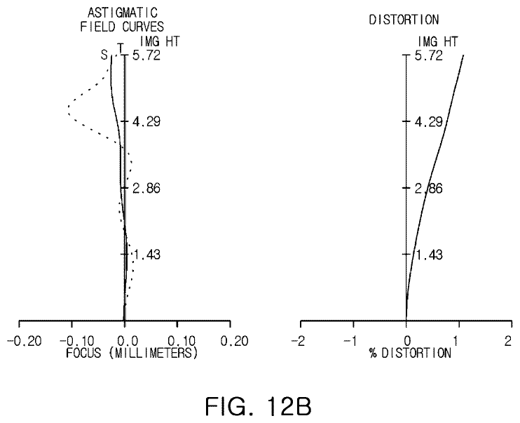

FIG. 12A is a configuration diagram illustrating an optical imaging system according to a 12th embodiment of the present disclosure. FIG. 12B is a graph showing aberration properties of the optical imaging system according to the 12th embodiment of the present disclosure.

An optical imaging system 1200 according to the 12th embodiment may include a first lens 1210, a second lens 1220, a third lens 1230, a fourth lens 1240, a fifth lens 1250, and a sixth lens 1260 sequentially disposed in ascending numerical order along an optical axis of the optical imaging system 1200 from an object side of the optical imaging system 1200 toward an imaging plane IP of the optical imaging system 1200, and may also include a filter F disposed on an image side of the sixth lens 1260 and an image sensor IS including the imaging plane IP. Also, a stop (not shown) may be disposed between the third lens 1230 and the fourth lens 1240.

Table 23 below lists characteristics of each of the lenses and other elements included in the optical imaging system 1200 according to the 12th embodiment.

TABLE 23

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.048 | 2.744 | 1.535 | 55.74 | 5.050 | 4.350 |
| 3 | Lens | −54.162 | 0.100 | | | 4.863 | 4.350 |
| 4 | Second | −113.822 | 1.573 | 1.614 | 25.94 | 4.818 | 4.350 |
| 5 | Lens | 7.880 | 0.322 | | | 4.252 | 4.350 |
| 6 | Third | 7.089 | 1.541 | 1.535 | 55.74 | 4.220 | |
| 7 | Lens | 16.219 | 1.293 | | | 4.062 | |
| 8 (Stop) | Fourth | 10.404 | 1.436 | 1.671 | 19.24 | 3.599 | |
| 9 | Lens | −33.480 | 0.121 | | | 3.400 | |
| 10 | Fifth | −51.931 | 1.016 | 1.614 | 25.94 | 3.234 | |
| 11 | Lens | 5.712 | 2.418 | | | 2.600 | |
| 12 | Sixth | 11.817 | 0.815 | 1.544 | 55.99 | 3.114 | |
| 13 | Lens | 13.549 | 5.059 | | | 3.354 | |
| 14 | Filter | Infinity | 0.210 | 1.518 | 64.17 | 6.000 | |
| 15 | | Infinity | 5.358 | | | 6.000 | |
| Image | | Infinity | | | | 5.723 | |

According to the 12th embodiment, the first lens 1210 and the second lens 1220 may be D-cut lenses.

According to the 12th embodiment, the first lens 1210 may have a positive refractive power, the second lens 1220 may have a negative refractive power, the third lens 1230 may have a positive refractive power, the fourth lens 1240 may have a positive refractive power, the fifth lens 1250 may have a negative refractive power, and the sixth lens 1260 may have a positive refractive power.

According to the 12th embodiment, an object-side surface and an image-side surface of the first lens 1210 may be convex in respective paraxial regions thereof, and an object-side surface and an image-side surface of the second lens 1220 may be concave in respective paraxial regions thereof. An object-side surface of the third lens 1230 may be convex in a paraxial region thereof, and an image-side surface of the third lens 1230 may be concave in a paraxial region thereof. An object-side surface and an image-side surface of the fourth lens 1240 may be convex in respective paraxial regions thereof. An object-side surface and an image-side surface of the fifth lens 1250 may be concave in respective paraxial regions thereof. An object-side surface of the sixth lens 1260 may be convex in a paraxial region thereof, and an image-side surface of the sixth lens 1260 may be concave in a paraxial region thereof. Also, each of an object-side surface and an image-side surface of the sixth lens 1260 may have an inflection point.

According to the 12th embodiment, the first lens 1210, the second lens 1220, the fourth lens 1240, and the sixth lens 1260 may be made of plastic materials having different optical characteristics from each other. The third lens 1230 may be made of the same plastic material as the first lens 1210, and the fifth lens 1250 may be made of the same plastic material as the second lens 1220.

According to the 12th embodiment, the second lens 1220, the fourth lens 1240, and the fifth lens 1250 may be high-index lenses each having a refractive index of 1.6 or greater.

Also, an Abbe number of each of the first lens 1210, the third lens 1230, and the sixth lens 1260 may be 50 or more, an Abbe number of each of the second lens 1220 and the fifth lens 1250 may be 20 or more and less than 40, and an Abbe number of the fourth lens 1240 may be less than 20.

Table 24 below lists aspheric coefficients of each of the lenses included in the optical imaging system 1200 according to the 12th embodiment. According to the 12th embodiment, object-side surfaces and image-side surfaces of the first lens 1210 to the sixth lens 1260 may be aspherical.

TABLE 24

| Surface | | | | | | |
|---|---|---|---|---|---|---|
| No. | 2 | 3 | 4 | 5 | 6 | 7 |
| K | −0.543 | 6.917 | 0.000 | −0.643 | 0.100 | −1.673 |
| A | 6.381E−05 | −1.798E−03 | −2.694E−03 | −1.619E−03 | 1.350E−04 | 5.240E−04 |
| B | 5.489E−05 | 2.470E−03 | 2.865E−03 | 2.026E−03 | 8.268E−04 | −4.153E−04 |
| C | −4.927E−05 | −1.436E−03 | −1.630E−03 | −1.322E−03 | −5.637E−04 | 2.514E−04 |
| D | 1.976E−05 | 4.852E−04 | 5.497E−04 | 4.493E−04 | 1.136E−04 | −1.377E−04 |
| E | −4.782E−06 | −1.058E−04 | −1.201E−04 | −8.722E−05 | 1.391E−05 | 4.984E−05 |
| F | 7.668E−07 | 1.574E−05 | 1.794E−05 | 9.136E−06 | −1.210E−05 | −1.160E−05 |
| G | −8.549E−08 | −1.645E−06 | −1.885E−06 | −2.097E−07 | 2.989E−06 | 1.799E−06 |
| H | 6.804E−09 | 1.226E−07 | 1.416E−07 | −8.084E−08 | −4.327E−07 | −1.916E−07 |
| J | −3.902E−10 | −6.533E−09 | −7.608E−09 | 1.309E−08 | 4.152E−08 | 1.418E−08 |
| L | 1.602E−11 | 2.462E−10 | 2.894E−10 | −1.060E−09 | −2.731E−09 | −7.276E−10 |
| M | −4.600E−13 | −6.393E−12 | −7.580E−12 | 5.284E−11 | 1.224E−10 | 2.530E−11 |
| N | 8.765E−15 | 1.084E−13 | 1.294E−13 | −1.641E−12 | −3.584E−12 | −5.647E−13 |
| O | −9.952E−17 | −1.075E−15 | −1.288E−15 | 2.928E−14 | 6.188E−14 | 7.205E−15 |
| P | 5.091E−19 | 4.712E−18 | 5.625E−18 | −2.300E−16 | −4.780E−16 | −3.881E−17 |

| Surface | | | | | | |
|---|---|---|---|---|---|---|
| No. | 9 | 9 | 10 | 11 | 12 | 13 |
| K | −0.529 | −1.840 | 18.712 | 0.144 | −0.924 | −5.718 |
| A | 2.709E−04 | 8.310E−03 | 9.418E−03 | 5.722E−04 | −7.491E−03 | −6.962E−03 |
| B | −4.794E−04 | −1.949E−02 | −2.627E−02 | −6.251E−03 | −1.437E−03 | −1.141E−03 |
| C | 3.189E−04 | 2.147E−02 | 3.059E−02 | 8.869E−03 | 2.430E−03 | 1.826E−03 |
| D | −8.045E−05 | −1.413E−02 | −2.106E−02 | −6.768E−03 | −2.307E−03 | −1.567E−03 |
| E | −2.656E−05 | 6.101E−03 | 9.562E−03 | 3.306E−03 | 1.462E−03 | 8.868E−04 |
| F | 2.585E−05 | −1.820E−03 | −3.011E−03 | −1.069E−03 | −6.395E−04 | −3.442E−04 |
| G | −8.953E−06 | 3.868E−04 | 6.773E−04 | 2.277E−04 | 1.980E−04 | 9.394E−05 |
| H | 1.839E−06 | −5.953E−05 | −1.105E−04 | −3.002E−05 | −4.400E−05 | −1.831E−05 |
| J | −2.493E−07 | 6.660E−06 | 1.310E−05 | 1.888E−06 | 7.044E−06 | 2.559E−06 |
| L | 2.298E−08 | −5.366E−07 | −1.118E−06 | 6.495E−08 | −8.052E−07 | −2.543E−07 |
| M | −1.432E−09 | 3.035E−08 | 6.692E−08 | −2.159E−08 | 6.409E−08 | 1.754E−08 |
| N | 5.795E−11 | −1.143E−09 | −2.661E−09 | 1.535E−09 | −3.373E−09 | −7.978E−10 |
| O | −1.375E−12 | 2.574E−11 | 6.306E−11 | −3.839E−11 | 1.055E−10 | 2.151E−11 |
| P | 1.454E−14 | −2.620E−13 | −6.730E−13 | −6.145E−14 | −1.485E−12 | −2.604E−13 |

### 13th Embodiment

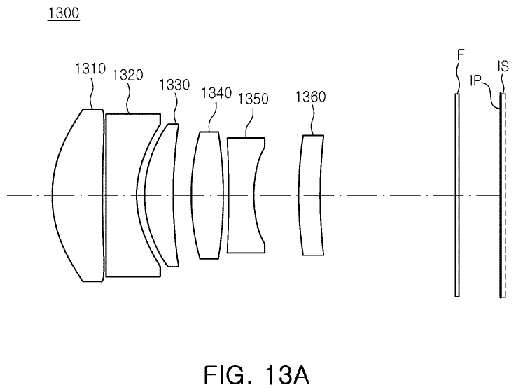

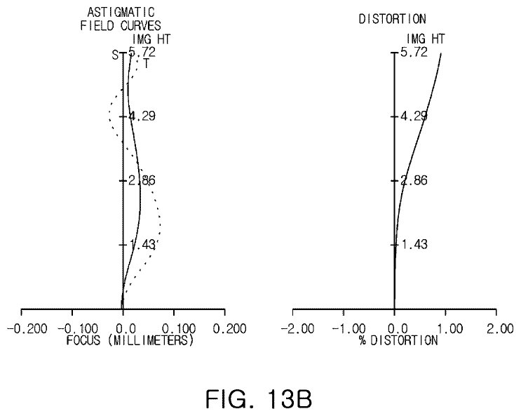

FIG. 13A is a configuration diagram illustrating an optical imaging system according to a 13th embodiment of the present disclosure. FIG. 13B is a graph showing aberration properties of the optical imaging system according to the 13th embodiment of the present disclosure.

An optical imaging system 1300 according to the 13th embodiment may include a first lens 1310, a second lens 1320, a third lens 1330, a fourth lens 1340, a fifth lens 1350, and a sixth lens 1360 sequentially disposed in ascending numerical order along an optical axis of the optical imaging system 1300 from an object side of the optical imaging system 1300 toward an imaging plane IP of the optical imaging system 1300, and may also include a filter F disposed on an image side of the sixth lens 1360 and an image sensor IS including the imaging plane IP. Also, a stop (not shown) may be disposed between the third lens 1330 and the fourth lens 1340.

Table 25 below lists characteristics of each of the lenses and other elements included in the optical imaging system 1300 according to the 13th embodiment.

TABLE 25

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.778 | 2.800 | 1.535 | 55.74 | 5.050 | 4.350 |
| 3 | Lens | 104.864 | 0.203 | | | 4.812 | 4.350 |
| 4 | Second | 123.922 | 1.696 | 1.614 | 25.94 | 4.760 | 4.350 |
| 5 | Lens | 6.309 | 0.447 | | | 4.174 | 4.350 |
| 6 | Third | 7.469 | 1.599 | 1.535 | 55.74 | 4.175 | |
| 7 | Lens | 30.255 | 1.000 | | | 4.040 | |
| 8 (Stop) | Fourth | 11.773 | 1.790 | 1.671 | 19.24 | 3.722 | |
| 9 | Lens | −47.053 | 0.297 | | | 3.571 | |
| 10 | Fifth | −53.942 | 1.400 | 1.614 | 25.94 | 3.367 | |
| 11 | Lens | 7.845 | 2.500 | | | 2.860 | |
| 12 | Sixth | 8.239 | 1.200 | 1.544 | 55.99 | 3.520 | |
| 13 | Lens | 8.272 | 7.529 | | | 3.687 | |
| 14 | Filter | Infinity | 0.210 | 1.518 | 64.17 | 6.000 | |
| 15 | | Infinity | 2.317 | | | 6.000 | |
| Image | | Infinity | | | | 5.721 | |

According to the 13th embodiment, the first lens 1310 and the second lens 1320 may be D-cut lenses.

According to the 13th embodiment, the first lens 1310 may have a positive refractive power, the second lens 1320 may have a negative refractive power, the third lens 1330 may have a positive refractive power, the fourth lens 1340 may have a positive refractive power, the fifth lens 1350 may have a negative refractive power, and the sixth lens 1360 may have a positive refractive power.

According to the 13th embodiment, object-side surfaces of the first lens 1310, the second lens 1320, and the third lens 1330 may be convex in respective paraxial regions thereof, and image-side surfaces of the first lens 1310, the second lens 1320, and the third lens 1330 may be concave in respective paraxial regions thereof. An object-side surface and an image-side surface of the fourth lens 1340 may be convex in respective paraxial regions thereof. An object-side surface and an image-side surface of the fifth lens 1350 may be concave in respective paraxial regions thereof. An object-side surface of the sixth lens 1360 may be convex in a paraxial region thereof, and an image-side surface of the sixth lens 1360 may be concave in a paraxial region thereof.

According to the 13th embodiment, the first lens 1310, the second lens 1320, the fourth lens 1340, and the sixth lens 1360 may be made of plastic materials having different optical characteristics from each other. The third lens 1330 may be made of the same plastic material as the first lens 1310, and the fifth lens 1350 may be made of the same plastic material as the second lens 1320.

According to the 13th embodiment, the second lens 1320, the fourth lens 1340, and the fifth lens 1350 may be high-index lenses each having a refractive index of 1.6 or greater.

Also, an Abbe number of each of the first lens 1310, the third lens 1330, and the sixth lens 1360 may be 50 or more, an Abbe number of each of the second lens 1320 and the fifth lens 1350 may be 20 or more and less than 40, and an Abbe number of the fourth lens 1340 may be less than 20.

Table 26 below lists aspheric coefficients of each of the lenses included in the optical imaging system 1300 according to the 13th embodiment. According to the 13th embodiment, object-side surfaces and image-side surfaces of the first lens 1310 to the sixth lens 1360 may be aspherical.

TABLE 26

| Surface | | | | | | |
|---|---|---|---|---|---|---|
| No. | 2 | 3 | 4 | 5 | 6 | 7 |
| K | −0.613 | −99.000 | −91.287 | −0.738 | 0.095 | 4.239 |
| A | −2.187E−04 | −2.591E−04 | −5.502E−05 | 6.005E−04 | 1.715E−04 | −9.130E−04 |
| B | 1.680E−04 | 5.521E−04 | 1.313E−04 | −9.156E−04 | −3.906E−04 | 6.137E−04 |
| C | −5.367E−05 | −2.403E−04 | −1.394E−04 | 3.788E−04 | 3.532E−04 | −1.520E−04 |
| D | 1.167E−05 | 4.918E−05 | 4.218E−05 | −8.727E−05 | −1.426E−04 | 1.872E−05 |
| E | −1.853E−06 | −5.556E−06 | −7.107E−06 | 1.187E−05 | 3.688E−05 | −1.225E−06 |
| F | 2.133E−07 | 3.668E−07 | 8.562E−07 | −9.739E−07 | −7.169E−06 | 3.993E−08 |
| G | −1.729E−08 | −1.412E−08 | −8.451E−08 | 4.727E−08 | 1.081E−06 | −7.324E−10 |
| H | 9.403E−10 | 2.939E−10 | 6.951E−09 | −1.249E−09 | −1.236E−07 | 3.088E−11 |
| J | −3.080E−11 | −2.558E−12 | −4.499E−10 | 1.384E−11 | 1.043E−08 | −1.002E−12 |
| L | 3.541E−13 | 0.000E+00 | 2.159E−11 | 0.000E+00 | −6.351E−10 | 0.000E+00 |
| M | 1.517E−14 | 0.000E+00 | −7.311E−13 | 0.000E+00 | 2.715E−11 | 0.000E+00 |
| N | −7.595E−16 | 0.000E+00 | 1.648E−14 | 0.000E+00 | −7.740E−13 | 0.000E+00 |
| O | 1.387E−17 | 0.000E+00 | −2.216E−16 | 0.000E+00 | 1.323E−14 | 0.000E+00 |
| P | −9.755E−20 | 0.000E+00 | 1.344E−18 | 0.000E+00 | −1.027E−16 | 0.000E+00 |

| Surface | | | | | | |
|---|---|---|---|---|---|---|
| No. | 9 | 9 | 10 | 11 | 12 | 13 |
| K | −1.032 | 95.626 | 72.956 | −0.480 | 2.407 | −1.128 |
| A | 4.979E−04 | 3.255E−03 | 1.752E−03 | −2.694E−03 | −6.762E−03 | −5.481E−03 |
| B | −8.921E−05 | −2.916E−03 | −3.134E−03 | 3.336E−03 | −4.430E−04 | −6.561E−04 |
| C | −4.475E−05 | 1.165E−03 | 1.268E−03 | −6.244E−03 | 8.362E−04 | 1.078E−03 |
| D | 2.597E−05 | −2.520E−04 | 2.164E−05 | 7.304E−03 | −6.129E−04 | −7.391E−04 |
| E | −7.155E−06 | 3.153E−05 | −1.976E−04 | −5.266E−03 | 2.928E−04 | 3.204E−04 |
| F | 1.286E−06 | −2.311E−06 | 8.938E−05 | 2.548E−03 | −9.484E−05 | −9.365E−05 |
| G | −1.552E−07 | 9.404E−08 | −2.310E−05 | −8.648E−04 | 2.134E−05 | 1.909E−05 |
| H | 9.215E−09 | −1.768E−09 | 4.028E−06 | 2.104E−04 | −3.385E−06 | −2.764E−06 |
| J | 5.680E−10 | 7.075E−12 | −4.947E−07 | −3.692E−05 | 3.805E−07 | 2.858E−07 |
| L | −1.779E−10 | 0.000E+00 | 4.296E−08 | 4.634E−06 | −3.005E−08 | −2.095E−08 |
| M | 1.761E−11 | 0.000E+00 | −2.587E−09 | −4.057E−07 | 1.628E−09 | 1.063E−09 |
| N | −9.424E−13 | 0.000E+00 | 1.028E−10 | 2.354E−08 | −5.739E−11 | −3.551E−11 |
| O | 2.729E−14 | 0.000E+00 | −2.423E−12 | −8.134E−10 | 1.181E−12 | 7.015E−13 |
| P | −3.369E−16 | 0.000E+00 | 2.570E−14 | 1.267E−11 | −1.071E−14 | −6.208E−15 |

### 14th Embodiment

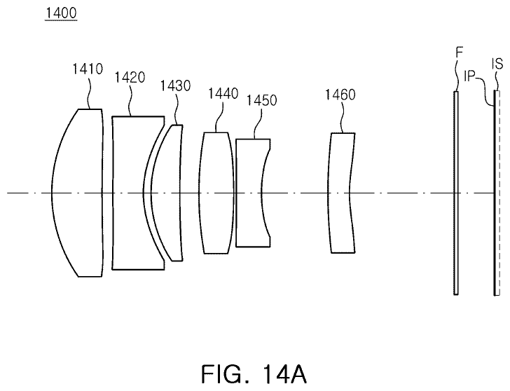

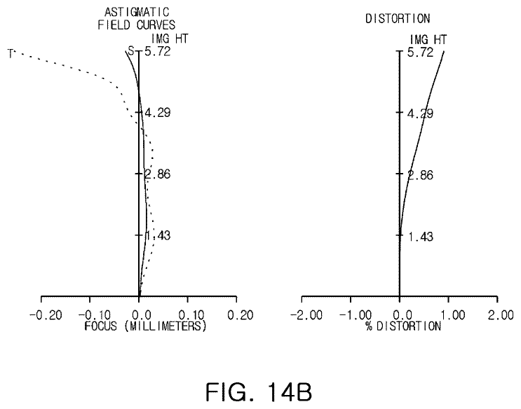

FIG. 14A is a configuration diagram illustrating an optical imaging system according to a 14th embodiment of the present disclosure. FIG. 14B is a graph showing aberration properties of the optical imaging system according to the 14th embodiment of the present disclosure.

An optical imaging system 1400 according to the 14th embodiment may include a first lens 1410, a second lens 1420, a third lens 1430, a fourth lens 1440, a fifth lens 1450, and a sixth lens 1460 sequentially disposed in ascending numerical order along an optical axis of the optical imaging system 1400 from an object side of the optical imaging system 1400 toward an imaging plane IP of the optical imaging system 1400, and may also include a filter F disposed on an image side of the sixth lens 1460 and an image sensor IS including the imaging plane IP. Also, a stop (not shown) may be disposed between the third lens 1430 and the fourth lens 1440.

Table 27 below lists characteristics of each of the lenses and other elements included in the optical imaging system 1400 according to the 14th embodiment.

TABLE 27

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.232 | 2.800 | 1.535 | 55.74 | 4.900 | 4.350 |
| 3 | Lens | 178.939 | 0.601 | | | 4.669 | 4.350 |
| 4 | Second | 201.353 | 1.700 | 1.614 | 25.94 | 4.478 | 4.350 |
| 5 | Lens | 6.404 | 0.425 | | | 3.961 | 4.350 |
| 6 | Third | 7.557 | 1.600 | 1.535 | 55.74 | 3.974 | |
| 7 | Lens | 65.298 | 1.066 | | | 3.843 | |
| 8 (Stop) | Fourth | 15.389 | 1.941 | 1.671 | 19.24 | 3.541 | |
| 9 | Lens | −26.511 | 0.148 | | | 3.339 | |
| 10 | Fifth | −112.605 | 1.400 | 1.614 | 25.94 | 3.149 | |
| 11 | Lens | 8.283 | 3.700 | | | 2.620 | |
| 12 | Sixth | 11.298 | 1.200 | 1.544 | 55.99 | 3.500 | |
| 13 | Lens | 8.361 | 5.832 | | | 3.679 | |
| 14 | Filter | Infinity | 0.210 | 1.518 | 64.17 | 6.000 | |
| 15 | | Infinity | 2.046 | | | 6.000 | |
| Image | | Infinity | | | | 5.722 | |

According to the 14th embodiment, the first lens 1410 and the second lens 1420 may be D-cut lenses.

According to the 14th embodiment, the first lens 1410 may have a positive refractive power, the second lens 1420 may have a negative refractive power, the third lens 1430 may have a positive refractive power, the fourth lens 1440 may have a positive refractive power, the fifth lens 1450 may have a negative refractive power, and the sixth lens 1460 may have a negative refractive power.

According to the 14th embodiment, object-side surfaces of the first lens 1410, the second lens 1420, and the third lens 1430 may be convex in respective paraxial regions thereof, and image-side surfaces of the first lens 1410, the second lens 1420, and the third lens 1430 may be concave in respective paraxial regions thereof. An object-side surface and an image-side surface of the fourth lens 1440 may be convex in respective paraxial regions thereof. An object-side surface and an image-side surface of the fifth lens 1450 may be concave in respective paraxial regions thereof. An object-side surface of the sixth lens 1460 may be convex in a paraxial region thereof, and an image-side surface of the sixth lens 1460 may be concave in a paraxial region thereof.

According to the 14th embodiment, the first lens 1410, the second lens 1420, the fourth lens 1440, and the sixth lens 1460 may be made of plastic materials having different optical characteristics from each other. The third lens 1430 may be made of the same plastic material as the first lens 1410, and the fifth lens 1450 may be made of the same plastic material as the second lens 1420.

According to the 14th embodiment, the second lens 1420, the fourth lens 1440, and the fifth lens 1450 may be high-index lenses each having a refractive index of 1.6 or greater.

Also, an Abbe number of each of the first lens 1410, the third lens 1430, and the sixth lens 1460 may be 50 or more, an Abbe number of each of the second lens 1420 and the fifth lens 1450 may be 20 or more and less than 40, and an Abbe number of the fourth lens 1440 may be less than 20.

Table 28 below lists aspheric coefficients of each of the lenses included in the optical imaging system 1400 according to the 14th embodiment. According to the 14th embodiment, object-side surfaces and image-side surfaces of the first lens 1410 to the sixth lens 1460 may be aspherical.

TABLE 28

| Surface | | | | | | |
|---|---|---|---|---|---|---|
| No. | 2 | 3 | 4 | 5 | 6 | 7 |
| K | −0.714 | −88.33 | 48.629 | −0.826 | 0.150 | 91.908 |
| A | 2.028E−05 | 1.300E−03 | 1.409E−03 | 5.484E−04 | −2.695E−04 | −8.670E−04 |
| B | 6.656E−05 | −6.240E−04 | −1.010E−03 | −9.175E−04 | −2.319E−04 | 6.147E−04 |
| C | −4.616E−05 | 1.529E−04 | 2.845E−04 | 3.788E−04 | 2.813E−04 | −1.519E−04 |
| D | 1.651E−05 | −2.173E−05 | −4.785E−05 | −8.727E−05 | −1.128E−04 | 1.872E−05 |
| E | −3.745E−06 | 1.894E−06 | 5.554E−06 | 1.187E−05 | 2.738E−05 | −1.225E−06 |
| F | 5.855E−07 | −1.034E−07 | −5.462E−07 | −9.739E−07 | −4.856E−06 | 3.993E−08 |
| G | −6.554E−08 | 3.458E−09 | 5.673E−08 | 4.727E−08 | 6.620E−07 | −7.319E−10 |
| H | 5.336E−09 | −6.491E−11 | −5.899E−09 | −1.249E−09 | −6.831E−08 | 3.099E−11 |
| J | −3.165E−10 | 5.253E−13 | 4.999E−10 | 1.384E−11 | 5.158E−09 | −9.879E−13 |
| L | 1.353E−11 | 0.000E+00 | −3.077E−11 | 0.000E+00 | −2.749E−10 | 0.000E+00 |
| M | −4.054E−13 | 0.000E+00 | 1.306E−12 | 0.000E+00 | 9.848E−12 | 0.000E+00 |
| N | 8.088E−15 | 0.000E+00 | −3.616E−14 | 0.000E+00 | −2.173E−13 | 0.000E+00 |
| O | −9.638E−17 | 0.000E+00 | 5.889E−16 | 0.000E+00 | 2.436E−15 | 0.000E+00 |
| P | 5.191E−19 | 0.000E+00 | −4.277E−18 | 0.000E+00 | −7.196E−18 | 0.000E+00 |

| Surface | | | | | | |
|---|---|---|---|---|---|---|
| No. | 9 | 9 | 10 | 11 | 12 | 13 |
| K | −3.089 | 0.000 | 0.000 | 0.307 | 4.592 | −0.224 |
| A | 4.984E−04 | 3.820E−03 | 2.540E−03 | −1.811E−03 | −6.196E−03 | −6.275E−03 |
| B | 1.371E−04 | −2.759E−03 | −2.952E−03 | 3.699E−03 | 1.544E−03 | 1.466E−03 |
| C | −1.197E−04 | 9.328E−04 | 7.373E−04 | −8.414E−03 | −1.653E−03 | −1.253E−03 |
| D | 2.641E−05 | −1.835E−04 | 4.258E−04 | 1.133E−02 | 1.253E−03 | 8.184E−04 |
| E | −3.161E−06 | 2.139E−05 | −4.453E−04 | −9.565E−03 | −6.141E−04 | −3.521E−04 |
| F | 2.082E−07 | −1.467E−06 | 2.065E−04 | 5.480E−03 | 2.044E−04 | 1.030E−04 |
| G | −6.415E−09 | 5.495E−08 | −6.241E−05 | −2.217E−03 | −4.765E−05 | −2.105E−05 |
| H | 2.240E−11 | −8.690E−10 | 1.326E−05 | 6.455E−04 | 7.910E−06 | 3.050E−06 |
| J | 2.225E−12 | 0.000E+00 | −2.017E−06 | −1.358E−04 | −9.396E−07 | −3.146E−07 |
| L | 0.000E+00 | 0.000E+00 | 2.189E−07 | 2.048E−05 | 7.923E−08 | 2.290E−08 |
| M | 0.000E+00 | 0.000E+00 | −1.656E−08 | −2.158E−06 | −4.628E−09 | −1.147E−09 |
| N | 0.000E+00 | 0.000E+00 | 8.296E−10 | 1.508E−07 | 1.780E−10 | 3.752E−11 |
| O | 0.000E+00 | 0.000E+00 | −2.475E−11 | −6.279E−09 | −4.052E−12 | −7.184E−13 |
| P | 0.000E+00 | 0.000E+00 | 3.327E−13 | 1.179E−10 | 4.134E−14 | 6.079E−15 |

### 15th Embodiment

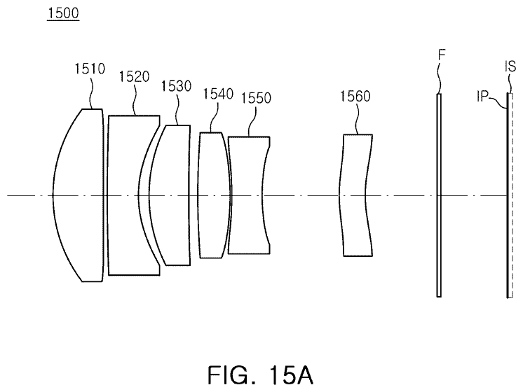

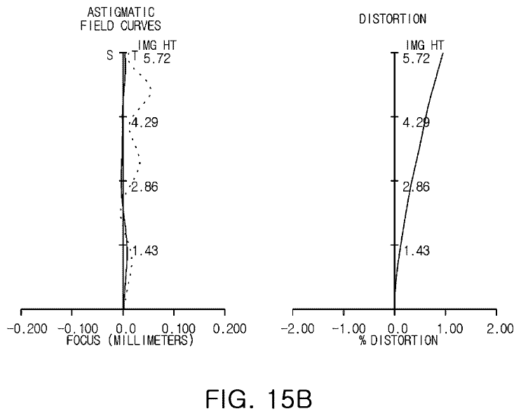

FIG. 15A is a configuration diagram illustrating an optical imaging system according to a 15th embodiment of the present disclosure. FIG. 15B is a graph showing aberration properties of the optical imaging system according to the 15th embodiment of the present disclosure.

An optical imaging system 1500 according to the 15th embodiment may include a first lens 1510, a second lens 1520, a third lens 1530, a fourth lens 1540, a fifth lens 1550, and a sixth lens 1560 sequentially disposed in ascending numerical order along an optical axis of the optical imaging system 1500 from an object side of the optical imaging system 1500 toward an imaging plane IP of the optical imaging system 1500, and may also include a filter F disposed on an image side of the sixth lens 1560 and an image sensor IS including the imaging plane IP. Also, a stop (not shown) may be disposed between the third lens 1530 and the fourth lens 1540.

Table 29 below lists characteristics of each of lenses and other elements included in the optical imaging system 1500 according to the 15th embodiment.

TABLE 29

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.210 | 2.794 | 1.535 | 55.73 | 5.050 | 4.350 |
| 3 | Lens | 881.080 | 0.221 | | | 4.807 | 4.350 |
| 4 | Second | 43.770 | 1.737 | 1.614 | 25.95 | 4.671 | 4.350 |
| 5 | Lens | 6.761 | 0.591 | | | 4.109 | 4.350 |
| 6 | Third | 9.816 | 2.215 | 1.535 | 55.73 | 4.095 | |
| 7 | Lens | 152.031 | 0.500 | | | 3.817 | |
| 8 (Stop) | Fourth | 28.653 | 1.796 | 1.671 | 19.24 | 3.663 | |
| 9 | Lens | −17.233 | 0.100 | | | 3.556 | |
| 10 | Fifth | −21.765 | 1.687 | 1.614 | 25.95 | 3.418 | |
| 11 | Lens | 11.931 | 4.292 | | | 2.900 | |
| 12 | Sixth | 9.164 | 1.446 | 1.544 | 55.99 | 3.550 | |
| 13 | Lens | 7.295 | 4.000 | | | 3.787 | |
| 14 | Filter | Infinity | 0.210 | 1.518 | 64.17 | 6.000 | |
| 15 | | Infinity | 3.725 | | | 6.000 | |
| Image | | Infinity | | | | 5.725 | |

According to the 15th embodiment, the first lens 1510 and the second lens 1520 may be D-cut lenses.

According to the 15th embodiment, the first lens 1510 may have a positive refractive power, the second lens 1520 may have a negative refractive power, the third lens 1530 may have a positive refractive power, the fourth lens 1540 may have a positive refractive power, the fifth lens 1550 may have a negative refractive power, and the sixth lens 1560 may have a negative refractive power.

According to the 15th embodiment, object-side surfaces of the first lens 1510, the second lens 1520, and the third lens 1530 may be convex in respective paraxial regions thereof, and image-side surfaces of the first lens 1510, the second lens 1520, and the third lens 1530 may be concave in respective paraxial regions thereof. An object-side surface and an image-side surface of the fourth lens 1540 may be convex in respective paraxial regions thereof. An object-side surface and an image-side surface of the fifth lens 1550 may be concave in respective paraxial regions thereof. An object-side surface of the sixth lens 1560 may be convex in a paraxial region thereof, and an image-side surface of the sixth lens 1560 may be concave in a paraxial region thereof.

According to the 15th embodiment, the first lens 1510, the second lens 1520, the fourth lens 1540, and the sixth lens 1560 may be made of plastic materials having different optical characteristics from each other. The third lens 1530 may be made of the same plastic material as the first lens 1510, and the fifth lens 1550 may be made of the same plastic material as the second lens 1520.

According to the 15th embodiment, the second lens 1520, the fourth lens 1540, and the fifth lens 1550 may be high-index lenses each having a refractive index of 1.6 or greater.

Also, an Abbe number of each of the first lens 1510, the third lens 1530, and the sixth lens 1560 may be 50 or more, an Abbe number of each of the second lens 1520 and the fifth lens 1550 may be 20 or more and less than 40, and an Abbe number of the fourth lens 1540 may be less than 20.

Table 30 below lists aspheric coefficients of each of the lenses included in the optical imaging system 1500 according to the 15th embodiment. According to the 15th embodiment, object-side surfaces and image-side surfaces of the first lens 1510 to the sixth lens 1560 may be aspherical.

TABLE 30

| Surface | | | | | | |
|---|---|---|---|---|---|---|
| No. | 2 | 3 | 4 | 5 | 6 | 7 |
| K | −0.628 | −80.000 | −80.000 | −0.769 | 0.237 | −36.834 |
| A | −2.854E−05 | −6.401E−06 | 1.922E−04 | 5.780E−04 | 4.072E−04 | −1.150E−05 |
| B | 5.281E−06 | −7.605E−07 | −3.936E−04 | −9.155E−04 | −4.492E−04 | 8.459E−07 |
| C | 5.260E−06 | −4.282E−08 | 1.737E−04 | 3.789E−04 | 1.316E−04 | 1.192E−07 |
| D | −2.364E−06 | −1.922E−09 | −5.035E−05 | −8.727E−05 | 4.050E−06 | 1.099E−08 |
| E | 4.555E−07 | −8.141E−11 | 1.054E−05 | 1.187E−05 | −1.227E−05 | 8.220E−10 |
| F | −4.928E−08 | 0.000E+00 | −1.649E−06 | −9.739E−07 | 3.715E−06 | 0.000E+00 |
| G | 3.016E−09 | 0.000E+00 | 1.938E−07 | 4.727E−08 | −6.301E−07 | 0.000E+00 |
| H | −7.255E−11 | 0.000E+00 | −1.696E−08 | −1.249E−09 | 7.146E−08 | 0.000E+00 |
| J | −3.613E−12 | 0.000E+00 | 1.091E−09 | 1.384E−11 | −5.724E−09 | 0.000E+00 |
| L | 3.975E−13 | 0.000E+00 | −5.063E−11 | 0.000E+00 | 3.264E−10 | 0.000E+00 |
| M | −1.679E−14 | 0.000E+00 | 1.645E−12 | 0.000E+00 | −1.294E−11 | 0.000E+00 |
| N | 3.931E−16 | 0.000E+00 | −3.543E−14 | 0.000E+00 | 3.378E−13 | 0.000E+00 |
| O | −5.018E−18 | 0.000E+00 | 4.545E−16 | 0.000E+00 | −5.184E−15 | 0.000E+00 |
| P | 2.735E−20 | 0.000E+00 | −2.625E−18 | 0.000E+00 | 3.517E−17 | 0.000E+00 |

| Surface | | | | | | |
|---|---|---|---|---|---|---|
| No. | 9 | 9 | 10 | 11 | 12 | 13 |
| K | −0.787 | 1.608 | 0.000 | −0.646 | 2.915 | −0.639 |
| A | 5.889E−04 | −4.118E−05 | −1.697E−03 | −1.555E−03 | −6.617E−03 | −6.042E−03 |
| B | −5.822E−05 | −6.014E−06 | 2.284E−04 | 1.008E−03 | 2.870E−03 | 2.147E−03 |
| C | −2.304E−05 | −4.909E−07 | 1.910E−04 | −9.572E−04 | −2.641E−03 | −1.729E−03 |
| D | −9.516E−06 | −3.167E−08 | −1.399E−04 | 8.887E−04 | 1.632E−03 | 9.772E−04 |
| E | 8.782E−06 | −2.027E−09 | 6.844E−05 | −5.339E−04 | −6.861E−04 | −3.762E−04 |
| F | −2.662E−06 | 0.000E+00 | −2.560E−05 | 2.118E−04 | 2.033E−04 | 1.017E−04 |
| G | 4.361E−07 | 0.000E+00 | 7.048E−06 | −5.697E−05 | −4.348E−05 | −1.970E−05 |
| H | −3.903E−08 | 0.000E+00 | −1.396E−06 | 1.044E−05 | 6.782E−06 | 2.767E−06 |
| J | 1.068E−09 | 0.000E+00 | 1.968E−07 | −1.268E−06 | −7.721E−07 | −2.820E−07 |
| L | 1.637E−10 | 0.000E+00 | −1.954E−08 | 9.272E−08 | 6.339E−08 | 2.062E−08 |
| M | −2.181E−11 | 0.000E+00 | 1.333E−09 | −2.649E−09 | −3.653E−09 | −1.054E−09 |
| N | 1.227E−12 | 0.000E+00 | −5.953E−11 | −1.456E−10 | 1.401E−10 | 3.574E−11 |
| O | −3.523E−14 | 0.000E+00 | 1.566E−12 | 1.481E−11 | −3.207E−12 | −7.217E−13 |
| P | 4.215E−16 | 0.000E+00 | −1.840E−14 | −3.746E−13 | 3.314E−14 | 6.568E−15 |

### 16th Embodiment

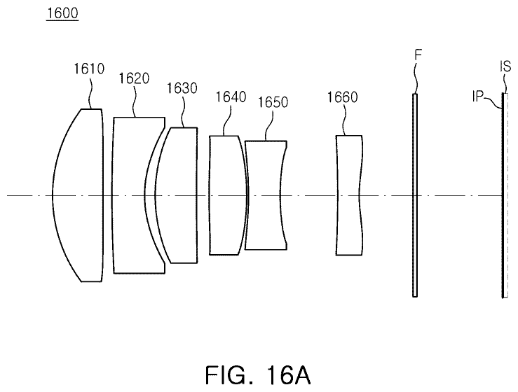

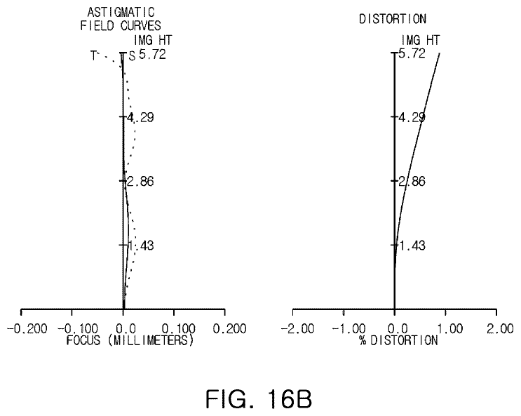

FIG. 16A is a configuration diagram illustrating an optical imaging system according to a 16th embodiment of the present disclosure. FIG. 16B is a graph showing aberration properties of the optical imaging system according to the 16th embodiment of the present disclosure.

An optical imaging system 1600 according to the 16th embodiment may include a first lens 1610, a second lens 1620, a third lens 1630, a fourth lens 1640, a fifth lens 1650, and a sixth lens 1660 sequentially disposed in ascending numerical order along an optical axis of the optical imaging system 1600 from an object side of the optical imaging system 1600 toward an imaging plane IP of the optical imaging system 1600, and may also include a filter F disposed on an image side of the sixth lens 1660 and an image sensor IS including the imaging plane IP. Also, a stop (not shown) may be disposed between the third lens 1630 and the fourth lens 1640.

Table 31 below lists characteristics of each of the lenses and other elements included in the optical imaging system 1600 according to the 16th embodiment.

TABLE 31

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.293 | 2.800 | 1.535 | 55.73 | 5.050 | 4.350 |
| 3 | Lens | 127158 | 0.505 | | | 4.823 | 4.350 |
| 4 | Second | 40.579 | 1.818 | 1.614 | 25.95 | 4.574 | 4.350 |
| 5 | Lens | 6.814 | 0.590 | | | 3.976 | 4.350 |
| 6 | Third | 9.781 | 2.300 | 1.535 | 55.73 | 3.968 | |
| 7 | Lens | 163.230 | 0.704 | | | 3.690 | |
| 8 (Stop) | Fourth | 56.560 | 2.090 | 1.671 | 19.24 | 3.482 | |
| 9 | Lens | −15.088 | 0.100 | | | 3.323 | |
| 10 | Fifth | −22.312 | 1.766 | 1.614 | 25.95 | 3.180 | |
| 11 | Lens | 14.331 | 3.200 | | | 2.860 | |
| 12 | Sixth | 12.310 | 1.200 | 1.544 | 55.99 | 3.500 | |
| 13 | Lens | 8.272 | 3.000 | | | 3.795 | |
| 14 | Filter | Infinity | 0.210 | 1.518 | 64.17 | 6.000 | |
| 15 | | Infinity | 4.787 | | | 6.000 | |
| Image | | Infinity | | | | 5.721 | |

According to the 16th embodiment, the first lens 1610 and the second lens 1620 may be D-cut lenses.

According to the 16th embodiment, the first lens 1610 may have a positive refractive power, the second lens 1620 may have a negative refractive power, the third lens 1630 may have a positive refractive power, the fourth lens 1640 may have a positive refractive power, the fifth lens 1650 may have a negative refractive power, and the sixth lens 1660 may have a negative refractive power.

According to the 16th embodiment, object-side surfaces of the first lens 1610, the second lens 1620, and the third lens 1630 may be convex in respective paraxial regions thereof, and image-side surfaces of the first lens 1610, the second lens 1620, and the third lens 1630 may be concave in respective paraxial regions thereof. An object-side surface and an image-side surface of the fourth lens 1640 may be convex in respective paraxial regions thereof. An object-side surface and an image-side surface of the fifth lens 1650 may be concave in respective paraxial regions thereof. An object-side surface of the sixth lens 1660 may be convex in a paraxial region thereof, and an image-side surface of the sixth lens 1660 may be concave in a paraxial region thereof. Also, each of an object-side surface and an image-side surface of the sixth lens 1660 may have an inflection point.

According to the 16th embodiment, the first lens 1610, the second lens 1620, the fourth lens 1640, and the sixth lens 1660 may be made of plastic materials having different optical characteristics from each other. The third lens 1630 may be made of the same plastic material as the first lens 1610, and the fifth lens 1650 may be made of the same plastic material as the second lens 1620.

According to the 16th embodiment, the second lens 1620, the fourth lens 1640, and the fifth lens 1650 may be high-index lenses each having a refractive index of 1.6 or greater.

Also, an Abbe number of each of the first lens 1610, the third lens 1630, and the sixth lens 1660 may be 50 or more, an Abbe number of each of the second lens 1620 and the fifth lens 1650 may be 20 or more and less than 40, and an Abbe number of the fourth lens 1640 may be less than 20.

Table 32 below lists aspheric coefficients of each of the lenses included in the optical imaging system 1600 according to the 16th embodiment. According to the 16th embodiment, object-side surfaces and image-side surfaces of the first lens 1610 to the sixth lens 1660 may be aspherical.

TABLE 32

| Surface | | | | | | |
|---|---|---|---|---|---|---|
| No. | 2 | 3 | 4 | 5 | 6 | 7 |
| K | −0.619 | 20.000 | −80.000 | −0.758 | 0.244 | 7.689 |
| A | −6.275E−05 | −3.951E−06 | −1.226E−05 | 5.829E−04 | 7.888E−04 | −3.863E−05 |
| B | 6.410E−05 | −6.085E−07 | −2.374E−04 | −9.155E−04 | −8.848E−04 | −1.407E−06 |
| C | −2.715E−05 | −4.121E−08 | 1.049E−04 | 3.789E−04 | 4.380E−04 | −4.695E−08 |
| D | 8.119E−06 | −2.154E−09 | −3.035E−05 | −8.727E−05 | −1.418E−04 | −1.145E−09 |
| E | −1.771E−06 | −1.050E−10 | 6.639E−06 | 1.187E−05 | 3.483E−05 | −5.883E−11 |
| F | 2.780E−07 | 0.000E+00 | −1.136E−06 | −9.739E−07 | −6.834E−06 | 0.000E+00 |
| G | −3.123E−08 | 0.000E+00 | 1.486E−07 | 4.727E−08 | 1.044E−06 | 0.000E+00 |
| H | 2.517E−09 | 0.000E+00 | −1.445E−08 | −1.249E−09 | −1.190E−07 | 0.000E+00 |
| J | −1.455E−10 | 0.000E+00 | 1.022E−09 | 1.384E−11 | 9.847E−09 | 0.000E+00 |
| L | 5.978E−12 | 0.000E+00 | −5.157E−11 | 0.000E+00 | −5.789E−10 | 0.000E+00 |
| M | −1.703E−13 | 0.000E+00 | 1.804E−12 | 0.000E+00 | 2.352E−11 | 0.000E+00 |
| N | 3.196E−15 | 0.000E+00 | −4.151E−14 | 0.000E+00 | −6.279E−13 | 0.000E+00 |
| O | −3.554E−17 | 0.000E+00 | 5.648E−16 | 0.000E+00 | 9.914E−15 | 0.000E+00 |
| P | 1.773E−19 | 0.000E+00 | −3.442E−18 | 0.000E+00 | −7.016E−17 | 0.000E+00 |

| Surface | | | | | | |
|---|---|---|---|---|---|---|
| No. | 9 | 9 | 10 | 11 | 12 | 13 |
| K | −32.339 | 2.066 | 0.000 | 0.751 | 3.059 | −1.520 |
| A | 4.507E−04 | −5.541E−05 | −1.103E−03 | −1.946E−03 | −7.481E−03 | −7.174E−03 |
| B | −1.894E−04 | −8.122E−06 | −1.925E−04 | 2.713E−03 | 7.723E−04 | 9.332E−04 |
| C | 2.303E−04 | −6.898E−07 | 5.510E−04 | −3.667E−03 | −2.015E−04 | −3.874E−04 |
| D | −2.242E−04 | −4.361E−08 | −3.591E−04 | 3.351E−03 | −6.387E−05 | 1.449E−04 |
| E | 1.216E−04 | −1.930E−09 | 1.567E−04 | −1.946E−03 | 1.130E−04 | −3.270E−05 |
| F | −4.228E−05 | 0.000E+00 | −4.987E−05 | 7.495E−04 | −6.055E−05 | 3.356E−06 |
| G | 1.009E−05 | 0.000E+00 | 1.173E−05 | −1.951E−04 | 1.888E−05 | 2.919E−07 |
| H | −1.704E−06 | 0.000E+00 | −2.036E−06 | 3.398E−05 | −3.878E−06 | −1.597E−07 |
| J | 2.061E−07 | 0.000E+00 | 2.580E−07 | −3.711E−06 | 5.468E−07 | 2.722E−08 |
| L | −1.775E−08 | 0.000E+00 | −2.341E−08 | 1.945E−07 | −5.341E−08 | −2.719E−09 |
| M | 1.064E−09 | 0.000E+00 | 1.469E−09 | 5.998E−09 | 3.559E−09 | 1.729E−10 |
| N | −4.221E−11 | 0.000E+00 | −5.989E−11 | −1.655E−09 | −1.546E−10 | −6.910E−12 |
| O | 9.960E−13 | 0.000E+00 | 1.406E−12 | 1.017E−10 | 3.945E−12 | 1.587E−13 |
| P | −1.059E−14 | 0.000E+00 | −1.407E−14 | −2.273E−12 | −4.492E−14 | −1.602E−15 |

### 17th Embodiment

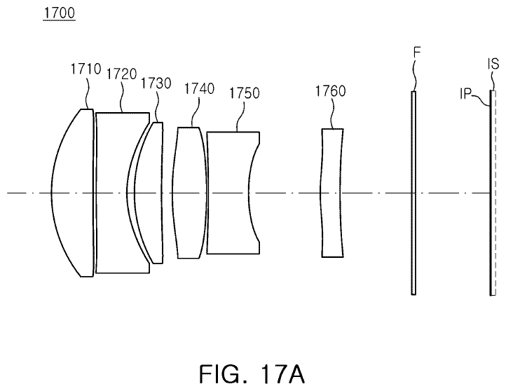

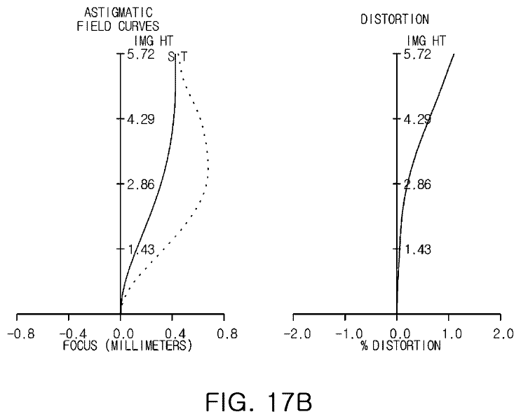

FIG. 17A is a configuration diagram illustrating an optical imaging system according to a 17th embodiment of the present disclosure. FIG. 17B is a graph showing aberration properties of the optical imaging system according to the 17th embodiment of the present disclosure.

An optical imaging system 1700 according to the 17th embodiment may include a first lens 1710, a second lens 1720, a third lens 1730, a fourth lens 1740, a fifth lens 1750, and a sixth lens 1760 sequentially disposed in ascending numerical order along an optical axis of the optical imaging system 1700 from an object side of the optical imaging system 1700 toward an imaging plane IP of the optical imaging system 1700, and may also include a filter F disposed on an image side of the sixth lens 1760 and an image sensor IS including the imaging plane IP. Also, a stop (not shown) may be disposed between the third lens 1730 and the fourth lens 1740.

Table 33 below lists characteristics of each of the lenses and other elements included in the optical imaging system 1700 according to the 17th embodiment.

TABLE 33

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.775 | 2.307 | 1.535 | 55.73 | 4.900 | 4.350 |
| 3 | Lens | 154.607 | 0.184 | | | 4.744 | 4.350 |
| 4 | Second | 80.676 | 1.708 | 1.614 | 25.95 | 4.684 | 4.350 |
| 5 | Lens | 6.562 | 0.415 | | | 4.117 | 4.350 |
| 6 | Third | 8.572 | 1.513 | 1.535 | 55.73 | 4.123 | |
| 7 | Lens | 74.157 | 0.600 | | | 4.045 | |
| 8 (Stop) | Fourth | 17.180 | 1.909 | 1.671 | 19.24 | 3.831 | |
| 9 | Lens | −25.654 | 0.100 | | | 3.727 | |
| 10 | Fifth | −43.650 | 2.235 | 1.614 | 25.95 | 3.564 | |
| 11 | Lens | 8.969 | 3.994 | | | 2.900 | |
| 12 | Sixth | 11.821 | 1.100 | 1.544 | 55.99 | 3.750 | |
| 13 | Lens | 9.473 | 4.000 | | | 3.938 | |
| 14 | Filter | Infinity | 0.210 | 1.518 | 64.17 | 6.000 | |
| 15 | | Infinity | 4.178 | | | 6.000 | |
| Image | | Infinity | | | | 5.726 | |

According to the 17th embodiment, the first lens 1710 and the second lens 1720 may be D-cut lenses.

According to the 17th embodiment, the first lens 1710 may have a positive refractive power, the second lens 1720 may have a negative refractive power, the third lens 1730 may have a positive refractive power, the fourth lens 1740 may have a positive refractive power, the fifth lens 1750 may have a negative refractive power, and the sixth lens 1760 may have a negative refractive power.

According to the 17th embodiment, object-side surfaces of the first lens 1710, the second lens 1720, and the third lens 1730 may be convex in respective paraxial regions thereof, and image-side surfaces of the first lens 1710, the second lens 1720, and the third lens 1730 may be concave in respective paraxial regions thereof. An object-side surface and an image-side surface of the fourth lens 1740 may be convex in respective paraxial regions thereof. An object-side surface and an image-side surface of the fifth lens 1750 may be concave in respective paraxial regions thereof. An object-side surface of the sixth lens 1760 may be convex in a paraxial region thereof, and an image-side surface of the sixth lens 1760 may be concave in a paraxial region thereof.

According to the 17th embodiment, the first lens 1710, the second lens 1720, the fourth lens 1740, and the sixth lens 1760 may be made of plastic materials having different optical characteristics from each other. The third lens 1730 may be made of the same plastic material as the first lens 1710, and the fifth lens 1750 may be made of the same plastic material as the second lens 1720.

According to the 17th embodiment, the second lens 1720, the fourth lens 1740, and the fifth lens 1750 may be high-index lenses each having a refractive index of 1.6 or greater.

Also, an Abbe number of each of the first lens 1710, the third lens 1730, and the sixth lens 1760 may be 50 or more, an Abbe number of each of the second lens 1720 and the fifth lens 1750 may be 20 or more and less than 40, and an Abbe number of the fourth lens 1740 may be less than 20.

Table 34 below lists aspheric coefficients of each of the lenses included in the optical imaging system 1700 according to the 17th embodiment. According to the 17th embodiment, object-side surfaces and image-side surfaces of the first lens 1710 to the sixth lens 1760 may be aspherical.

TABLE 34

| Surface | | | | | | |
|---|---|---|---|---|---|---|
| No. | 2 | 3 | 4 | 5 | 6 | 7 |
| K | −0.614 | 6.436 | −80.000 | −0.754 | 0.021 | −70.139 |
| A | −6.484E−04 | 1.175E−05 | −2.725E−04 | 6.063E−04 | 2.671E−03 | −3.697E−05 |
| B | 5.287E−04 | −7.767E−07 | −1.870E−04 | −9.648E−04 | −2.483E−03 | −2.067E−07 |
| C | −2.417E−04 | −6.886E−08 | 9.502E−05 | 4.077E−04 | 1.297E−03 | −2.915E−08 |
| D | 7.471E−05 | −3.390E−09 | −3.099E−05 | −9.589E−05 | −4.502E−04 | −8.291E−09 |
| E | −1.628E−05 | −1.275E−10 | 8.089E−06 | 1.332E−05 | 1.108E−04 | −1.143E−09 |
| F | 2.544E−06 | 0.000E+00 | −1.646E−06 | −1.116E−06 | −2.007E−05 | 0.000E+00 |
| G | −2.874E−07 | 0.000E+00 | 2.457E−07 | 5.531E−08 | 2.719E−06 | 0.000E+00 |
| H | 2.358E−08 | 0.000E+00 | −2.618E−08 | −1.493E−09 | −2.753E−07 | 0.000E+00 |
| J | −1.401E−09 | 0.000E+00 | 1.974E−09 | 1.689E−11 | 2.067E−08 | 0.000E+00 |
| L | 5.963E−11 | 0.000E+00 | −1.043E−10 | 0.000E+00 | −1.132E−09 | 0.000E+00 |
| M | −1.768E−12 | 0.000E+00 | 3.777E−12 | 0.000E+00 | 4.398E−11 | 0.000E+00 |
| N | 3.470E−14 | 0.000E+00 | −8.931E−14 | 0.000E+00 | −1.149E−12 | 0.000E+00 |
| O | −4.045E−16 | 0.000E+00 | 1.242E−15 | 0.000E+00 | 1.811E−14 | 0.000E+00 |
| P | 2.121E−18 | 0.000E+00 | −7.715E−18 | 0.000E+00 | −1.304E−16 | 0.000E+00 |

| Surface | | | | | | |
|---|---|---|---|---|---|---|
| No. | 9 | 9 | 10 | 11 | 12 | 13 |
| K | 0.075 | 8.146 | 0.000 | 0.995 | 5.843 | 0.253 |
| A | 2.067E−03 | −1.081E−04 | −4.298E−03 | −5.214E−04 | −5.300E−03 | −4.719E−03 |
| B | −2.658E−03 | −1.305E−05 | 6.491E−03 | 3.821E−03 | 3.472E−04 | −2.900E−04 |
| C | 2.048E−03 | −9.269E−07 | −5.811E−03 | −6.524E−03 | −7.535E−05 | 4.784E−04 |
| D | −1.022E−03 | −3.280E−08 | 3.356E−03 | 6.422E−03 | −1.089E−05 | −3.010E−04 |
| E | 3.464E−04 | 1.632E−09 | −1.315E−03 | −4.029E−03 | 2.505E−05 | 1.239E−04 |
| F | −8.298E−05 | 0.000E+00 | 3.639E−04 | 1.724E−03 | −1.264E−05 | −3.501E−05 |
| G | 1.437E−05 | 0.000E+00 | −7.286E−05 | −5.214E−04 | 3.645E−06 | 6.972E−06 |
| H | −1.818E−06 | 0.000E+00 | 1.068E−05 | 1.134E−04 | −6.915E−07 | −9.926E−07 |
| J | 1.680E−07 | 0.000E+00 | −1.145E−06 | −1.781E−05 | 9.026E−08 | 1.015E−07 |
| L | −1.122E−08 | 0.000E+00 | 8.885E−08 | 1.998E−06 | −8.176E−09 | −7.386E−09 |
| M | 5.262E−10 | 0.000E+00 | −4.854E−09 | −1.559E−07 | 5.058E−10 | 3.735E−10 |
| N | −1.645E−11 | 0.000E+00 | 1.770E−10 | 8.020E−09 | −2.038E−11 | −1.246E−11 |
| O | 3.076E−13 | 0.000E+00 | −3.868E−12 | −2.435E−10 | 4.823E−13 | 2.466E−13 |
| P | −2.601E−15 | 0.000E+00 | 3.829E−14 | 3.289E−12 | −5.081E−15 | −2.191E−15 |

### 18th Embodiment

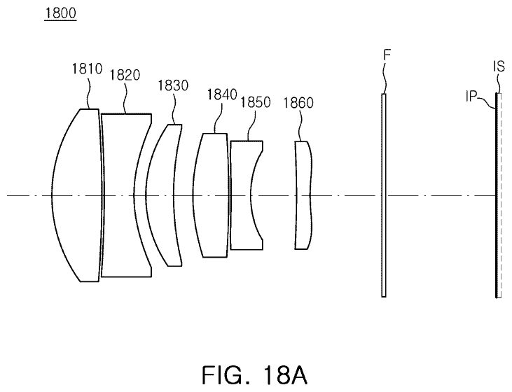

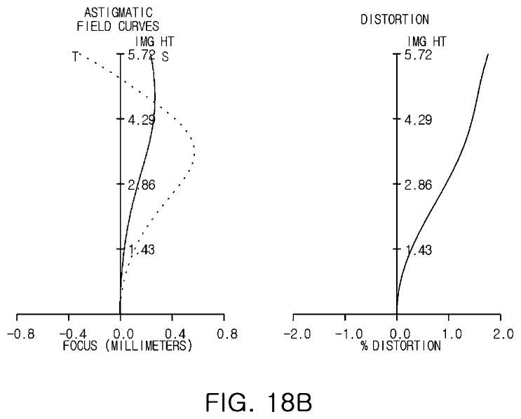

FIG. 18A is a configuration diagram illustrating an optical imaging system according to an 18th embodiment of the present disclosure. FIG. 18B is a graph showing aberration properties of the optical imaging system according to the 18th embodiment of the present disclosure.

An optical imaging system 1800 according to the 18th embodiment may include a first lens 1810, a second lens 1820, a third lens 1830, a fourth lens 1840, a fifth lens 1850, and a sixth lens 1860 sequentially disposed in ascending numerical order along an optical axis of the optical imaging system 1800 from an object side of the optical imaging system 1800 toward an imaging plane IP of the optical imaging system 1800, and may also include a filter F disposed on an image side of the sixth lens 1860 and an image sensor IS including the imaging plane IP. Also, a stop (not shown) may be disposed between the third lens 1830 and the fourth lens 1840.

Table 35 below lists characteristics of each of the lenses and other elements included in the optical imaging system 1800 according to the 18th embodiment.

TABLE 35

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.595 | 2.788 | 1.535 | 55.74 | 5.050 | 4.350 |
| 3 | Lens | −56.053 | 0.131 | | | 4.844 | 4.350 |
| 4 | Second | −200.938 | 1.656 | 1.614 | 25.94 | 4.769 | 4.350 |
| 5 | Lens | 8.368 | 0.665 | | | 4.218 | 4.350 |
| 6 | Third | 7.675 | 1.541 | 1.535 | 55.74 | 4.138 | |
| 7 | Lens | 17.463 | 1.075 | | | 3.954 | |
| 8 (Stop) | Fourth | 10.963 | 1.999 | 1.671 | 19.24 | 3.627 | |
| 9 | Lens | −60.509 | 0.125 | | | 3.280 | |
| 10 | Fifth | −100.301 | 1.094 | 1.614 | 25.94 | 3.179 | |
| 11 | Lens | 5.918 | 2.558 | | | 2.650 | |
| 12 | Sixth | 8.800 | 0.760 | 1.544 | 55.99 | 3.150 | |
| 13 | Lens | 10.599 | 4.000 | | | 3.358 | |
| 14 | Filter | Infinity | 0.210 | 1.518 | 64.17 | 6.000 | |
| 15 | | Infinity | 6.168 | | | 6.000 | |
| Image | | Infinity | | | | 5.734 | |

According to the 18th embodiment, the first lens 1810 and the second lens 1820 may be D-cut lenses.

According to the 18th embodiment, the first lens 1810 may have a positive refractive power, the second lens 1820 may have a negative refractive power, the third lens 1830 may have a positive refractive power, the fourth lens 1840 may have a positive refractive power, the fifth lens 1850 may have a negative refractive power, and the sixth lens 1860 may have a positive refractive power.

According to the 18th embodiment, an object-side surface and an image-side surface of the first lens 1810 may be convex in respective paraxial regions thereof. An object-side surface and an image-side surface of the second lens 1820 may be concave in respective paraxial regions thereof. An object-side surface of the third lens 1830 may be convex in a paraxial region thereof, and an image-side surface of the third lens 1830 may be concave in a paraxial region thereof. An object-side surface and an image-side surface of the fourth lens 1840 may be convex in respective paraxial regions thereof. An object-side surface and an image-side surface of the fifth lens 1850 may be concave in respective paraxial regions thereof. An object-side surface of the sixth lens 1860 may be convex in a paraxial region thereof, and an image-side surface of the sixth lens 1860 may be concave in a paraxial region thereof. Also, each of an object-side surface and an image-side surface of the sixth lens 1860 may have an inflection point.

According to the 18th embodiment, the first lens 1810, the second lens 1820, the fourth lens 1840, and the sixth lens 1860 may be made of plastic materials having different optical characteristics from each other. The third lens 1830 may be made of the same plastic material as the first lens 1810, and the fifth lens 1850 may be made of the same plastic material as the second lens 1820.

According to the 18th embodiment, the second lens 1820, the fourth lens 1840, and the fifth lens 1850 may be high-index lenses each having a refractive index of 1.6 or greater.

Also, an Abbe number of each of the first lens 1810, the third lens 1830 and the sixth lens 1860 may be 50 or more, an Abbe number of each of the second lens 1820 and the fifth lens 1850 may be 20 or more and less than 40, and an Abbe number of the fourth lens 1840 may be less than 20.

Table 36 below lists aspheric coefficients of each of the lenses included in the optical imaging system 1800 according to the 18th embodiment. According to the 18th embodiment, object-side surfaces and image-side surfaces of the first lens 1810 to the sixth lens 1860 may be aspherical.

TABLE 36

| Surface | | | | | | |
|---|---|---|---|---|---|---|
| No. | 2 | 3 | 4 | 5 | 6 | 7 |
| K | −0.555 | 19.466 | 0.000 | −0.729 | 0.102 | −0.182 |
| A | 2.561E−04 | −2.203E−03 | −2.394E−03 | −1.728E−04 | 6.036E−04 | −1.268E−05 |
| B | −3.522E−05 | 3.076E−03 | 2.648E−03 | −1.721E−04 | −4.053E−04 | 7.345E−05 |
| C | −2.378E−05 | −1.875E−03 | −1.602E−03 | 5.849E−06 | 2.012E−04 | −4.105E−05 |
| D | 1.408E−05 | 6.691E−04 | 5.804E−04 | 5.121E−05 | −6.973E−05 | 9.390E−06 |
| E | −3.720E−06 | −1.549E−04 | −1.375E−04 | −3.164E−05 | 1.700E−05 | −1.321E−06 |
| F | 6.124E−07 | 2.456E−05 | 2.240E−05 | 9.871E−06 | −3.235E−06 | 1.380E−07 |
| G | −6.912E−08 | −2.752E−06 | −2.584E−06 | −1.934E−06 | 5.154E−07 | −1.019E−08 |
| H | 5.566E−09 | 2.216E−07 | 2.143E−07 | 2.560E−07 | −6.803E−08 | 4.371E−10 |
| J | −3.243E−10 | −1.287E−08 | −1.282E−08 | −2.357E−08 | 7.023E−09 | −7.828E−12 |
| L | 1.361E−11 | 5.342E−10 | 5.484E−10 | 1.516E−09 | −5.341E−10 | 0.000E+00 |
| M | −4.017E−13 | −1.547E−11 | −1.636E−11 | −6.689E−11 | 2.837E−11 | 0.000E+00 |
| N | 7.909E−15 | 2.968E−13 | 3.233E−13 | 1.934E−12 | −9.876E−13 | 0.000E+00 |
| O | −9.327E−17 | −3.393E−15 | −3.807E−15 | −3.301E−14 | 2.016E−14 | 0.000E+00 |
| P | 4.978E−19 | 1.750E−17 | 2.022E−17 | 2.524E−16 | −1.827E−16 | 0.000E+00 |

| Surface | | | | | | |
|---|---|---|---|---|---|---|
| No. | 9 | 9 | 10 | 11 | 12 | 13 |
| K | −0.247 | 0.921 | −23.601 | −0.100 | −0.575 | −3.247 |
| A | 9.874E−04 | −1.182E−06 | 1.861E−03 | 1.135E−02 | −9.586E−03 | −9.082E−03 |
| B | −2.004E−03 | −1.493E−07 | −7.040E−03 | −3.982E−02 | 4.317E−03 | 3.811E−03 |
| C | 2.067E−03 | −1.446E−08 | 8.385E−03 | 6.767E−02 | −5.983E−03 | −4.204E−03 |
| D | −1.331E−03 | −1.066E−09 | −6.043E−03 | −7.277E−02 | 5.325E−03 | 3.123E−03 |
| E | 5.651E−04 | −8.737E−11 | 2.990E−03 | 5.340E−02 | −3.101E−03 | −1.571E−03 |
| F | −1.666E−04 | 0.000E+00 | −1.055E−03 | −2.770E−02 | 1.236E−03 | 5.526E−04 |
| G | 3.510E−05 | 0.000E+00 | 2.701E−04 | 1.037E−02 | −3.470E−04 | −1.389E−04 |
| H | −5.365E−06 | 0.000E+00 | −5.060E−05 | −2.828E−03 | 6.974E−05 | 2.523E−05 |
| J | 5.959E−07 | 0.000E+00 | 6.925E−06 | 5.618E−04 | −1.007E−05 | −3.314E−06 |
| L | −4.760E−08 | 0.000E+00 | −6.840E−07 | −8.038E−05 | 1.035E−06 | 3.117E−07 |
| M | 2.664E−09 | 0.000E+00 | 4.743E−08 | 8.060E−06 | −7.394E−08 | −2.044E−08 |
| N | −9.908E−11 | 0.000E+00 | −2.189E−09 | −5.372E−07 | 3.482E−09 | 8.876E−10 |
| O | 2.200E−12 | 0.000E+00 | 6.040E−11 | 2.137E−08 | −9.711E−11 | −2.292E−11 |
| P | −2.205E−14 | 0.000E+00 | −7.530E−13 | −3.835E−10 | 1.214E−12 | 2.662E−13 |

### 19th Embodiment

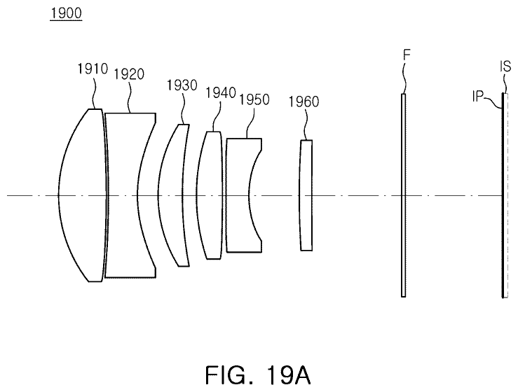

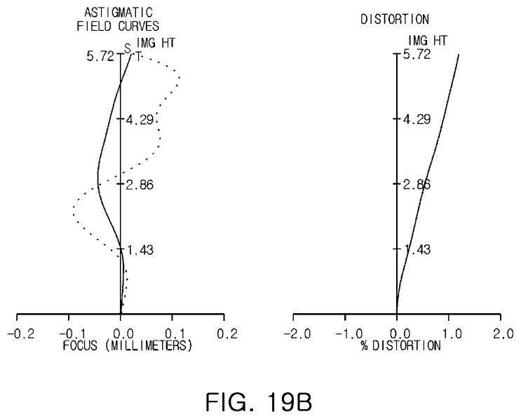

FIG. 19A is a configuration diagram illustrating an optical imaging system according to a 19th embodiment of the present disclosure. FIG. 19B is a graph showing aberration properties of the optical imaging system according to the 19th embodiment of the present disclosure.

An optical imaging system 1900 according to the 19th embodiment may include a first lens 1910, a second lens 1920, a third lens 1930, a fourth lens 1940, a fifth lens 1950, and a sixth lens 1960 sequentially disposed in ascending numerical order along an optical axis of the optical imaging system 1900 from an object side of the optical imaging system 1900 toward an imaging plane IP of the optical imaging system 1900, and may also include a filter F disposed on an image side of the sixth lens 1960 and an image sensor IS including the imaging plane IP. Also, a stop (not shown) may be disposed between the third lens 1930 and the fourth lens 1940.

Table 37 below lists characteristics of each of the lenses and other elements included in the optical imaging system 1900 according to the 19th embodiment.

TABLE 37

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.169 | 2.652 | 1.535 | 55.73 | 5.050 | 4.350 |
| | Lens | | | | | | |
| 3 | | −56.514 | 0.116 | | | 4.886 | 4.350 |
| 4 | Second | −153.432 | 1.616 | 1.614 | 25.95 | 4.819 | 4.350 |
| | Lens | | | | | | |
| 5 | | 8.169 | 1.149 | | | 4.261 | 4.350 |
| 6 | Third | 8.185 | 1.355 | 1.535 | 55.73 | 4.153 | |
| | Lens | | | | | | |
| 7 | | 21.468 | 0.782 | | | 4.013 | |
| 8 (Stop) | Fourth | 10.966 | 1.448 | 1.671 | 19.24 | 3.729 | |
| | Lens | | | | | | |
| 9 | | −88.304 | 0.199 | | | 3.518 | |
| 10 | Fifth | 2819.363 | 1.273 | 1.614 | 25.95 | 3.327 | |
| | Lens | | | | | | |
| 11 | | 5.808 | 2.807 | | | 2.700 | |
| 12 | Sixth | 6.672 | 0.698 | 1.544 | 55.99 | 3.230 | |
| | Lens | | | | | | |
| 13 | | 7.281 | 5.000 | | | 3.406 | |
| 14 | Filter | Infinity | 0.210 | 1.518 | 64.17 | 6.000 | |
| 15 | | Infinity | 5.429 | | | 6.000 | |
| Image | | Infinity | | | | 5.723 | |

According to the 19th embodiment, the first lens 1910 and the second lens 1920 may be D-cut lenses.

According to the 19th embodiment, the first lens 1910 may have a positive refractive power, the second lens 1920 may have a negative refractive power, the third lens 1930 may have a positive refractive power, the fourth lens 1940 may have a positive refractive power, the fifth lens 1950 may have a negative refractive power, and the sixth lens 1960 may have a positive refractive power.

According to the 19th embodiment, an object-side surface and an image-side surface of the first lens 1910 may be convex in respective paraxial regions thereof. An object-side surface and an image-side surface of the second lens 1920 may be concave in respective paraxial regions thereof. An object-side surface of the third lens 1930 may be convex in a respective paraxial region, and an image-side surface of the third lens 1930 may be concave in a respective paraxial region. An object-side surface and an image-side surface of the fourth lens 1940 may be convex in respective paraxial regions thereof. Object-side surfaces of the fifth lens 1950 and the sixth lens 1960 may be convex in respective paraxial regions thereof, and image-side surfaces of the fifth lens 1950 and the sixth lens 1960 may be concave in respective paraxial regions thereof. Also, each of an object-side surface and an image-side surface of the sixth lens 1960 may have an inflection point.

According to the 19th embodiment, the first lens 1910, the second lens 1920, the fourth lens 1940, and the sixth lens 1960 may be made of plastic materials having different optical characteristics from each other. The third lens 1930 may be made of the same plastic material as the first lens 1910, and the fifth lens 1950 may be made of the same plastic material as the second lens 1920.

According to the 19th embodiment, the second lens 1920, the fourth lens 1940, and the fifth lens 1950 may be high-index lenses each having a refractive index of 1.6 or greater.

Also, an Abbe number of each of the first lens 1910, the third lens 1930, and the sixth lens 1960 may be 50 or more, an Abbe number of each of the second lens 1920 and the fifth lens 1950 may be 20 or more and less than 40, and an Abbe number of the fourth lens 1940 may be less than 20.

Table 38 below lists aspheric coefficients of each of the lenses included in the optical imaging system 1900 according to the 19th embodiment. According to the 19th embodiment, object-side surfaces and image-side surfaces of the first lens 1910 to the sixth lens 1960 may be aspherical.

TABLE 38

| Surface | | | | | | |
|---|---|---|---|---|---|---|
| No. | 2 | 3 | 4 | 5 | 6 | 7 |
| K | −0.565 | 14.063 | 0.000 | −0.757 | 0.077 | −0.608 |
| A | 1.887E−04 | −1.427E−03 | −1.920E−03 | −5.535E−04 | 7.700E−04 | 1.095E−03 |
| B | −6.829E−05 | 1.631E−03 | 1.655E−03 | 3.145E−04 | −2.096E−04 | −8.805E−04 |
| C | 1.914E−05 | −8.593E−04 | −8.638E−04 | −2.318E−04 | −3.164E−05 | 3.089E−04 |
| D | −3.320E−06 | 2.778E−04 | 2.839E−04 | 9.963E−05 | 3.802E−05 | −6.260E−05 |
| E | 2.712E−07 | −5.993E−05 | −6.281E−05 | −2.883E−05 | −1.403E−05 | 7.949E−06 |
| F | 1.489E−08 | 8.999E−06 | 9.704E−06 | 5.799E−06 | 3.155E−06 | −6.385E−07 |
| G | −7.040E−09 | −9.622E−07 | −1.070E−06 | −8.248E−07 | −4.809E−07 | 3.135E−08 |
| H | 9.602E−10 | 7.405E−08 | 8.501E−08 | 8.379E−08 | 5.134E−08 | −8.548E−10 |
| J | −7.793E−11 | −4.103E−09 | −4.869E−09 | −6.070E−09 | −3.850E−09 | 9.877E−12 |
| L | 4.159E−12 | 1.620E−10 | 1.989E−10 | 3.090E−10 | 1.988E−10 | 0.000E+00 |
| M | −1.474E−13 | −4.438E−12 | −5.641E−12 | −1.071E−11 | −6.771E−12 | 0.000E+00 |
| N | 3.344E−15 | 8.018E−14 | 1.055E−13 | 2.375E−13 | 1.394E−13 | 0.000E+00 |
| O | −4.397E−17 | −8.586E−16 | −1.170E−15 | −2.986E−15 | −1.437E−15 | 0.000E+00 |
| P | 2.547E−19 | 4.129E−18 | 5.821E−18 | 1.567E−17 | 3.973E−18 | 0.000E+00 |

| Surface | | | | | | |
|---|---|---|---|---|---|---|
| No. | 9 | 9 | 10 | 11 | 12 | 13 |
| K | −0.366 | −21.114 | 20.000 | −0.301 | −0.578 | −2.389 |
| A | 1.353E−03 | 4.689E−03 | 3.125E−03 | −5.382E−04 | −8.341E−03 | −6.441E−03 |
| B | −1.796E−03 | −8.010E−03 | −8.228E−03 | −3.567E−03 | 1.509E−03 | −1.860E−03 |
| C | 1.057E−03 | 6.317E−03 | 7.512E−03 | 6.611E−03 | −2.407E−03 | 2.267E−03 |
| D | −4.241E−04 | −3.129E−03 | −4.128E−03 | −6.856E−03 | 2.292E−03 | −1.605E−03 |
| E | 1.294E−04 | 1.103E−03 | 1.611E−03 | 4.936E−03 | −1.360E−03 | 7.703E−04 |
| F | −3.037E−05 | −2.907E−04 | −4.710E−04 | −2.542E−03 | 5.440E−04 | −2.583E−04 |
| G | 5.360E−06 | 5.790E−05 | 1.042E−04 | 9.480E−04 | −1.526E−04 | 6.170E−05 |
| H | −6.961E−07 | −8.678E−06 | −1.735E−05 | −2.573E−04 | 3.058E−05 | −1.062E−05 |
| J | 6.526E−08 | 9.663E−07 | 2.144E−06 | 5.076E−05 | −4.405E−06 | 1.320E−06 |
| L | −4.315E−09 | −7.834E−08 | −1.926E−07 | −7.191E−06 | 4.521E−07 | −1.173E−07 |
| M | 1.940E−10 | 4.475E−09 | 1.218E−08 | 7.125E−07 | −3.227E−08 | 7.260E−09 |
| N | −5.556E−12 | −1.702E−10 | −5.121E−10 | −4.683E−08 | 1.522E−09 | −2.973E−10 |
| O | 8.939E−14 | 3.862E−12 | 1.283E−11 | 1.834E−09 | −4.260E−11 | 7.236E−12 |
| P | −5.895E−16 | −3.949E−14 | −1.448E−13 | −3.239E−11 | 5.363E−13 | −7.925E−14 |

### 20th Embodiment

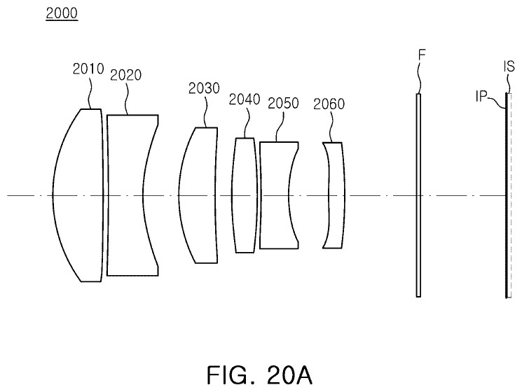

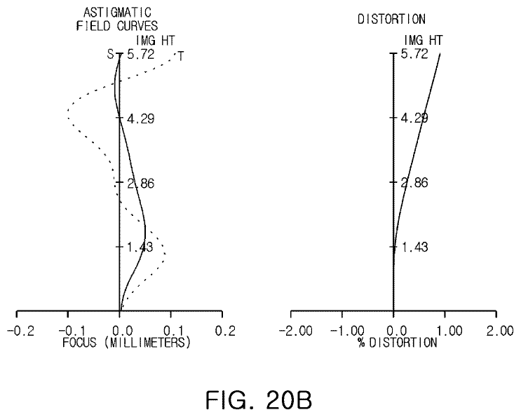

FIG. 20A is a configuration diagram illustrating an optical imaging system according to a 20th embodiment of the present disclosure. FIG. 20B is a graph showing aberration properties of the optical imaging system according to the 20th embodiment of the present disclosure.

An optical imaging system 2000 according to the 20th embodiment may include a first lens 2010, a second lens 2020, a third lens 2030, a fourth lens 2040, a fifth lens 2050, and a sixth lens 2060 sequentially disposed in ascending numerical order along an optical axis of the optical imaging system 2000 from an object side of the optical imaging system 2000 toward an imaging plane IP of the optical imaging system 2000, and may also include a filter F disposed on an image side of the sixth lens 2060 and an image sensor IS including the imaging plane IP. Also, a stop (not shown) may be disposed between the third lens 2030 and the fourth lens 2040.

Table 39 below lists characteristics of each of the lenses and other elements included in the optical imaging system 2000 according to the 20th embodiment.

TABLE 39

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.630 | 2.800 | 1.535 | 55.73 | 5.050 | 4.350 |
| 3 | Lens | −124.251 | 0.296 | | | 4.822 | 4.350 |
| 4 | Second | 405.007 | 1.922 | 1.614 | 25.95 | 4.704 | 4.350 |
| 5 | Lens | 9.165 | 1.999 | | | 4.160 | 4.350 |
| 6 | Third | 9.059 | 2.021 | 1.535 | 55.73 | 3.965 | |
| 7 | Lens | 55.851 | 0.928 | | | 3.688 | |
| 8 (Stop) | Fourth | 20.850 | 1.426 | 1.671 | 19.24 | 3.353 | |
| 9 | Lens | −27.880 | 0.210 | | | 3.228 | |
| 10 | Fifth | −42.210 | 1.530 | 1.614 | 25.95 | 3.119 | |
| 11 | Lens | 8.003 | 2.226 | | | 2.750 | |
| 12 | Sixth | 16.328 | 0.901 | 1.544 | 55.99 | 3.089 | |
| 13 | Lens | 12.472 | 4.000 | | | 3.420 | |
| 14 | Filter | Infinity | 0.210 | 1.518 | 64.17 | 6.000 | |
| 15 | | Infinity | 4.799 | | | 6.000 | |
| Image | | Infinity | | | | 5.720 | |

According to the 20th embodiment, the first lens 2010 and the second lens 2020 may be D-cut lenses.

According to the 20th embodiment, the first lens 2010 may have a positive refractive power, the second lens 2020 may have a negative refractive power, the third lens 2030 may have a positive refractive power, the fourth lens 2040 may have a positive refractive power, the fifth lens 2050 may have a negative refractive power, and the sixth lens 2060 may have a negative refractive power.

According to the 20th embodiment, an object-side surface and an image-side surface of the first lens 2010 may be convex in respective paraxial regions thereof. Object-side surfaces of the second lens 2020 and the third lens 2030 may be convex in respective paraxial regions thereof, and image-side surfaces of the second lens 2020 and the third lens 2030 may be concave in respective paraxial regions thereof. An object-side surface and an image-side surface of the fourth lens 2040 may be convex in respective paraxial regions thereof. An object-side surface and an image-side surface of the fifth lens 2050 may be concave in respective paraxial regions thereof. An object-side surface of the sixth lens 2060 may be convex in a paraxial region thereof, and an image-side surface of the sixth lens 2060 may be concave in a paraxial region thereof. Also, each of an object-side surface and an image-side surface of the sixth lens 2060 may have an inflection point.

According to the 20th embodiment, the first lens 2010, the second lens 2020, the fourth lens 2040, and the sixth lens 2060 may be made of plastic materials having different optical characteristics from each other. The third lens 2030 may be made of the same plastic material as the first lens 2010, and the fifth lens 2050 may be made of the same plastic material as the second lens 2020.

According to the 20th embodiment, the second lens 2020, the fourth lens 2040, and the fifth lens 2050 may be high-index lenses each having a refractive index of 1.6 or greater.

Also, an Abbe number of each of the first lens 2010, the third lens 2030, and the sixth lens 2060 may be 50 or more, an Abbe number of each of the second lens 2020 and the fifth lens 2050 may be 20 or more and less than 40, and an Abbe number of the fourth lens 2040 may be less than 20.

Table 40 below lists aspheric coefficients of each of the lenses included in the optical imaging system 2000 according to the 20th embodiment. According to the 20th embodiment, object-side surfaces and image-side surfaces of the first lens 2010 to the sixth lens 2060 may be aspherical.

TABLE 40

| Surface | | | | | | |
|---|---|---|---|---|---|---|
| No. | 2 | 3 | 4 | 5 | 6 | 7 |
| K | −0.566 | 19.590 | 0.000 | −0.732 | 0.086 | −2.473 |
| A | −1.360E−05 | −1.271E−03 | −2.037E−03 | −5.846E−04 | 4.733E−04 | 5.057E−04 |
| B | 1.005E−04 | 1.492E−03 | 1.935E−03 | 4.399E−04 | −1.309E−04 | 2.061E−04 |
| C | −5.613E−05 | −7.983E−04 | −1.048E−03 | −3.011E−04 | 9.934E−05 | −3.247E−04 |
| D | 1.678E−05 | 2.613E−04 | 3.523E−04 | 1.156E−04 | −8.518E−05 | 1.234E−04 |
| E | −3.171E−06 | −5.713E−05 | −8.014E−05 | −3.123E−05 | 3.671E−05 | −2.358E−05 |
| F | 4.085E−07 | 8.736E−06 | 1.286E−05 | 6.296E−06 | −9.545E−06 | 2.583E−06 |
| G | −3.741E−08 | −9.570E−07 | −1.489E−06 | −9.482E−07 | 1.670E−06 | −1.643E−07 |
| H | 2.494E−09 | 7.594E−08 | 1.253E−07 | 1.054E−07 | −2.073E−07 | 5.648E−09 |
| J | −1.223E−10 | −4.367E−09 | −7.668E−09 | −8.525E−09 | 1.860E−08 | −8.119E−11 |
| L | 4.400E−12 | 1.800E−10 | 3.369E−10 | 4.931E−10 | −1.203E−09 | 0.000E+00 |
| M | −1.138E−13 | −5.182E−12 | −1.035E−11 | −1.982E−11 | 5.478E−11 | 0.000E+00 |
| N | 2.011E−15 | 9.897E−14 | 2.110E−13 | 5.250E−13 | −1.667E−12 | 0.000E+00 |
| O | −2.177E−17 | −1.127E−15 | −2.565E−15 | −8.242E−15 | 3.045E−14 | 0.000E+00 |
| P | 1.087E−19 | 5.797E−18 | 1.408E−17 | 5.806E−17 | −2.524E−16 | 0.000E+00 |

| Surface | | | | | | |
|---|---|---|---|---|---|---|
| No. | 9 | 9 | 10 | 11 | 12 | 13 |
| K | −0.337 | −10.852 | −76.036 | −0.382 | −2.081 | −1.707 |
| A | 6.774E−04 | 8.720E−04 | 5.426E−04 | −2.473E−03 | −7.634E−03 | −6.969E−03 |
| B | −4.091E−04 | −1.717E−03 | −4.274E−03 | 2.780E−03 | −2.655E−03 | −2.177E−03 |
| C | 1.958E−04 | 1.885E−03 | 6.022E−03 | −3.531E−03 | 3.649E−03 | 2.680E−03 |
| D | −1.748E−04 | −1.454E−03 | −4.922E−03 | 3.542E−03 | −2.871E−03 | −1.796E−03 |
| E | 9.623E−05 | 7.417E−04 | 2.658E−03 | −2.438E−03 | 1.554E−03 | 8.048E−04 |
| F | −3.016E−05 | −2.465E−04 | −9.841E−04 | 1.185E−03 | −5.981E−04 | −2.515E−04 |
| G | 5.904E−06 | 5.460E−05 | 2.572E−04 | −4.164E−04 | 1.669E−04 | 5.619E−05 |
| H | −7.653E−07 | −8.205E−06 | −4.838E−05 | 1.068E−04 | −3.406E−05 | −9.090E−06 |
| J | 6.713E−08 | 8.338E−07 | 6.605E−06 | −1.995E−05 | 5.074E−06 | 1.068E−06 |
| L | −3.935E−09 | −5.506E−08 | −6.504E−07 | 2.686E−06 | −5.452E−07 | −9.015E−08 |
| M | 1.447E−10 | 2.081E−09 | 4.508E−08 | −2.534E−07 | 4.110E−08 | 5.333E−09 |
| N | −2.779E−12 | −2.358E−11 | −2.089E−09 | 1.590E−08 | −2.061E−09 | −2.098E−10 |
| O | 8.948E−15 | −1.150E−12 | 5.815E−11 | −5.954E−10 | 6.168E−11 | 4.928E−12 |
| P | 3.793E−16 | 3.458E−14 | −7.354E−13 | 1.007E−11 | −8.335E−13 | −5.230E−14 |

### 21st Embodiment

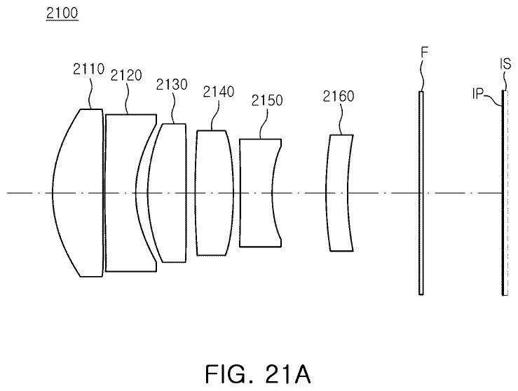

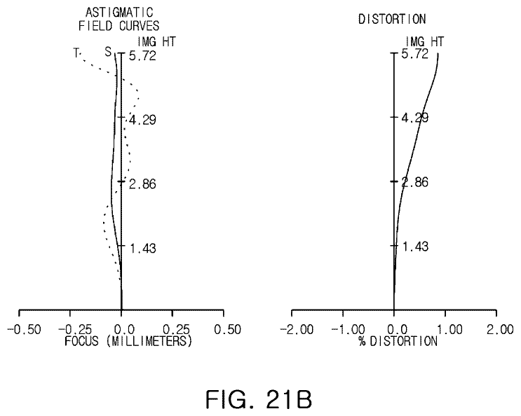

FIG. 21A is a configuration diagram illustrating an optical imaging system according to a 21st embodiment of the present disclosure. FIG. 21B is a graph showing aberration properties of the optical imaging system according to the 21st embodiment of the present disclosure.

An optical imaging system 2100 according to the 21st embodiment may include a first lens 2110, a second lens 2120, a third lens 2130, a fourth lens 2140, a fifth lens 2150, and a sixth lens 2160 sequentially disposed in ascending numerical order along an optical axis of the optical imaging system 2100 from an object side of the optical imaging system 2100 toward an imaging plane IP of the optical imaging system 2100, and may also include a filter F disposed on an image side of the sixth lens 2160 and an image sensor IS including the imaging plane IP. Also, a stop (not shown) may be disposed between the third lens 2130 and the fourth lens 2140.

Table 41 below lists characteristics of each of the lenses and other elements included in the optical imaging system 2100 according to the 21st embodiment.

TABLE 41

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 8.025 | 2.800 | 1.535 | 55.73 | 4.900 | 4.350 |
| 3 | Lens | 360.404 | 0.100 | | | 4.649 | 4.350 |
| 4 | Second | 50.644 | 1.728 | 1.614 | 25.95 | 4.587 | 4.350 |
| 5 | Lens | 6.727 | 0.669 | | | 4.061 | 4.350 |
| 6 | Third | 10.573 | 2.140 | 1.535 | 55.73 | 4.050 | |
| 7 | Lens | −2386.57 | 0.500 | | | 3.830 | |
| 8 (Stop) | Fourth | 28.332 | 2.132 | 1.671 | 19.24 | 3.649 | |
| 9 | Lens | −20.439 | 0.386 | | | 3.473 | |
| 10 | Fifth | −69.367 | 1.769 | 1.614 | 25.95 | 3.150 | |
| 11 | Lens | 9.043 | 3.000 | | | 2.750 | |
| 12 | Sixth | 9.252 | 1.200 | 1.544 | 55.99 | 3.400 | |
| 13 | Lens | 7.732 | 4.000 | | | 3.591 | |
| 14 | Filter | Infinity | 0.210 | 1.518 | 64.17 | 6.000 | |
| 15 | | Infinity | 4.450 | | | 6.000 | |
| Image | | Infinity | | | | 5.725 | |

According to the 21st embodiment, the first lens 2110 and the second lens 2120 may be D-cut lenses.

According to the 21st embodiment, the first lens 2110 may have a positive refractive power, the second lens 2120 may have a negative refractive power, the third lens 2130 may have a positive refractive power, the fourth lens 2140 may have a positive refractive power, the fifth lens 2150 may have a negative refractive power, and the sixth lens 2160 may have a negative refractive power.

According to the 21st embodiment, an object-side surface of the first lens 2110 and the second lens 2120 may be convex in respective paraxial regions thereof, and an image-side surface of the first lens 2110 and the second lens 2120 may be concave in respective paraxial regions thereof. Object-side surfaces and image-side surfaces of the third lens 2130 and the fourth lens 2140 may be convex in respective paraxial regions thereof. An object-side surface and an image-side surface of the fifth lens 2150 may be concave in respective paraxial regions thereof. An object-side surface of the sixth lens 2160 may be convex in a paraxial region thereof, and an image-side surface of the sixth lens 2160 may be concave in a paraxial region thereof.

According to the 21st embodiment, the first lens 2110, the second lens 2120, the fourth lens 2140, and the sixth lens 2160 may be made of plastic materials having different optical characteristics from each other. The third lens 2130 may be made of the same plastic material as the first lens 2110, and the fifth lens 2150 may be made of the same plastic material as the second lens 2120.

According to the 21st embodiment, the second lens 2120, the fourth lens 2140, and the fifth lens 2150 may be high-index lenses each having a refractive index of 1.6 or greater.

Also, an Abbe number of each of the first lens 2110, the third lens 2130, and the sixth lens 2160 may be 50 or more, an Abbe number of each of the second lens 2120 and the fifth lens 2150 may be 20 or more and less than 40, and an Abbe number of the fourth lens 2140 may be less than 20.

Table 42 below lists aspheric coefficients of each of the lenses included in the optical imaging system 2100 according to the 21st embodiment. According to the 21st embodiment, object-side surfaces and image-side surfaces of the first lens 2110 to the sixth lens 2160 may be aspherical.

TABLE 42

| Surface | | | | | | |
|---|---|---|---|---|---|---|
| No. | 2 | 3 | 4 | 5 | 6 | 7 |
| K | −0.646 | 20.000 | −80.000 | −0.742 | 0.184 | 20.000 |
| A | −1.162E−04 | 3.982E−06 | 2.088E−04 | 6.086E−04 | 2.777E−04 | −7.512E−05 |
| B | 7.203E−05 | −5.722E−07 | −4.121E−04 | −9.648E−04 | −3.829E−04 | −3.258E−06 |
| C | −2.958E−05 | −4.998E−08 | 1.643E−04 | 4.077E−04 | 1.045E−04 | −1.112E−07 |
| D | 1.054E−05 | −2.763E−09 | −4.389E−05 | −9.589E−05 | 2.058E−05 | 4.337E−10 |
| E | −2.833E−06 | −1.363E−10 | 8.900E−06 | 1.332E−05 | −2.034E−05 | 7.461E−10 |
| F | 5.309E−07 | 0.000E+00 | −1.434E−06 | −1.116E−06 | 6.271E−06 | 0.000E+00 |
| G | −6.895E−08 | 0.000E+00 | 1.811E−07 | 5.531E−08 | −1.169E−06 | 0.000E+00 |
| H | 6.285E−09 | 0.000E+00 | −1.736E−08 | −1.493E−09 | 1.500E−07 | 0.000E+00 |
| J | −4.054E−10 | 0.000E+00 | 1.227E−09 | 1.689E−11 | −1.378E−08 | 0.000E+00 |
| L | 1.843E−11 | 0.000E+00 | −6.235E−11 | 0.000E+00 | 9.086E−10 | 0.000E+00 |
| M | −5.779E−13 | 0.000E+00 | 2.208E−12 | 0.000E+00 | −4.194E−11 | 0.000E+00 |
| N | 1.191E−14 | 0.000E+00 | −5.163E−14 | 0.000E+00 | 1.285E−12 | 0.000E+00 |
| O | −1.450E−16 | 0.000E+00 | 7.164E−16 | 0.000E+00 | −2.347E−14 | 0.000E+00 |
| P | 7.921E−19 | 0.000E+00 | −4.466E−18 | 0.000E+00 | 1.932E−16 | 0.000E+00 |

| Surface | | | | | | |
|---|---|---|---|---|---|---|
| No. | 9 | 9 | 10 | 11 | 12 | 13 |
| K | −8.396 | 4.849 | 0.000 | 0.802 | 3.293 | −0.714 |
| A | 2.032E−04 | −9.657E−05 | −9.404E−04 | −3.622E−03 | −7.455E−03 | −6.596E−03 |
| B | 4.514E−05 | −1.222E−05 | 6.197E−04 | 1.062E−02 | 4.157E−03 | 2.447E−03 |
| C | −8.823E−05 | −8.980E−07 | −4.072E−04 | −2.032E−02 | −5.174E−03 | −2.503E−03 |
| D | 2.106E−05 | −4.166E−08 | 3.024E−04 | 2.452E−02 | 4.130E−03 | 1.803E−03 |
| E | 3.816E−06 | −1.387E−10 | −1.450E−04 | −1.932E−02 | −2.160E−03 | −8.716E−04 |
| F | −4.151E−06 | 0.000E+00 | 4.195E−05 | 1.042E−02 | 7.744E−04 | 2.916E−04 |
| G | 1.431E−06 | 0.000E+00 | −6.733E−06 | −3.963E−03 | −1.959E−04 | −6.895E−05 |
| H | −2.977E−07 | 0.000E+00 | 2.713E−07 | 1.082E−03 | 3.550E−05 | 1.167E−05 |
| J | 4.144E−08 | 0.000E+00 | 1.236E−07 | −2.128E−04 | −4.627E−06 | −1.416E−06 |
| L | −3.952E−09 | 0.000E+00 | −3.005E−08 | 2.989E−05 | 4.300E−07 | 1.221E−07 |
| M | 2.554E−10 | 0.000E+00 | 3.434E−09 | −2.927E−06 | −2.780E−08 | −7.295E−09 |
| N | −1.070E−11 | 0.000E+00 | −2.253E−10 | 1.896E−07 | 1.188E−09 | 2.872E−10 |
| O | 2.628E−13 | 0.000E+00 | 8.168E−12 | −7.308E−09 | −3.015E−11 | −6.695E−12 |
| P | −2.869E−15 | 0.000E+00 | −1.274E−13 | 1.268E−10 | 3.441E−13 | 7.000E−14 |

### 22nd Embodiment

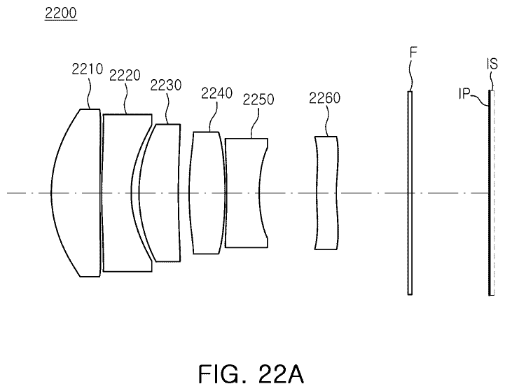

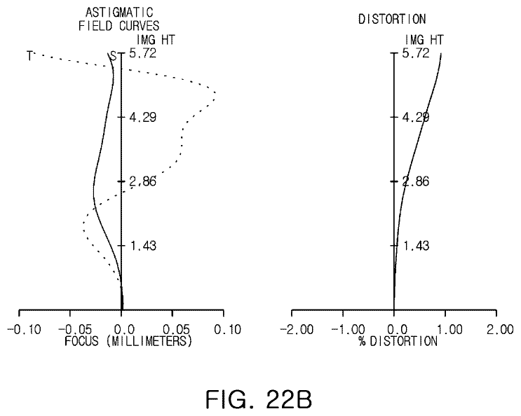

FIG. 22A is a configuration diagram illustrating an optical imaging system according to a 22nd embodiment of the present disclosure. FIG. 22B is a graph showing aberration properties of the optical imaging system according to the 22nd embodiment of the present disclosure.

An optical imaging system 2200 according to the 22nd embodiment may include a first lens 2210, a second lens 2220, a third lens 2230, a fourth lens 2240, a fifth lens 2250, and a sixth lens 2260 sequentially disposed in ascending numerical order along an optical axis of the optical imaging system 2200 from an object side of the optical imaging system 2200 toward an imaging plane IP of the optical imaging system 2200, and may also include a filter F disposed on an image side of the sixth lens 2260 and an image sensor IS including the imaging plane IP. Also, a stop (not shown) may be disposed between the third lens 2230 and the fourth lens 2240.

Table 43 below lists characteristics of each of the lenses and other elements included in the optical imaging system 2200 according to the 22nd embodiment.

TABLE 43

| | | | | | | | D-Cut Lens |
|---|---|---|---|---|---|---|---|
| Surface | | Radius of | Thickness/ | Refractive | Abbe | Effective | Minor Axis |
| No. | Element | Curvature | Distance | Index | Number | Radius | Radius |
| Object | | Infinity | Infinity | | | | |
| 1 | | Infinity | 0.000 | | | | |
| 2 | First | 7.859 | 2.708 | 1.535 | 55.73 | 4.900 | 4.350 |
| 3 | Lens | 200.282 | 0.100 | | | 4.667 | 4.350 |
| 4 | Second | 39.843 | 1.641 | 1.614 | 25.95 | 4.597 | 4.350 |
| 5 | Lens | 6.456 | 0.436 | | | 4.028 | 4.350 |
| 6 | Third | 8.823 | 2.195 | 1.535 | 55.73 | 4.018 | |
| 7 | Lens | 57.342 | 0.600 | | | 3.774 | |
| 8 (Stop) | Fourth | 19.904 | 2.000 | 1.671 | 19.24 | 3.565 | |
| 9 | Lens | −24.660 | 0.100 | | | 3.338 | |
| 10 | Fifth | −43.470 | 1.807 | 1.614 | 25.95 | 3.190 | |
| 11 | Lens | 9.444 | 3.200 | | | 2.680 | |
| 12 | Sixth | 16.450 | 1.100 | 1.544 | 55.99 | 3.300 | |
| 13 | Lens | 11.857 | 4.000 | | | 3.610 | |
| 14 | Filter | Infinity | 0.210 | 1.518 | 64.17 | 6.000 | |
| 15 | | Infinity | 4.359 | | | 6.000 | |
| Image | | Infinity | | | | 5.723 | |

According to the 22nd embodiment, the first lens 2210 and the second lens 2220 may be D-cut lenses.

According to the 22nd embodiment, the first lens 2210 may have a positive refractive power, the second lens 2220 may have a negative refractive power, the third lens 2230 may have a positive refractive power, the fourth lens 2240 may have a positive refractive power, the fifth lens 2250 may have a negative refractive power, and the sixth lens 2260 may have a negative refractive power.

According to the 22nd embodiment, object-side surfaces of the first lens 2210, the second lens 2220, and the third lens 2230 may be convex in respective paraxial regions thereof, and image-side surfaces of the first lens 2210, the second lens 2220, and the third lens 2230 may be concave in respective paraxial regions thereof. An object-side surface and an image-side surface of the fourth lens 2240 may be convex in respective paraxial regions thereof. An object-side surface and an image-side surface of the fifth lens 2250 may be concave in respective paraxial regions thereof. An object-side surface of the sixth lens 2260 may be convex in a paraxial region thereof, and an image-side surface of the sixth lens 2260 may be concave in a paraxial region thereof.

According to the 22nd embodiment, the first lens 2210, the second lens 2220, the fourth lens 2240, and the sixth lens 2260 may be made of plastic materials having different optical characteristics from each other. The third lens 2230 may be made of the same plastic material as the first lens 2210, and the fifth lens 2250 may be made of the same plastic material as the second lens 2220.

According to the 22nd embodiment, the second lens 2220, the fourth lens 2240, and the fifth lens 2250 may be high-index lenses each having a refractive index of 1.6 or greater.

Also, an Abbe number of each of the first lens 2210, the third lens 2230, and the sixth lens 2260 may be 50 or more, an Abbe number of each of the second lens 2220 and the fifth lens 2250 may be 20 or more and less than 40, and an Abbe number of the fourth lens 2240 may be less than 20.

Table 44 below lists aspheric coefficients of each of the lenses included in the optical imaging system 2200 according to the 22nd embodiment. According to the 22nd embodiment, object-side surfaces and image-side surfaces of the first lens 2210 to the sixth lens 2260 may be aspherical.

TABLE 44

| Surface | | | | | | |
|---|---|---|---|---|---|---|
| No. | 2 | 3 | 4 | 5 | 6 | 7 |
| K | −0.591 | 20.000 | −80.000 | −0.780 | −0.026 | −77.896 |
| A | −6.439E−05 | 9.840E−06 | −7.097E−05 | 5.938E−04 | 6.909E−04 | −3.257E−05 |
| B | 4.437E−05 | −7.043E−07 | −2.808E−04 | −9.662E−04 | −4.146E−04 | −2.997E−07 |
| C | −2.496E−06 | −6.145E−08 | 1.148E−04 | 4.076E−04 | 1.664E−05 | −3.122E−08 |
| D | −3.316E−06 | −2.995E−09 | −2.752E−05 | −9.590E−05 | 8.131E−05 | −8.057E−09 |
| E | 1.259E−06 | −1.098E−10 | 4.557E−06 | 1.332E−05 | −4.290E−05 | −1.039E−09 |
| F | −2.408E−07 | 0.000E+00 | −5.744E−07 | −1.116E−06 | 1.178E−05 | 0.000E+00 |
| G | 2.945E−08 | 0.000E+00 | 5.836E−08 | 5.531E−08 | −2.109E−06 | 0.000E+00 |
| H | −2.472E−09 | 0.000E+00 | −4.818E−09 | −1.493E−09 | 2.656E−07 | 0.000E+00 |
| J | 1.457E−10 | 0.000E+00 | 3.139E−10 | 1.689E−11 | −2.411E−08 | 0.000E+00 |
| L | −6.031E−12 | 0.000E+00 | −1.546E−11 | 0.000E+00 | 1.572E−09 | 0.000E+00 |
| M | 1.715E−13 | 0.000E+00 | 5.480E−13 | 0.000E+00 | −7.190E−11 | 0.000E+00 |
| N | −3.188E−15 | 0.000E+00 | −1.310E−14 | 0.000E+00 | 2.187E−12 | 0.000E+00 |
| O | 3.481E−17 | 0.000E+00 | 1.881E−16 | 0.000E+00 | −3.972E−14 | 0.000E+00 |
| P | −1.689E−19 | 0.000E+00 | −1.224E−18 | 0.000E+00 | 3.257E−16 | 0.000E+00 |

| Surface | | | | | | |
|---|---|---|---|---|---|---|
| No. | 9 | 9 | 10 | 11 | 12 | 13 |
| K | −0.079 | 9.319 | 0.000 | 0.915 | 6.134 | −1.067 |
| A | 7.447E−05 | −1.201E−04 | −6.611E−04 | −2.747E−03 | −6.134E−03 | −5.631E−03 |
| B | 3.950E−04 | −1.359E−05 | 1.409E−04 | 9.129E−03 | 1.845E−03 | 8.876E−04 |
| C | −4.970E−04 | −9.526E−07 | −2.689E−05 | −1.669E−02 | −2.255E−03 | −8.101E−04 |
| D | 3.256E−04 | −3.436E−08 | 1.158E−04 | 1.940E−02 | 1.811E−03 | 5.918E−04 |
| E | −1.411E−04 | 1.642E−09 | −1.137E−04 | −1.494E−02 | −9.480E−04 | −2.880E−04 |
| F | 4.248E−05 | 0.000E+00 | 5.912E−05 | 7.958E−03 | 3.396E−04 | 9.596E−05 |
| G | −9.115E−06 | 0.000E+00 | −1.956E−05 | −3.017E−03 | −8.566E−05 | −2.241E−05 |
| H | 1.413E−06 | 0.000E+00 | 4.403E−06 | 8.264E−04 | 1.543E−05 | 3.720E−06 |
| J | −1.585E−07 | 0.000E+00 | −6.911E−07 | −1.640E−04 | −1.994E−06 | −4.406E−07 |
| L | 1.276E−08 | 0.000E+00 | 7.584E−08 | 2.335E−05 | 1.832E−07 | 3.698E−08 |
| M | −7.182E−10 | 0.000E+00 | −5.711E−09 | −2.326E−06 | −1.168E−08 | −2.148E−09 |
| N | 2.684E−11 | 0.000E+00 | 2.813E−10 | 1.539E−07 | 4.907E−10 | 8.213E−11 |
| O | −5.987E−13 | 0.000E+00 | −8.170E−12 | −6.071E−09 | −1.223E−11 | −1.860E−12 |
| P | 6.029E−15 | 0.000E+00 | 1.061E−13 | 1.081E−10 | 1.368E−13 | 1.891E−14 |

Table 45 and Table 46 below list optical and physical properties of the optical imaging system according to the first to 22nd embodiments, and Table 47 and Table 48 below list values of Conditional Expressions 1 to 9 of the optical imaging system according to the first to 22nd embodiments.

TABLE 45

| Property | Emb. 1 | Emb. 2 | Emb. 3 | Emb. 4 | Emb. 5 | Emb. 6 |
|---|---|---|---|---|---|---|
| f | 24.932 | 25.106 | 25.107 | 25.107 | 25.122 | 25.084 |
| f1 | 10.975 | 10.344 | 10.610 | 10.932 | 10.340 | 10.416 |
| f2 | −12.159 | −10.923 | −11.516 | −12.436 | −10.781 | −10.277 |
| f3 | 20.587 | 18.530 | 19.433 | 22.991 | 21.702 | 26.286 |
| f4 | −14.188 | −13.735 | −14.692 | −18.936 | −19.208 | −33.587 |
| f5 | 20.307 | 20.939 | 22.063 | 17.390 | 27.703 | 25.575 |
| f6 | −38.353 | −36.545 | −34.271 | −17.740 | −36.497 | −25.066 |
| f123 | 15.091 | 14.508 | 14.715 | 15.862 | 15.938 | 19.331 |
| IMH | 5.720 | 5.720 | 5.720 | 5.720 | 5.720 | 5.720 |
| FNO | 2.570 | 2.560 | 2.560 | 2.560 | 2.560 | 2.560 |
| EPD | 9.800 | 9.800 | 9.800 | 9.800 | 9.800 | 9.800 |
| TTL | 24.590 | 24.456 | 24.456 | 24.455 | 24.446 | 24.453 |
| BFL | 8.820 | 8.650 | 8.656 | 7.913 | 8.146 | 8.153 |
| ΣCT | 8.476 | 9.004 | 8.852 | 8.939 | 8.874 | 9.121 |
| ΣAT | 7.294 | 6.802 | 6.948 | 7.603 | 7.426 | 7.179 |
| Td | 15.770 | 15.805 | 15.800 | 16.542 | 16.300 | 16.300 |
| ET2 | 2.900 | 2.930 | 2.960 | 2.540 | 2.450 | 2.470 |

| Property | Emb. 7 | Emb. 8 | Emb. 9 | Emb. 10 | Emb. 11 |
|---|---|---|---|---|---|
| f | 25.084 | 25.079 | 25.083 | 25.087 | 25.086 |
| f1 | 11.397 | 9.949 | 10.433 | 10.656 | 10.663 |
| f2 | −13.562 | −10.046 | −10.262 | −10.876 | −10.922 |
| f3 | 24.947 | 23.315 | 25.211 | 21.204 | 20.648 |
| f4 | −18.118 | −19.851 | −28.110 | −19.060 | −18.354 |
| f5 | 14.856 | 25.251 | 24.382 | 20.037 | 19.892 |
| f6 | −16.314 | −40.456 | −27.133 | −24.126 | −24.030 |
| f123 | 16.226 | 17.173 | 18.706 | 16.833 | 16.577 |
| IMH | 5.720 | 5.720 | 5.720 | 5.720 | 5.720 |
| FNO | 2.560 | 2.560 | 2.560 | 2.560 | 2.570 |
| EPD | 9.800 | 9.800 | 9.800 | 9.800 | 9.750 |
| TTL | 24.649 | 24.769 | 24.370 | 24.421 | 24.392 |
| BFL | 8.534 | 9.394 | 8.170 | 8.221 | 8.192 |
| ΣCT | 8.808 | 9.148 | 8.698 | 8.264 | 8.071 |
| ΣAT | 7.307 | 6.227 | 7.502 | 7.936 | 8.129 |
| Td | 16.115 | 15.375 | 16.200 | 16.200 | 16.200 |
| ET2 | 2.490 | 2.500 | 2.440 | 2.580 | 2.560 |

TABLE 46

| Property | Emb. 12 | Emb. 13 | Emb. 14 | Emb. 15 | Emb. 16 | Emb. 17 |
|---|---|---|---|---|---|---|
| f | 25.385 | 25.390 | 25.125 | 25.389 | 25.389 | 25.123 |
| f1 | 13.305 | 15.551 | 16.042 | 15.479 | 15.507 | 15.225 |
| f2 | −11.935 | −10.878 | −10.800 | −13.250 | −13.607 | −11.728 |
| f3 | 22.240 | 18.101 | 15.826 | 19.515 | 19.354 | 17.979 |
| f4 | 11.991 | 14.213 | 14.792 | 16.300 | 17.968 | 15.619 |
| f5 | −8.319 | −11.051 | −12.502 | −12.307 | −13.946 | −11.916 |
| f6 | 145.733 | 274.624 | −69.059 | −90.385 | −51.767 | −105.007 |
| f123 | 22.724 | 28.281 | 25.204 | 21.860 | 20.932 | 23.950 |
| IMH | 5.720 | 5.720 | 5.720 | 5.720 | 5.720 | 5.720 |
| FNO | 2.510 | 2.510 | 2.560 | 2.510 | 2.510 | 2.560 |
| EPD | 10.114 | 10.116 | 9.814 | 10.115 | 10.115 | 9.814 |
| TTL | 24.006 | 24.989 | 24.670 | 25.314 | 25.070 | 24.454 |
| BFL | 10.627 | 10.056 | 8.089 | 7.935 | 7.997 | 8.387 |
| ΣCT | 9.125 | 10.485 | 10.641 | 11.675 | 11.974 | 10.773 |
| ΣAT | 4.254 | 4.448 | 5.940 | 5.703 | 5.098 | 5.294 |
| Td | 13.379 | 14.933 | 16.581 | 17.378 | 17.073 | 16.066 |

| Property | Emb. 18 | Emb. 19 | Emb. 20 | Emb. 21 | Emb. 12 |
|---|---|---|---|---|---|
| f | 25.388 | 25.389 | 25.388 | 25.125 | 25.124 |
| f1 | 14.146 | 13.539 | 15.201 | 15.305 | 15.220 |
| f2 | −13.036 | −12.574 | −15.290 | −12.818 | −12.779 |
| f3 | 24.269 | 23.888 | 19.920 | 19.689 | 19.195 |
| f4 | 13.995 | 14.629 | 17.996 | 18.018 | 16.722 |
| f5 | −9.095 | −9.474 | −10.823 | −12.909 | −12.465 |
| f6 | 82.960 | 104.450 | −105.790 | −119.848 | −85.244 |
| f123 | 23.806 | 23.177 | 19.017 | 22.867 | 22.230 |
| IMH | 5.720 | 5.720 | 5.720 | 5.720 | 5.720 |
| FNO | 2.510 | 2.510 | 2.510 | 2.560 | 2.560 |
| EPD | 10.115 | 10.115 | 10.115 | 9.814 | 9.814 |
| TTL | 24.770 | 24.735 | 25.267 | 25.084 | 24.457 |
| BFL | 10.378 | 10.639 | 9.009 | 8.660 | 8.569 |
| ΣCT | 9.837 | 9.042 | 10.600 | 11.769 | 11.451 |
| ΣAT | 4.555 | 5.054 | 5.659 | 4.655 | 4.436 |
| Td | 14.392 | 14.096 | 16.259 | 16.424 | 15.887 |

TABLE 47

| Conditional | | | | | | |
|---|---|---|---|---|---|---|
| Expression | Emb. 1 | Emb. 2 | Emb. 3 | Emb. 4 | Emb. 5 | Emb. 6 |
| AR1 | 0.888 | 0.888 | 0.888 | 0.888 | 0.888 | 0.888 |
| CT1/d2 | 0.878 | 1.252 | 0.880 | 0.858 | 1.088 | 1.287 |
| ΣAT/Td | 0.463 | 0.430 | 0.440 | 0.460 | 0.456 | 0.440 |
| CT1/ET2 | 0.862 | 0.998 | 0.923 | 1.174 | 1.306 | 1.296 |
| IMH/f | 0.233 | 0.234 | 0.234 | 0.234 | 0.234 | 0.234 |
| EPD/Td | 0.621 | 0.620 | 0.620 | 0.592 | 0.601 | 0.601 |
| SD1/IMH | 0.857 | 0.857 | 0.857 | 0.857 | 0.857 | 0.857 |
| ΣCT/Td | 0.537 | 0.570 | 0.560 | 0.540 | 0.544 | 0.560 |
| f123/f | 0.605 | 0.578 | 0.586 | 0.632 | 0.634 | 0.771 |

| Conditional | | | | | |
|---|---|---|---|---|---|
| Expression | Emb. 7 | Emb. 8 | Emb. 9 | Emb. 10 | Emb. 11 |
| AR1 | 0.888 | 0.888 | 0.888 | 0.888 | 0.892 |
| CT1/d2 | 0.725 | 0.914 | 1.124 | 0.946 | 0.929 |
| ΣAT/Td | 0.453 | 0.405 | 0.463 | 0.490 | 0.502 |
| CT1/ET2 | 1.165 | 1.280 | 1.289 | 1.221 | 1.229 |
| IMH/f | 0.232 | 0.231 | 0.235 | 0.234 | 0.235 |
| EPD/Td | 0.608 | 0.637 | 0.605 | 0.605 | 0.602 |
| SD1/IMH | 0.857 | 0.857 | 0.857 | 0.857 | 0.852 |
| ΣCT/Td | 0.547 | 0.595 | 0.537 | 0.510 | 0.498 |
| f123/f | 0.647 | 0.685 | 0.746 | 0.671 | 0.661 |

TABLE 48

| Conditional | | | | | | |
|---|---|---|---|---|---|---|
| Expression | Emb. 12 | Emb. 13 | Emb. 14 | Emb. 15 | Emb. 16 | Emb. 17 |
| AR1 | 0.861 | 0.861 | 0.888 | 0.861 | 0.861 | 0.888 |
| CT1/d2 | 8.523 | 6.259 | 6.586 | 4.730 | 4.749 | 5.557 |
| ΣAT/Td | 0.318 | 0.298 | 0.358 | 0.328 | 0.299 | 0.329 |
| IMH/f | 0.225 | 0.225 | 0.228 | 0.225 | 0.225 | 0.228 |
| EPD/Td | 0.756 | 0.677 | 0.592 | 0.582 | 0.592 | 0.611 |
| SD1/IMH | 0.883 | 0.883 | 0.857 | 0.883 | 0.883 | 0.857 |
| ΣCT/Td | 0.682 | 0.702 | 0.642 | 0.672 | 0.701 | 0.671 |
| f123/f | 0.895 | 1.114 | 1.003 | 0.861 | 0.824 | 0.953 |

| Conditional | | | | | |
|---|---|---|---|---|---|
| Expression | Emb. 18 | Emb. 19 | Emb. 20 | Emb. 21 | Emb. 12 |
| AR1 | 0.861 | 0.861 | 0.861 | 0.888 | 0.888 |
| CT1/d2 | 4.195 | 2.308 | 1.401 | 4.187 | 6.207 |
| ΣAT/Td | 0.316 | 0.359 | 0.348 | 0.283 | 0.279 |
| IMH/f | 0.225 | 0.225 | 0.225 | 0.228 | 0.228 |
| EPD/Td | 0.703 | 0.718 | 0.622 | 0.598 | 0.618 |
| SD1/IMH | 0.883 | 0.883 | 0.883 | 0.857 | 0.857 |
| ΣCT/Td | 0.684 | 0.641 | 0.652 | 0.717 | 0.721 |
| f123/f | 0.938 | 0.913 | 0.749 | 0.910 | 0.885 |

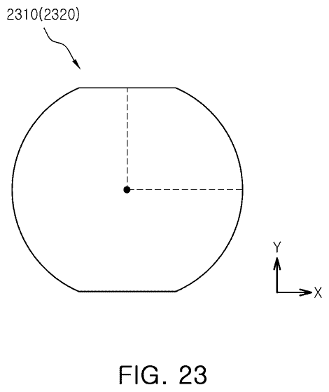

FIG. 23 is an example of a D-cut lens according to embodiments of the present disclosure.

According to embodiments, a first lens 2310 and a second lens 2320 may be provided as D-cut lenses as shown in FIG. 23. In FIG. 23, a Y-axis direction may correspond to a module height, and both edges of the first lens 2310 and the second lens 2320 in the Y-axis direction may be cut out to form straight edges. A diameter of the first lens 2310 and the second lens 2320 in an X-axis direction is a major axis diameter of the first lens 2310 and the second lens 2320, and a diameter of the first lens 2310 and the second lens 2320 in the Y-axis direction is a minor axis diameter of the first lens 2310 and the second lens 2320.

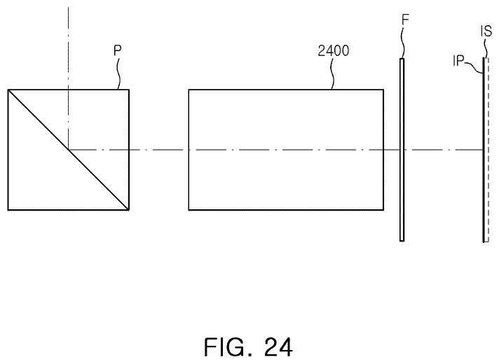

FIG. 24 is a configuration diagram illustrating a telephoto camera according to embodiments of the present disclosure.

Referring to FIG. 24, an optical imaging system 2400 according to embodiments may be employed in a folded system including a reflective member P that folds a light path. For example, the reflective member P may be disposed on an object side of the optical imaging system 2400.

According to the aforementioned embodiments, an increase in a module thickness may be reduced, and high-quality images may be obtained in a high-magnification mode.

While this disclosure includes specific embodiments, it will be apparent after an understanding of the disclosure of this application that various changes in form and detail may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens having a positive refractive power;
a second lens having a concave object-side surface in a paraxial region thereof;
a third lens having a positive refractive power;
a fourth lens having a negative refractive power;
a fifth lens having a refractive power; and
a sixth lens having a concave image-side surface in a paraxial region thereof,
wherein the first lens, the second lens, the third lens, the fourth lens, the fifth lens, and the sixth lens are sequentially disposed in ascending numerical order along an optical axis of the optical imaging system from an object side of the optical imaging system toward an imaging plane of the optical imaging system, and
a conditional expression 0.6≤CT1/d2≤1.4 is satisfied, where CT1 is a thickness of the first lens along the optical axis, and d2 is an air gap along the optical axis between the second lens and the third lens.

2. The optical imaging system of claim 1, wherein an object-side surface of the first lens is convex in a paraxial region thereof, and an image-side surface of the first lens is convex in a paraxial region thereof.

3. The optical imaging system of claim 1, wherein the second lens has a negative refractive power.

4. The optical imaging system of claim 1, wherein the fifth lens has a positive refractive power, and the sixth lens has a negative refractive power.

5. The optical imaging system of claim 1, wherein an object-side surface of the fifth lens is convex in a paraxial region thereof, and an image-side surface of the fifth lens is convex in a paraxial region thereof.

6. The optical imaging system of claim 1, wherein the first lens and the second lens are D-cut lenses.

7. The optical imaging system of claim 1, wherein the second lens, the third lens, and the fourth lens each have a refractive index of 1.6 or greater.

8. The optical imaging system of claim 1, wherein a conditional expression 0.1≤IMH/f≤0.4 is satisfied, where IMH is one half of a diagonal length of the imaging plane, and f is a focal length of the optical imaging system.

9. The optical imaging system of claim 1, wherein a conditional expression 0.7≤SD1/IMH≤1.0 is satisfied, where SD1 is a maximum effective radius of an object-side surface of the first lens, and IMH is one half of a diagonal length of the imaging plane.

10. The optical imaging system of claim 1, wherein a conditional expression 0.5≤EPD/Td≤0.9 is satisfied, where EPD is an entrance pupil diameter of the optical imaging system, and Td is a total distance along the optical axis from an object-side surface of the first lens to the image-side surface of the sixth lens.

11. An optical imaging system comprising:
a first lens having a convex image-side surface in a paraxial region thereof;
a second lens having a negative refractive power;
a third lens having a positive refractive power;
a fourth lens having a negative refractive power;
a fifth lens having a positive refractive power and a convex object-side surface in a paraxial region thereof; and
a sixth lens having a refractive power,
wherein the first lens, the second lens, the third lens, the fourth lens, the fifth lens, and the sixth lens are sequentially disposed in ascending numerical order along an optical axis of the optical imaging system from an object side of the optical imaging system toward an imaging plane of the optical imaging system,
the fifth lens has an Abbe number of 50 or more, and
a conditional expression 0.1≤IMH/f≤0.4 is satisfied, where IMH is one half of a diagonal length of the imaging plane, and f is a focal length of the optical imaging system.

12. The optical imaging system of claim 11, wherein a conditional expression 0.4≤ΣAT/Td≤0.6 is satisfied, where ΣAT is a sum of an air gap along the optical axis between the first lens and the second lens, an air gap along the optical axis between the second lens and the third lens, an air gap along the optical axis between the third lens and the fourth lens, an air gap along the optical axis between the fourth lens and the fifth lens, and an air gap along the optical axis between the fifth lens and the sixth lens, and Td is a total distance along the optical axis from an object-side surface of the first lens to an image-side surface of the sixth lens.

13. The optical imaging system of claim 11, wherein a conditional expression 0.7≤CT1/ET2≤1.5 is satisfied, where CT1 is a thickness of the first lens along the optical axis, and ET2 is a peripheral thickness of the second lens at an edge of the second lens.

14. The optical imaging system of claim 11, wherein a conditional expression 0.5<AR1<1.0 is satisfied, where AR1 is a ratio of a minor axis diameter of the first lens to a major axis diameter of the first lens.

15. The optical imaging system of claim 11, wherein a conditional expression 0.6≤f123/f≤1.2 is satisfied, where f123 is a composite focal length of the first lens, the second lens, and the third lens, and f is the focal length of the optical imaging system.

16. The optical imaging system of claim 11, wherein an object-side surface of the sixth lens is concave in a paraxial region thereof.
